(19) United States
(12) Patent Application Publication
(10) Pub. No.: US 2008/0015982 A1
(43) Pub. Date: Jan. 17, 2008

(54) Funds transfer method and system including payment enabled invoices

(76) Inventors: Jeremy Sokolic, New York, NY (US); Sanjeev Dheer, Scarsdale, NY (US); Behram Panthaki, Jersey City, NJ (US); Azeem Sattar, Santa Clara, CA (US); Aaron Rudenstine, New York, NY (US)

Correspondence Address: COURTNEY STANIFORD & GREGORY LLP, P.O. BOX 9686, SAN JOSE, CA, 95157, US

(21) Appl. No.: 11/879,818

(22) Filed: Jul. 19, 2007

Related U.S. Application Data
(63) Continuation-in-part of application No. 09/665,919, filed on Sep. 20, 2000.
(60) Provisional application No. 60/807,791, filed on Jul. 19, 2006.

(51) Int. Cl. G06Q 40/00

(52) U.S. Cl. 705/39

(57) ABSTRACT

Embodiments described herein include a financial management system that transfers funds on behalf of a user. Embodiments further include a payment enabled invoice method and system including a payment application and payment hubs through which invoicing entities may create and modify invoices, and through which a payer may view and pay the invoices. The invoicing entity and the payer do not exchange financial account information, which is confidentially held by the payment enabled invoice system. Invoices are paid according to funds transfer embodiments, wherein a transfer comprises the financial management system executing a debit transaction from a first financial institution, holding the debited funds in an intermediary account owned by the financial management system at a second financial institution, and executing a credit transaction to credit the funds to an account at a third financial institution.

### RELATED APPLICATIONS

This application claims the benefit of U.S. Provisional Patent Application No. 60/807,791, filed Jul. 19, 2006, which is incorporated by reference in its entirety herein.

This application is a continuation-in-part of copending U.S. patent application Ser. No. 09/665,919, filed Sep. 20, 2000, which is incorporated by reference in its entirety herein.

This application is related to the following copending U.S. patent applications Ser. Nos. 10/040,929, 10/402,855, 11/698,703, 11/698,702, and 11/698,468, which are incorporated by reference in their entirety herein.

### TECHNICAL FIELD

The present invention relates to an invoicing system and method including payment hubs via which an invoice can be accessed by multiple parties to create the invoice, review the invoice, modify the invoice, pay the invoice, etc., without the exchange of financial account data between an invoicing entity and a payer entity.

### BACKGROUND

Customers of financial institutions (both individual customers and businesses) typically maintain multiple financial accounts at one or more financial institutions. Financial institutions include, for example, banks, savings and loans, credit unions, mortgage companies, lending companies, and stock brokers. A customer's financial accounts may include asset accounts (such as savings accounts, checking accounts, certificates of deposit (CDs), mutual funds, bonds, and equities) and debt accounts (such as credit card accounts, mortgage accounts, home equity loans, overdraft protection, and other types of loans).

If a user identifies funds to be transferred between different accounts, the user is then required to execute the necessary transactions. To execute these transactions, the user may need to visit one or more financial institutions and request the appropriate fund transfers. However, if one or more of the financial institutions is located in a distant town, the fund transfers may need to be processed by check or bank wire. Alternatively, the user may execute some of the transactions through an online banking service, if the financial institution supports online banking. However, typical online banking services do not permit the transfer of funds between two different financial institutions. Thus, if a user wants to transfer funds, for example, from a checking account at a bank to a money market account at a stock broker, the user cannot generally execute the transfer using online banking.

Instead, the user needs to withdraw funds manually using, for example, a check and manually deposit the funds in the second account (either in person or by mail). Since the second account may place a hold on the deposit, the actual fund transfer may not occur for a week (or longer) depending on the amount of the check, the policies of the financial institutions, and any delays involved with mailing the check. A bank wire provides a faster method of transferring funds between financial institutions, but is not generally cost-effective for small transfers (e.g., transfers of less than a few thousand dollars), due to the costs associated with the bank wire. For small transfers, the costs associated with the bank wire may exceed the interest savings generated by the transfer.

Furthermore, to execute a particular transaction between two financial institutions that support the online transfer of funds, the user must configure a particular transaction for each possible combination of accounts that may have funds transferred between them. This is tedious and requires the user to remember the differences between the online interfaces at the different financial institutions.

If a user's financial institutions support online transfers of funds, before performing any transfers between two financial institutions that support the online transfer of funds, the user must configure a particular transaction for each possible combination of accounts that may have funds transferred between them. This is tedious and requires the user to remember the differences between the online interfaces at the different financial institutions.

The foregoing limitations apply to current systems and methods for online payment of invoices. Current online invoice mechanisms include so-called biller-direct web sites which allow a customer to log in and pay an invoice of a particular invoicing entity. For example, a utility company may have a proprietary web site that includes a place for a utility customer to enter a customer account number and some authentication information (user name and password, for example) in order to view the customer's utility bill (invoice) and pay that bill. Such biller-direct sites require the customer to enter payment account information, such as checking account numbers and routing numbers, directly on the invoicing entity web site. In addition, the biller-direct site allows a customer to view and pay only a current invoice from one particular invoicing entity.

A limitation of current online invoicing and payment systems is that they are only economically viable for very large invoicing entities, such as large utility companies. There is currently no system or method for facilitating creation and maintenance of invoices from multiple invoicing entities that is accessible by multiple payers. There is currently no such system that can be practically offered to small businesses, or even individuals, who desire to offer online invoicing to customers.

### BRIEF DESCRIPTION OF THE DRAWINGS

FIG. 1 illustrates a network environment in which various servers, computing devices, and financial management systems exchange data across a network, such as the Internet, according to an embodiment.

FIG. 2 illustrates an example of the interaction between a particular pair of financial institution servers, a market information service, a client computer, and a financial management system, according to an embodiment.

FIG. 3 is a block diagram showing pertinent components of a computer in accordance with the invention, according to an embodiment.

FIG. 4 is a block diagram showing components and modules of a financial management system, according to an embodiment.

FIG. 5 is a block diagram showing components and modules of an asset analysis and recommendation module, according to an embodiment.

FIG. 6 is a block diagram showing components and modules of a debt analysis and recommendation module, according to an embodiment.

FIG. 7 is a block diagram showing components and modules of a balance sheet analysis and recommendation module, according to an embodiment.

FIG. 8 is a flow diagram illustrating a procedure for identifying financial transactions to optimize a user's asset account balances, according to an embodiment.

FIG. 9 is a flow diagram illustrating a procedure for identifying financial transactions to optimize a user's debt account balances.

FIG. 10 is a flow diagram illustrating a procedure for identifying financial transactions to optimize a user's balance sheet, according to an embodiment.

FIG. 11 is a flow diagram illustrating a procedure for automatically optimizing a user's asset accounts, debt accounts, and balance sheet, according to an embodiment.

FIG. 12 is a table illustrating information associated with different financial institutions, according to an embodiment.

FIG. 13 is a table illustrating customer information related to financial accounts and user preferences, according to an embodiment.

FIGS. 14-15 illustrate a user interface screens illustrating account entry fields and account recommendations, according to an embodiment.

FIG. 16 illustrates an environment in which funds are transferred between various financial institutions using a payment network, according to an embodiment.

FIG. 17 is a flow diagram illustrating a procedure for transferring funds between two financial institutions, according to an embodiment.

FIG. 18 illustrates another environment in which funds are transferred between various financial institutions using multiple payment networks, according to an embodiment.

FIG. 19 illustrates an environment in which funds are transferred between various financial institutions, according to an embodiment.

FIG. 20 is a block diagram of a system including an invoicing application and payment hubs, according to an embodiment.

FIG. 21 is a block diagram of an invoicing application, according to an embodiment.

FIG. 22 is a block diagram of a system including an invoicing application, payment hubs, and user interfaces, according to an embodiment.

FIG. 23A is a flow diagram of invoicing entity actions in a payment enabled invoice method, according to an embodiment.

FIG. 23B is a flow diagram of creating an invoice template according to an embodiment.

FIG. 24A is a flow diagram of a payment hub process in a payment enabled invoice method, according to an embodiment.

FIG. 24B is a flow diagram of a payment hub “quick-pay” process, according to an embodiment.

FIG. 25 is a flow diagram of invoicing entity actions and payer actions in a payment enabled explanation of benefits (EOB) method, according to an embodiment.

FIG. 26 is an “invoice details” screen shot, according to an embodiment.

FIG. 27 is a “product invoice details” screen shot, according to an embodiment.

FIG. 28 is a “service invoice details” screen shot, according to an embodiment.

FIG. 29 is a “free form invoice details” screen shot, according to an embodiment.

FIG. 30 is a “confirm invoice details” screen shot, according to an embodiment.

FIG. 31 is a “review email” screen shot, according to an embodiment.

FIG. 32 is an “invoice sent” screen shot, according to an embodiment.

FIG. 33 is an “invoice history” screen shot showing paid invoices, according to an embodiment.

FIG. 34 is an “invoice history” screen shot showing unpaid invoices, according to an embodiment.

FIG. 35 is a “delete invoice” screen shot, according to an embodiment.

FIG. 36 is an “apply payment to invoice” screen shot, according to an embodiment.

FIG. 37 is a “confirm payment to invoice” screen shot, according to an embodiment.

FIG. 38 is a “mark invoice as paid” screen shot, according to an embodiment.

FIG. 39 is an “invoice details” screen shot, according to an embodiment.

FIG. 40 is a “manage customers” screen shot, according to an embodiment.

FIG. 41 is a “manage business profiles” screen shot, according to an embodiment.

FIG. 42 is an “add business profile” screen shot, according to an embodiment.

FIG. 43 is a “confirm business profile” screen shot, according to an embodiment.

FIG. 44 is a “business profile added” screen shot, according to an embodiment.

FIG. 45 is an “edit business profile” screen shot, according to an embodiment.

FIG. 46 is a “confirm business profile edits” screen shot, according to an embodiment.

FIG. 47 is a “delete business profile” screen shot, according to an embodiment.

FIG. 48 is a “manage items” screen shot, according to an embodiment.

FIG. 49 is an “add item” screen shot, according to an embodiment.

FIG. 50 is an “edit item” screen shot, according to an embodiment.

FIG. 51 is a “manage payment terms” screen shot, according to an embodiment.

FIG. 52 is an “add payment terms” screen shot, according to an embodiment.

FIG. 53 is an “edit payment terms” screen shot, according to an embodiment.

FIG. 54 is a “manage penalties” screen shot, according to an embodiment.

FIG. 55 is an “add penalties” screen shot, according to an embodiment.

FIG. 56 is an “edit penalties” screen shot, according to an embodiment.

FIG. 57 is a “view claims history screen”, according to an embodiment.

FIG. 58 is a payment enabled explanation of service (EOB) screen, according to an embodiment.

### DETAILED DESCRIPTION

The system and methods described herein include a financial management system that executes transfers of funds between accounts at different financial institutions. The transfers of funds include a debit transaction with one financial institution, according to which the funds are held in an account owned by the financial management system. The transfer of funds further includes a credit transaction, according to which the funds are credited to another financial institution from the account owned by the financial management system.

As used herein, the terms “account holder”, “customer”, “user”, and “client” are interchangeable. “Account holder” refers to any person having access to an account. A particular account may have multiple account holders (e.g., a joint checking account having husband and wife as account holders or a corporate account identifying several corporate employees as account holders. Various financial account and financial institution examples are provided herein for purposes of explanation. However, it will be appreciated that the system and procedures described herein can be used with any type of asset account and any type of debt account. Example asset accounts include savings accounts, money market accounts, checking accounts (both interest-bearing and non-interest-bearing), certificates of deposit (CDs), mutual funds, bonds, and equities. Example debt accounts include credit card accounts, mortgage accounts, home equity loans, overdraft protection, margin accounts, personal loans, and other types of loans. Financial institutions include banks, savings and loans, credit unions, mortgage companies, mutual fund companies, lending companies, and stock brokers.

Various attributes associated with an asset account and/or a debt account are discussed herein. These attributes are used to analyze various accounts and make recommendations that would benefit the account holder. Example attributes include interest rate, loan repayment terms, minimum balance, type of collateral, etc. Although particular examples are discussed herein with reference to interest rates, it will be appreciated that the methods and systems described herein are applicable to any type of attribute.

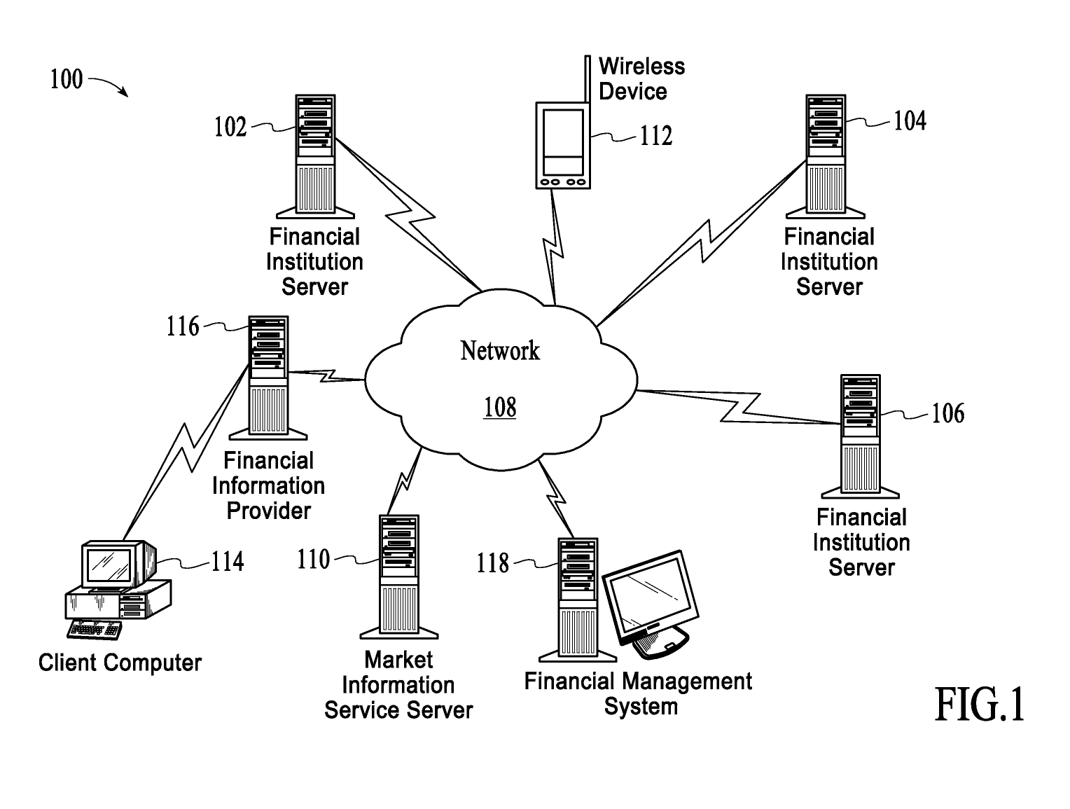

FIG. 1 illustrates a network environment 100 in which various servers, computing devices, and financial management systems exchange data across a data communication network. The network environment of FIG. 1 includes multiple financial institution servers 102, 104, and 106 coupled to a data communication network 108, such as the Internet. A market information service server 110 and a financial management system 118 are also coupled to network 108. Additionally, a wireless device 112 and a client computer 114 are coupled to network 108. Wireless device 112 may be a personal digital assistant (PDA), a handheld or portable computer, a cellular phone, a pager, or any other device capable of communicating with other devices via a wireless connection. A financial information provider 116 is coupled between network 108 and client computer 114.

Network 108 may be any type of data communication network using any communication protocol. Further, network 108 may include one or more sub-networks (not shown) which are interconnected with one another.

The communication links shown between the network 108 and the various devices (102-106 and 110-118) shown in FIG. 1 can use any type of communication medium and any communication protocol. For example, one or more of the communication links shown in FIG. 1 may be a wireless link (e.g., a radio frequency (RF) link or a microwave link) or a wired link accessed via a public telephone system or another communication network. Wireless device 112 typically accesses network 108 via a wireless connection to another communication network that is coupled to network 108. Certain devices, such as servers, may be coupled to a local area network (LAN), which is coupled to network 108. Client computer 114 may access network 108 in different ways. First, client computer 114 may directly access network 108, for example, by using a modem to access a public telephone network (e.g., a public switched telephone network (PSTN)) that is coupled to network 108. Alternately, client computer 114 may access financial information provider 116, which establishes a connection to network 108. Financial information provider 116 may act as a “buffer” between network 108 and client computer 114, or may allow commands and data to simply pass-through between the network 108 and the client computer 114.

Each of the financial institution servers 102, 104, and 106 are typically associated with a particular financial institution and store data for that financial institution, such as customer account data. The market information service server 110 may represent one or more services that collect and report information regarding current financial market conditions. For example, a particular market information service may collect information from many financial institutions to generate a report identifying the average interest rates for savings, checking, or other accounts. The report may also identify the highest rates for each type of account and the financial institution offering those rates. Multiple market information service servers 110 may be coupled to network 108, each server providing a different type of market data.

Financial management system 118 performs various account analysis functions to determine whether a user's financial accounts (e.g., both asset accounts and debt accounts) are optimized. Additionally, financial management system 118 is capable of initiating the automatic transfer of funds between accounts at one or more financial institutions. These analysis and fund transfer functions are discussed in greater detail below. Wireless device 112 and client computer 114 allow a user to access information via the network 108. For example, the user can access account information from one of the financial institution servers 102, 104, or 106, access current interest rate data from market information service server 110, or send a request for an analysis of the user's financial accounts to financial management system 118. Financial information provider 116 acts as an intermediary between client computer 114 and other devices coupled to network 108. For example, client computer 114 generates a request for data or account analysis and communicates the request to the financial information provider 116. The financial information provider 116 then retrieves the requested data or initiates the requested account analysis on behalf of the user of client computer 114.

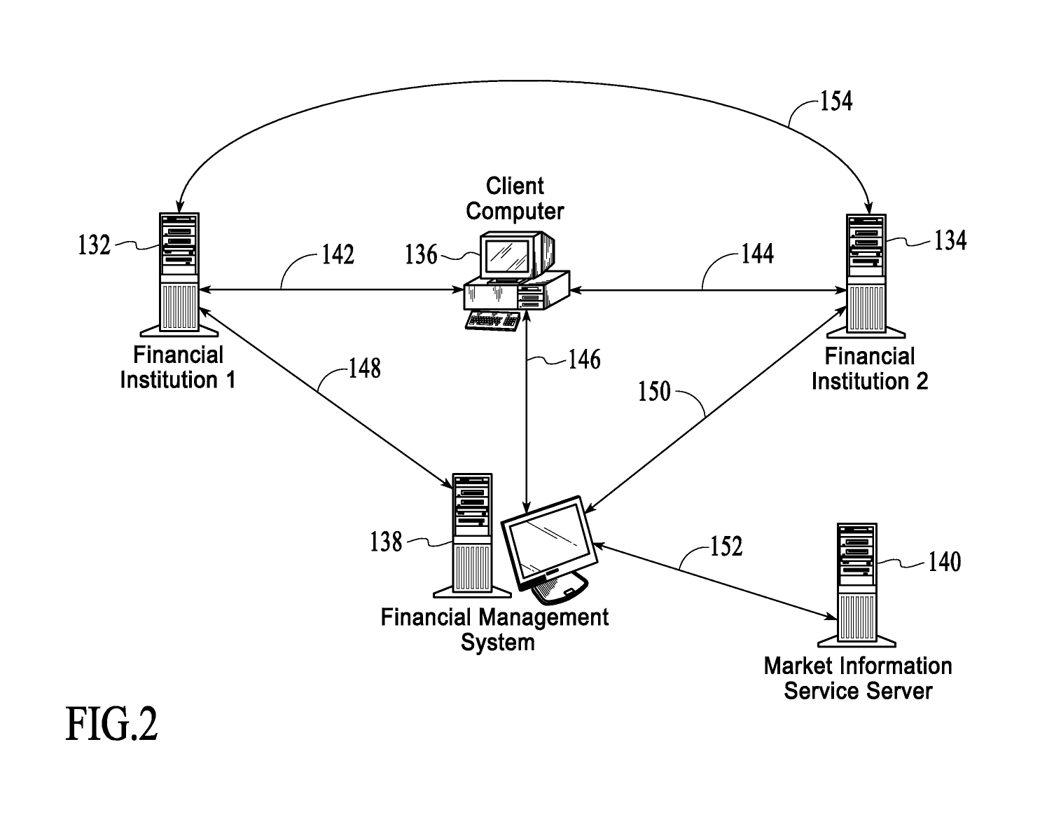

FIG. 2 illustrates an example of the interaction between a particular pair of financial institution servers 132 and 134, a market information service server 140, a client computer 136, and a financial management system 138. In this example, each financial institution server 132 and 134 is associated with a different financial institution. Client computer 136 is capable of accessing financial institution server 132 via a communication link 142 and accessing financial institution server 134 via a communication link 144. For example, the user of client computer 136 may retrieve account information or interest rate information from one or both of the financial institution servers 132, 134. Client computer 136 is also capable of interacting with financial management system 138 via a communication link 146. The user of client computer 136 may access financial management system 138, for example, to have the system analyze the user's financial accounts and automatically initiate the transfer of funds between accounts.

Financial management system 138 is coupled to the two financial institution servers 132 and 134 via two communication links 148 and 150, respectively. Communication links 148 and 150 allow the financial management system 138 to retrieve information from the financial institution servers 132, 134, and execute transactions on the financial institution servers on behalf of the user of client computer 136. Financial management system 138 is also coupled to market information service server 140 through a communication link 152, which allows the financial management system to retrieve various information regarding market interest rates and other market data. Financial institution servers 132 and 134 are capable of communicating with one another via a communication link 154, which allows the servers to exchange data and other information with one another.

Communication links 142-154 may be dial-up connections and/or connections via one or more networks of the type discussed above with respect to FIG. 1.

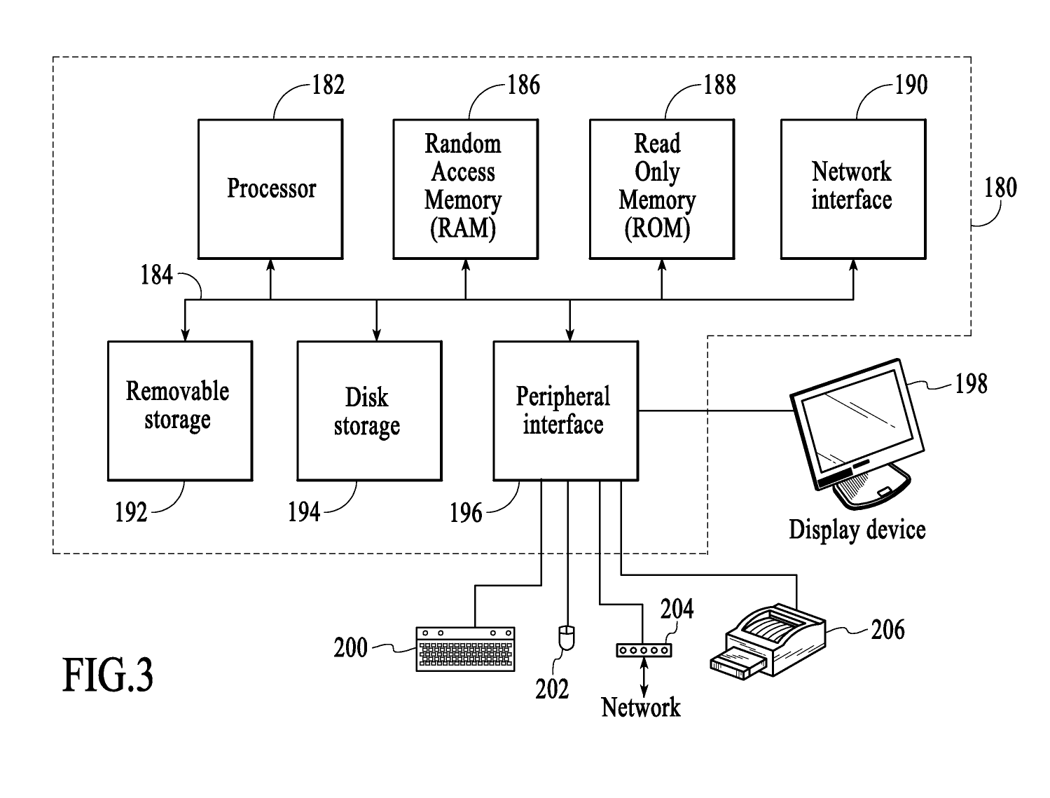

FIG. 3 is a block diagram showing pertinent components of a computer 180 in accordance with the invention. A computer such as that shown in FIG. 3 can be used, for example, to perform various financial analysis operations such as accessing and analyzing a user's financial account information to make account recommendations. Computer 180 can also be used to access a web site or other computing facility to access the various financial analysis functions. The computer shown in FIG. 3 can function as a server, a client computer, or a financial management system, of the types discussed herein.

Computer 180 includes at least one processor 182 coupled to a bus 184 that couples together various system components. Bus 184 represents one or more of any of several types of bus structures, such as a memory bus or memory controller, a peripheral bus, and a processor or local bus using any of a variety of bus architectures. A random access memory (RAM) 186 and a read only memory (ROM) 188 are coupled to bus 184. Additionally, a network interface 190 and a removable storage device 192, such as a floppy disk or a CD-ROM, are coupled to bus 184. Network interface 190 provides an interface to a data communication network such as a local area network (LAN) or a wide area network (WAN) for exchanging data with other computers and devices. A disk storage 194, such as a hard disk, is coupled to bus 184 and provides for the non-volatile storage of data (e.g., computer-readable instructions, data structures, program modules and other data used by computer 180). Although computer 180 illustrates a removable storage 192 and a disk storage 194, it will be appreciated that other types of computer-readable media which can store data that is accessible by a computer, such as magnetic cassettes, flash memory cards, digital video disks, and the like, may also be used in the computer.

Various peripheral interfaces 196 are coupled to bus 184 and provide an interface between the computer 180 and the individual peripheral devices. Peripheral devices include a display device 198, a keyboard 200, a mouse 202, a modem 204, and a printer 206. Modem 204 can be used to access other computer systems and devices directly or by connecting to a data communication network such as the Internet.

A variety of program modules can be stored on the disk storage 194, removable storage 192, RAM 186, or ROM 188, including an operating system, one or more application programs, and other program modules and program data. A user can enter commands and other information into computer 180 using the keyboard 200, mouse 202, or other input devices (not shown). Other input devices may include a microphone, joystick, game pad, scanner, satellite dish, or the like.

Computer 180 may operate in a network environment using logical connections to other remote computers. The remote computers may be personal computers, servers, routers, or peer devices. In a networked environment, some or all of the program modules executed by computer 180 may be retrieved from another computing device coupled to the network.

Typically, the computer 180 is programmed using instructions stored at different times in the various computer-readable media of the computer. Programs and operating systems are often distributed, for example, on floppy disks or CD-ROMs. The programs are installed from the distribution media into a storage device within the computer 180. When a program is executed, the program is at least partially loaded into the computer's primary electronic memory. As described herein, the invention includes these and other types of computer-readable media when the media contains instructions or programs for implementing the steps described below in conjunction with a processor. The invention also includes the computer itself when programmed according to the procedures and techniques described herein.

For purposes of illustration, programs and other executable program components are illustrated herein as discrete blocks, although it is understood that such programs and components reside at various times in different storage components of the computer, and are executed by the computer's processor. Alternatively, the systems and procedures described herein can be implemented in hardware or a combination of hardware, software, and/or firmware. For example, one or more application specific integrated circuits (ASICs) can be programmed to carry out the systems and procedures described herein.

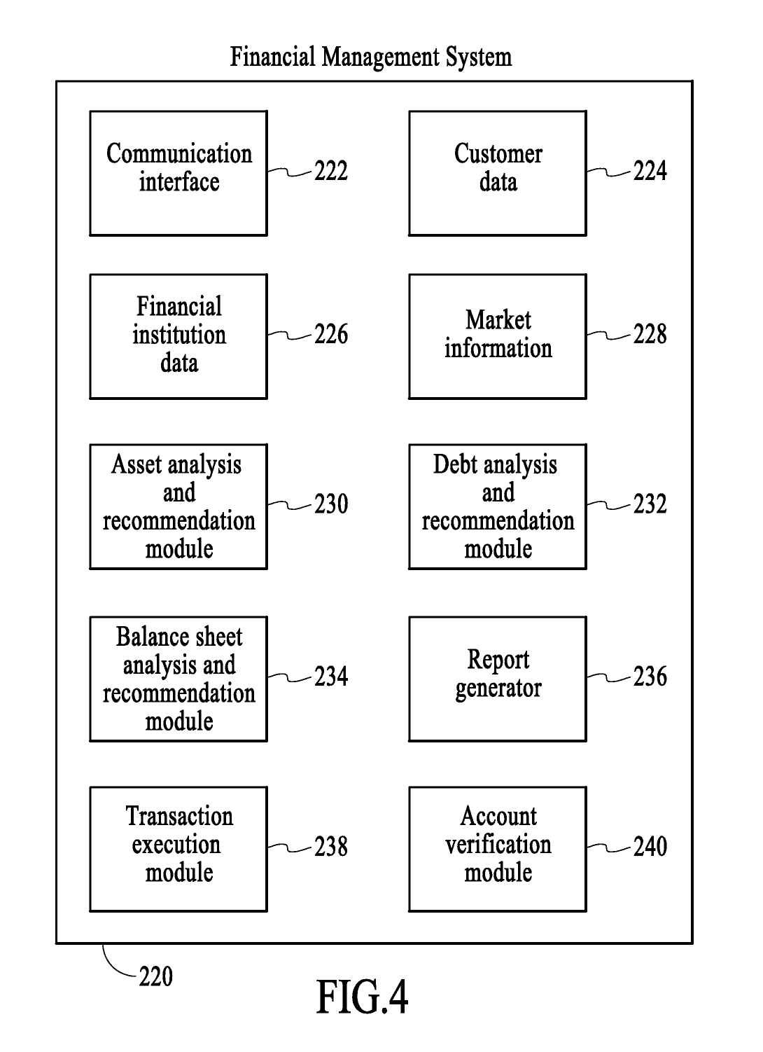

FIG. 4 is a block diagram showing components and modules of a financial management system 220. A communication interface 222 allows the financial management system 220 to communicate with other computing systems, such as servers, client computers, and portable computing devices. In one embodiment, communication interface 222 is a network interface to a LAN, which is coupled to another data communication network, such as the Internet.

The financial management system 220 stores customer data 224, such as customer account information, online banking login name and password, and user preferences. Financial management system 220 also stores financial institution data 226 and market information 228. Financial institution data 226 includes, for example, transaction routing data, account offerings, account interest rates, and minimum account balances. Market information 228 includes data such as average interest rates for different types of accounts (both asset accounts and debt accounts), the best available interest rates for each type of account, and the financial institutions offering the best available interest rates.

An asset analysis and recommendation module 230 analyzes various asset accounts to determine whether the accounts are earning the best available interest rates (or close to the best interest rates) and whether the fund allocation among the asset accounts is optimal or close to optimal. If fund adjustments would benefit the account holder, then module 230 makes the appropriate recommendations to the account holder. The asset accounts analyzed may be associated with two or more different financial institutions. A debt analysis and recommendation module 232 analyzes various debt accounts to determine whether the accounts are paying the most competitive (i.e., the lowest) interest rates or close to the best interest rates. Module 232 also determines whether the allocation of funds among the debt accounts is optimal or close to optimal, and makes recommendations, if necessary, to adjust funds in a manner that reduces the overall interest payments. The debt accounts analyzed may be associated with two or more different financial institutions.

A balance sheet analysis and recommendation module 234 analyzes both asset accounts and debt accounts to determine whether the allocation of funds among all of the accounts is optimal or close to optimal. If fund adjustments would benefit the account holder, then the balance sheet analysis and recommendation module 234 makes the appropriate recommendations to the account holder.

A report generator 236 generates various types of reports, such as account activity history, current recommendations to adjust funds among accounts, or a report comparing the current market interest rates to the interest rates of a user's current accounts. A transaction execution module 238 executes financial transactions on behalf of account holders. For example, an account holder may request that the financial management system 220 execute the recommendations generated by one or more of the three analysis and recommendation modules 230, 232, and 234. In this example, transaction execution module 238 identifies the recommendations and executes the financial transactions necessary to implement the recommendations. An account verification module 240 verifies that the user accessing financial management system 220 is authorized to access a particular account.

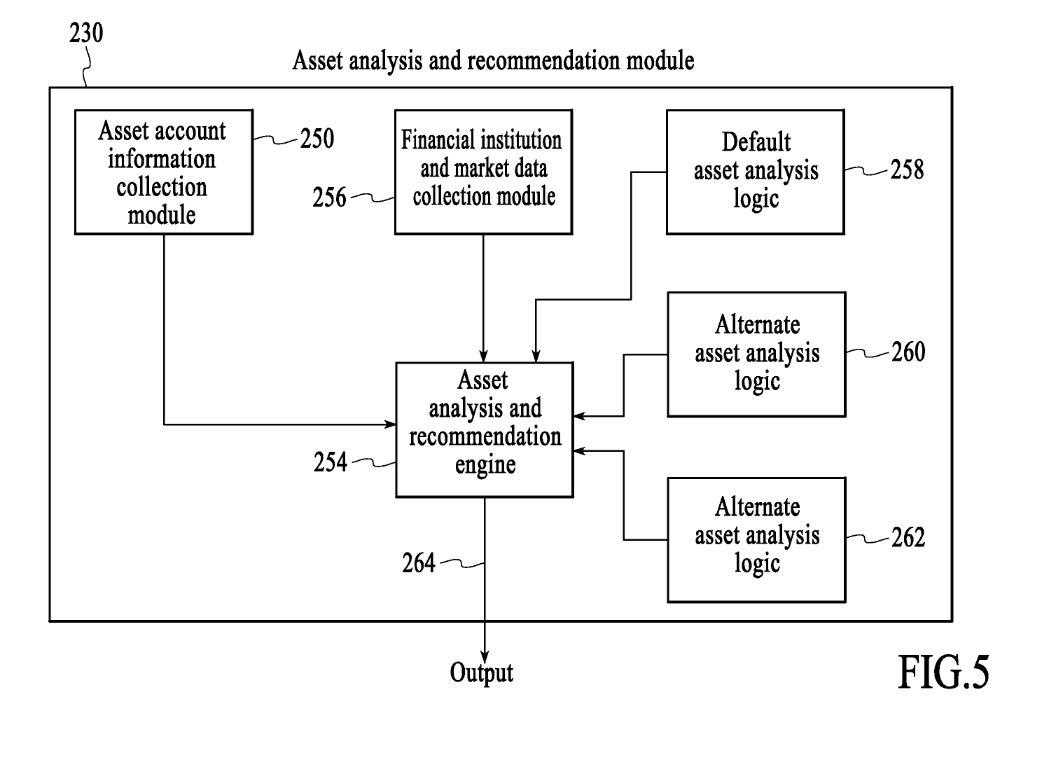

FIG. 5 is a block diagram showing components and modules of asset analysis and recommendation module 230. An asset account information collection module 250 collects information about a user's asset accounts. When a user accesses the financial management system and requests an analysis of the user's asset accounts, the system prompts the user to enter account information for all of the user's asset accounts. The information provided for each account may include the name of the financial institution, the account number, and the login name and password for online access to the account. This information is typically stored by the financial management system to avoid asking the user to re-enter the same information in the future. Based on the information provided by the user, the asset account information collection module 250 is able to access the user's accounts and determine the balance of each account as well as other information such as the interest rate and minimum balance for the account.

After collecting the user's asset account information, the collection module 250 organizes the account information into a common format and communicates the information to an asset analysis and recommendation engine 254 for processing.

A financial institution and market data collection module 256 collects information about particular financial institutions (e.g., transaction routing information and account offerings) and information about current market interest rates. The information about financial institutions may be retrieved from the financial institutions themselves or from one or more market information services that provide information about various financial institutions. The information relating to current market interest rates is collected from one or more market information services. After collecting the financial institution information and the market data, the collection module 256 communicates the collected information and data to the asset analysis and recommendation engine 254.

A default asset analysis logic 258 defines a default set of logic rules used to analyze a user's asset accounts. These default logic rules are used if the user does not create their own set of logic rules and does not select from one of several sets of alternate asset analysis logic rules 260 and 262. The alternate logic rules 260 and 262 may provide different approaches to asset account analysis (e.g., a conservative approach, a moderate approach, or an aggressive approach). In particular embodiments, at least one of the alternate logic rules 260, 262 is associated with a financial and/or investment celebrity, who defines the particular set of logic rules based on their financial and/or investment expertise.

The particular logic rules selected for each user may be different based on the sets of logic rules chosen by the user. Additionally, the logic rules selected for a particular user may change over time as the financial management system learns more about the user's payment or spending habits. For example, if the user regularly makes a $1000 payment from a particular checking account on the 15th of each month, a rule may be created by the financial management system to ensure that the checking account has at least a $1000 balance on the 14th of each month. If the checking account does not have a sufficient balance, then the financial management system may recommend a fund transfer to raise the balance of the checking account to cover the anticipated $1000 payment on the 15th. This type of user-specific logic rule may be stored with the other user data in the financial management system.

Asset analysis and recommendation engine 254 analyzes the user's asset account information by applying the various asset analysis logic rules to the asset account information. The asset analysis and recommendation engine 254 also considers market data collected by collection module 256 when analyzing the user's asset accounts. After analyzing the user's asset accounts, the asset analysis and recommendation engine 254 generates one or more recommendations to adjust the fund allocation among the asset accounts. The recommendation may also include opening a new asset account (e.g., an account that pays a higher interest rate) and/or closing an existing asset account (e.g., an account that pays a low interest rate). The recommendations and analysis results are output on communication link 264 for use by other modules or components in the financial management system.

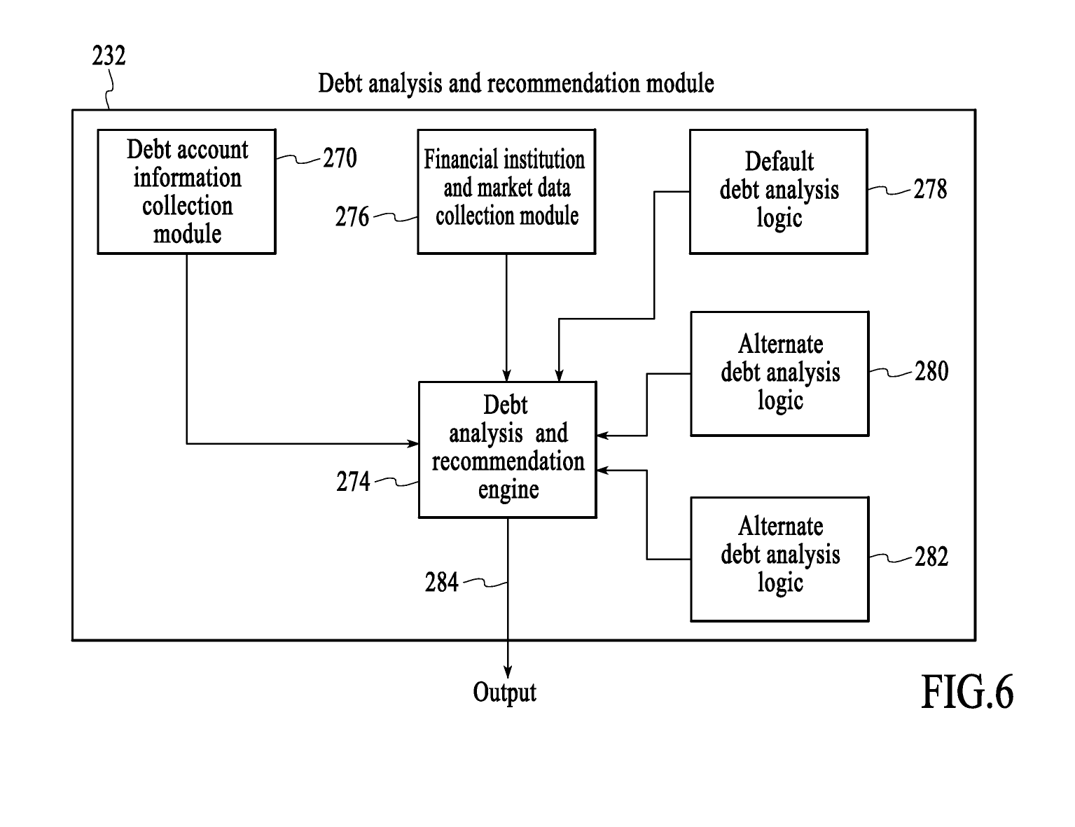

FIG. 6 is a block diagram showing components and modules of debt analysis and recommendation module 232. A debt account information collection module 270 collects information about a user's debt accounts. When a user accesses the financial management system and requests an analysis of the user's debt accounts, the system prompts the user to enter account information for each of the user's debt accounts. The information provided for each account may include the name of the financial institution, the account number, and information necessary to access the account online. This information is typically stored by the financial management system to avoid asking the user to re-enter the same information in the future. Based on the information provided by the user, the debt account collection module 270 accesses the user's debt accounts and determines the balance of each account as well as other information, such as the interest charged and the maximum balance for the account.

After collecting the user's debt account information, the collection module 270 organizes the account information into a common format and communicates the account information to a debt analysis and recommendation engine 274 for processing.

A financial institution and market data collection 276 collects information regarding particular financial institutions and information about current market interest rates. The information relating to financial institutions may be retrieved from the financial institutions themselves or from one or more market information services that provide information about various financial institutions. The information relating to current market interest rates is collected from one or more market information services. After collecting the financial institution information and the market data, the collection module 276 communicates the collected information and data to the debt analysis and recommendation engine 274.

A default debt analysis logic 278 defines a default set of logic rules used to analyze a user's debt accounts. These default logic rules are used if the user does not create their own set of logic rules and does not select from one of the several sets of alternate debt analysis logic 280 and 282. The alternate logic rules 280 and 282 may provide different approaches to debt account analysis, such as a conservative approach, a moderate approach, or an aggressive approach. In a particular embodiment, at least one of the alternate logic rules 280, 282 is associated with a financial and/or investment celebrity, who defines the particular set of logic rules based on their financial and/or investment expertise.

The particular logic rules selected for each user may be different based on the sets of logic rules chosen by the user. Additionally, the logic rules selected for a particular user may change over time as the financial management system learns more about the user's payment or spending habits. For example, if the user has too many expenses (i.e., the current month's expenses exceed the user's typical monthly income), then the logic rules (applied by the analysis engine) may suggest a short term loan to cover the expenses, thereby avoiding a situation in which the user has insufficient funds to pay bills as they become due. Additionally, if the loan will only be required for a short period of time, the rules may suggest opening (or taking advantage of an existing) overdraft protection account.

Different debt logic rules may be applied depending on a user's opinions regarding debt. One user might use the majority of available assets to pay down debts, thereby minimizing the user's level of debt. Another user might want to maintain a larger “cushion” of cash and only pay down debts if the available assets exceed a predetermined amount (e.g., $10,000). Debt rules from, for example, a celebrity or well-known financial analyst might recommend setting aside savings at the beginning of the month to “force” the appropriate monthly savings. The remainder of the assets are then used to pay monthly bills and other expenses. Other financial analysts may use different sets of logic rules to define the analysis and handling of asset accounts and debt accounts.

Debt analysis and recommendation engine 274 analyzes the user's debt account information by applying the various debt analysis logic rules to the debt account information. The debt analysis and recommendation engine 274 also considers market data collected by collection module 276 when analyzing the user's debt accounts. After analyzing the user's debt accounts, the debt analysis and recommendation engine 274 generates one or more recommendations to adjust the fund allocation among the debt accounts. The recommendation may also include opening a new debt account (e.g., an account with a lower interest rate) and/or closing an existing debt account (e.g., an account with a high interest rate). The recommendations and analysis results are output on communication link 284 for use by other modules or components in the financial management system.

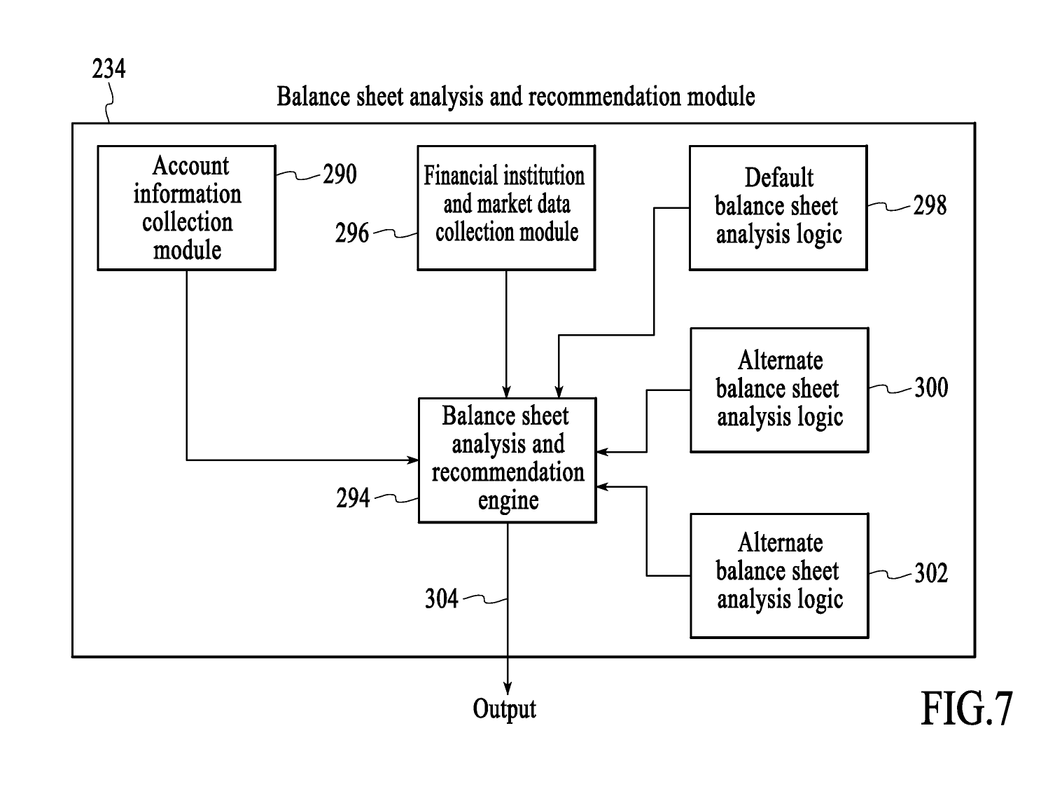

FIG. 7 is a block diagram showing components and modules of balance sheet analysis and recommendation module 234. An account information collection module 290 collects information about a user's asset accounts and debt accounts. When a user accesses the financial management system and requests an analysis of the user's balance sheet, the system prompts the user to enter account information for each of the user's asset accounts and debt accounts. The information provided for each account may include the name of the financial institution, the account number, and information necessary to access the account online. This information is typically stored by the financial management system to avoid asking the user to re-enter the same information in the future. Based on the information provided by the user, the account collection module 290 accesses the user's debt accounts and determines the balance of each account as well as other information, such as the interest charged or earned, and the maximum balance or credit limit associated with the account.

After collecting the user's asset and debt account information, the collection module 290 organizes the account information into a common format and communicates the account information to a balance sheet analysis and recommendation engine 294 for processing.

A financial institution and market data collection 296 collects information regarding particular financial institutions and information about current market interest rates for both asset accounts and debt accounts. The information relating to financial institutions may be retrieved from the financial institutions themselves or from one or more market information services that provide information about various financial institutions. The information relating to current market interest rates is collected from one or more market information services. After collecting the financial institution information and the market data, the collection module 296 communicates the collected information and data to the balance sheet analysis and recommendation engine 294.

A default balance sheet analysis logic 298 defines a default set of logic rules used to analyze a user's balance sheet. These default logic rules are used if the user does not create their own set of logic rules and does not select from one of the several sets of alternate balance sheet analysis logic 300 and 302. The alternate logic rules 300 and 302 may provide different approaches to debt account analysis, such as a conservative approach, a moderate approach, or an aggressive approach. In a particular embodiment, at least one of the alternate logic rules 300, 302 is associated with a financial and/or investment celebrity, who defines the particular set of logic rules based on their financial and/or investment expertise.

The particular logic rules selected for each user may be different based on the sets of logic rules chosen by the user. Additionally, the logic rules selected for a particular user may change over time as the financial management system learns more about the user's payment or spending habits. For example, if the user has funds earning a low interest rate in a savings account and carries a balance on a credit card with a high interest rate, the logic rules may suggest applying some or all of the funds in the savings account to pay off all or a portion of the balance on the credit card.

Different balance sheet logic rules may be applied depending on a user's opinions regarding assets and debts. One user might prefer to use the majority of available assets to pay down debts, thereby minimizing the user's level of debt. Another user might want to maintain a larger “cushion” of cash and only pay down debts if the available assets exceed a predetermined amount (e.g., $5,000).

Balance sheet analysis and recommendation engine 294 analyzes the user's balance sheet information by applying the various balance sheet analysis logic rules to the balance sheet information. The balance sheet analysis and recommendation engine 294 also considers financial institution and market data collected by collection module 296 when analyzing the user's balance sheet. After analyzing the user's balance sheet, the balance sheet analysis and recommendation engine 294 generates one or more recommendations to adjust the fund allocation among the user's asset accounts and debt accounts. The recommendation may also include opening one or more new accounts and/or closing one or more existing accounts. The recommendations and analysis results are output on communication link 304 for use by other modules or components in the financial management system.

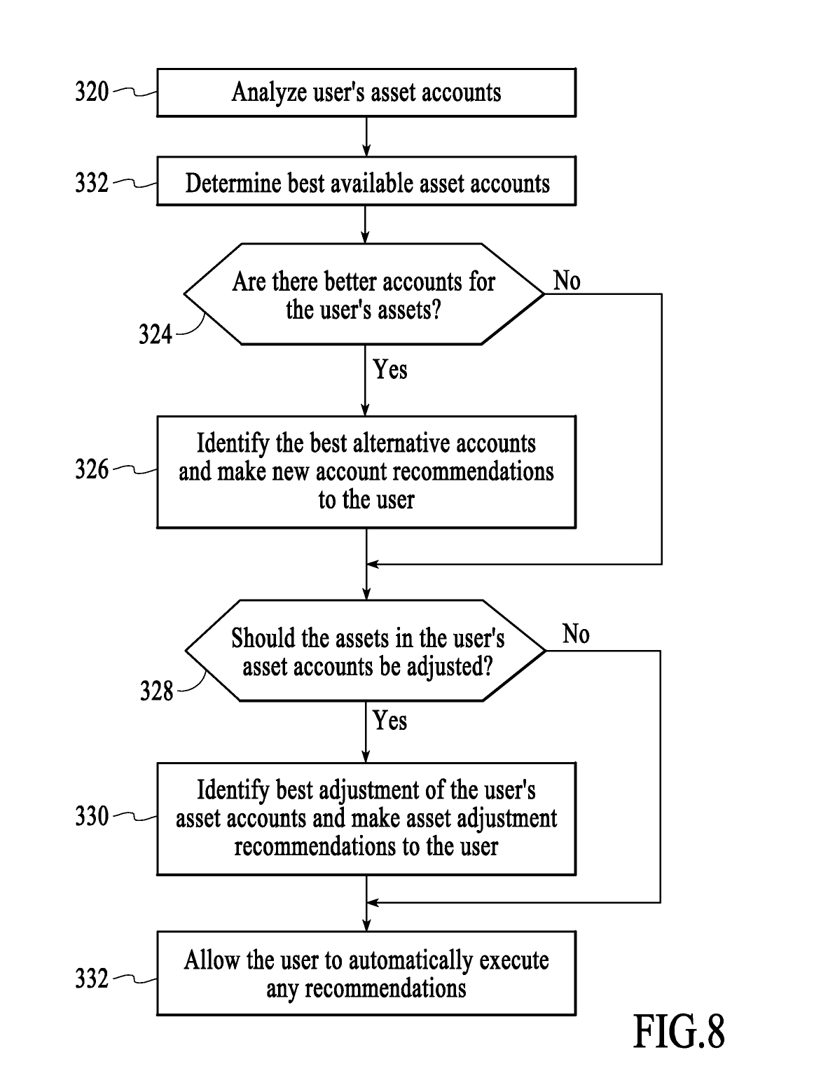

FIG. 8 is a flow diagram illustrating a procedure for identifying financial transactions to optimize a user's asset account balances. The procedure begins by analyzing the user's asset accounts (block 320). The procedure then determines the best available asset accounts (block 322), for example, by using market interest rate information from a market information service. Next, the procedure determines whether there are better accounts for the user's assets (block 324). These “better” accounts may include asset accounts that earn higher interest rates than the user's current asset accounts.

If the procedure identifies better accounts for the user's assets, then the procedure selects the best alternative account (or accounts) and makes a recommendation that the user open the alternative account (block 326). If the procedure does not identify any better accounts for the user's assets, then the procedure continues to block 328, where the procedure determines whether the assets in the user's accounts should be adjusted. If the user's asset accounts should be adjusted, then the procedure identifies the best adjustment of the user's asset accounts and makes asset adjustment recommendations to the user (block 330). Finally, the user is provided the opportunity to automatically execute any of the recommendations, such as opening one or more new asset accounts and/or moving funds between asset accounts (block 332). If the user chooses to have the recommendations executed automatically, the financial management system executes the necessary financial transactions to implement the system's recommendations as discussed in greater detail below. The procedure described above with respect to FIG. 8 may be implemented, for example, by asset analysis and recommendation module 230.

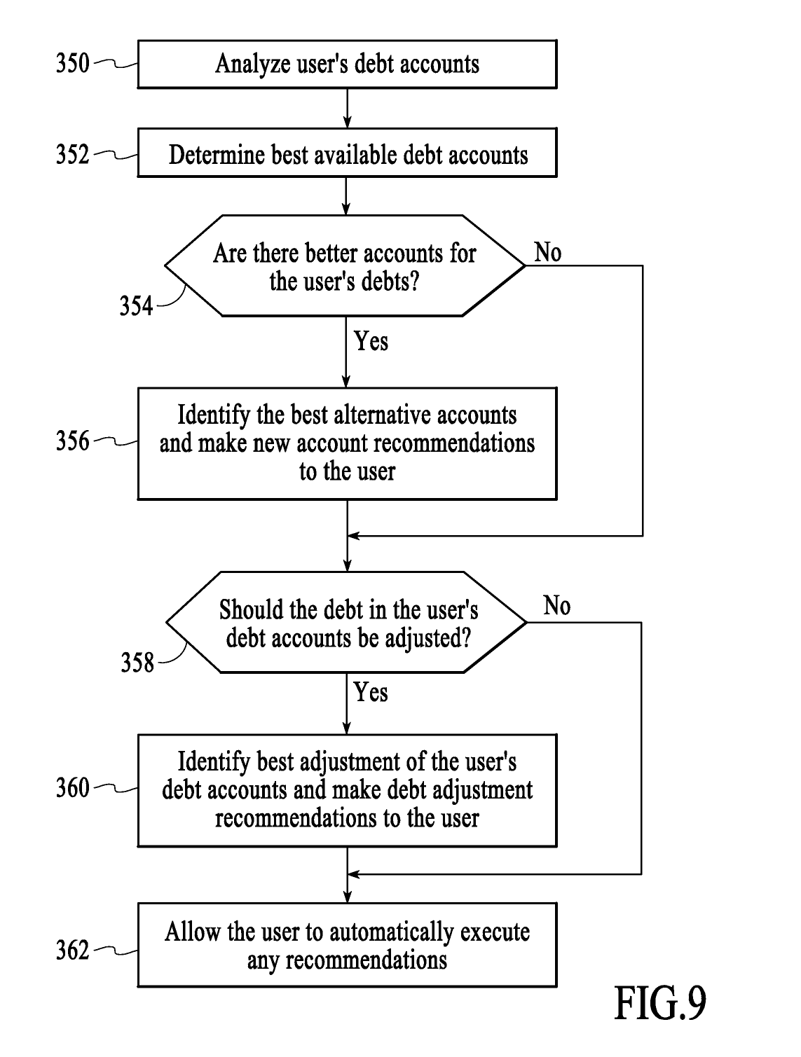

FIG. 9 is a flow diagram illustrating a procedure for identifying financial transactions to optimize a user's debt account balances. The procedure analyzes the user's debt accounts (block 350) and determines the best available debt accounts (block 352). The best available debt accounts are determined, for example, by using market interest rate information from one or more market information services. Next, the procedure determines whether there are better accounts for the user's debts (block 354). These “better” accounts may include debt accounts that charge lower interest rates than the user's current debt accounts.

If better accounts are identified for the user's debts, then the procedure selects the best alternative account (or accounts) and makes a recommendation that the user open the alternative account (block 356). If the procedure does not identify any better accounts for the user's debts, then the procedure continues to block 358, to determine whether the debts in the user's accounts should be adjusted. If the user's debt accounts should be adjusted, then the procedure identifies the best adjustment of the user's debt accounts and makes asset adjustment recommendations to the user (block 360). Finally, the user is provided the opportunity to automatically execute any of the recommendations, such as opening one or more new debt accounts and/or moving funds between debt accounts (block 362). If the user chooses to have the recommendations executed automatically, the financial management system executes the necessary financial transactions to implement the system's recommendations, as discussed below. The procedure described above with respect to FIG. 9 can be implemented, for example, by debt analysis and recommendation module 232.

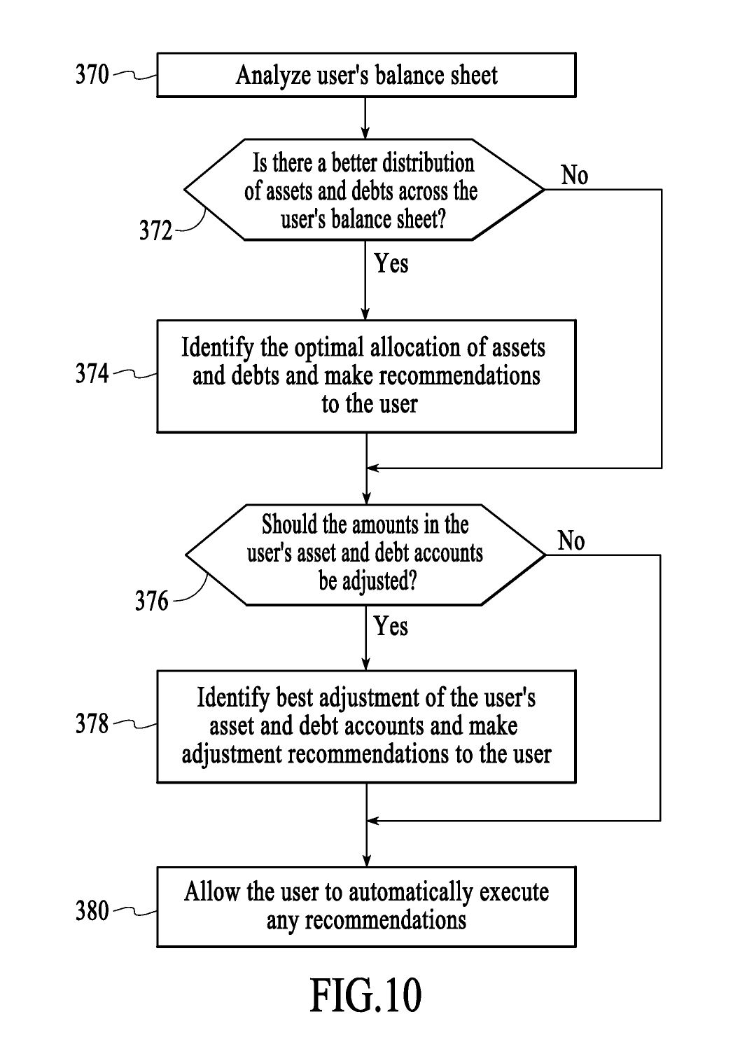

FIG. 10 is a flow diagram illustrating a procedure for identifying financial transactions to optimize a user's balance sheet. The procedure analyzes the user's balance sheet (block 370) and determines whether there is a better distribution of assets and debts across the user's balance sheet (block 372). For example, a “better distribution” of assets and debts may result in greater interest earned by the user or less interest paid by the user. If there is a better distribution of assets and debts across the user's balance sheet, then the procedure identifies the optimal allocation of assets and debts and makes recommendations to the user (block 374).

If the procedure does not identify any better distribution of assets and debts, then the procedure continues to block 376, to determine whether the amounts in the user's asset and debt accounts should be adjusted. If the user's accounts should be adjusted, then the procedure identifies the best adjustment of the user's asset and debt accounts and makes adjustment recommendations to the user (block 378). Finally, the user is provided the opportunity to automatically execute any of the recommendations (block 380), such as moving funds between accounts to maximize interest earned or minimize interest paid. If the user chooses to have the recommendations executed automatically, the financial management system executes the necessary financial transactions to implement the system's recommendations. The procedure described above with respect to FIG. 10 can be implemented, for example, by balance sheet analysis and recommendation module 234.

A user may choose to have the financial management system 220 (FIG. 4) analyze and make recommendations regarding the user's asset accounts, while ignoring the user's debt accounts. FIG. 8 illustrates an example procedure for this type of analysis and recommendation. Additionally, the user may select specific asset accounts to ignore during the analysis procedure. For example, the user may have a savings account for a special purpose. Even though the savings account may earn a below-average interest rate, the user does not want funds transferred into or out of that savings account. In this example, the user would instruct the financial management system to ignore that particular savings account.

The user may also choose to have the financial management system analyze and make recommendations regarding the user's debt accounts, while ignoring the user's asset accounts. FIG. 9 illustrates an example procedure for this type of analysis and recommendation. Additionally, the user may select specific debt accounts to ignore during the analysis procedure. For example, the user may want to pay-off and close a particular debt account even though the account has a favorable interest rate. In this example, the user would instruct the financial management system to ignore that particular debt account when performing its analysis.

The user can also choose to have the financial management system analyze and make recommendations regarding both the user's asset accounts and debt accounts (i.e., analyze the user's balance sheet). FIG. 10 illustrates an example procedure for this type of analysis and recommendation. Additionally, the user may select one or more asset accounts or debt accounts to ignore during the analysis procedure. Thus, the user has the option of selecting the types of accounts to consider, as well as specific accounts to consider or ignore, when the financial management system performs its analysis and makes recommendations.

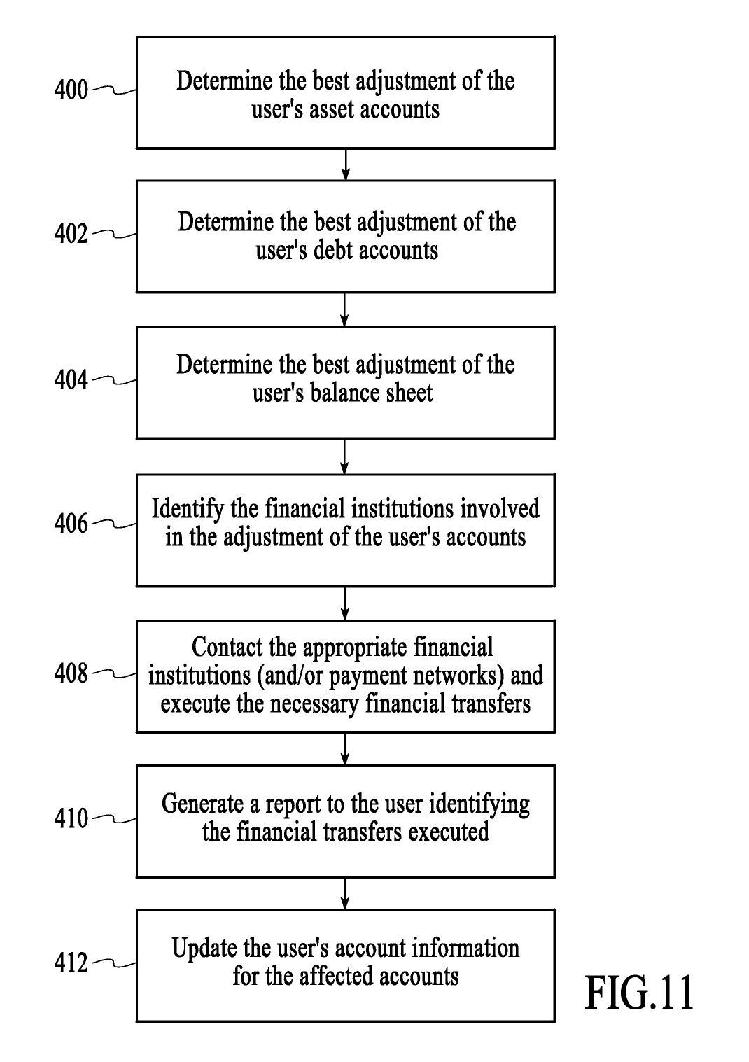

FIG. 11 is a flow diagram illustrating a procedure for automatically optimizing a user's asset accounts, debt accounts, and balance sheet. Initially, the procedure determines the best adjustment of the user's asset accounts (block 400). The best adjustment of the user's asset accounts may include opening a new account, closing an existing account, and/or transferring funds between accounts (new accounts or existing accounts). If the user's asset accounts are already optimized, or almost optimized, the procedure determines that no adjustment of asset accounts is necessary.

Next, the procedure determines the best adjustment of the user's debt accounts (block 402) and the best adjustment of the user's balance sheet (block 404). The best adjustment of the user's debt accounts and the user's balance sheet may include opening one or more new accounts, closing one or more existing accounts, and/or transferring funds between accounts (new accounts or existing accounts). If the user's debt accounts are already optimized, or almost optimized, the procedure determines that no adjustment of debt accounts is necessary. Similarly, if the user's balance sheet is already optimized, or almost optimized, then the procedure determines that no adjustment of asset accounts or debt accounts is necessary.

The various logic rules discussed above, which are used by the financial management system to determine whether funds should be adjusted between accounts, may define how to determine whether accounts are “almost optimized.” Typical factors that may be considered in determining whether accounts are “almost optimized” include: the savings (extra interest earned or less interest paid) that would result from an adjustment of funds, the difference in interest rates, the time required to implement the adjustment of funds, fees associated with the adjustment of funds, and the “risk” associated with the adjustment. The “risk” may be overdrawing an account by leaving insufficient funds to cover unexpected expenses (or expenses that are greater than expected).

For example, if a particular adjustment of funds would result in an increase in interest earnings of three cents per week, most logic rules will consider this situation “almost optimized.” In this situation, the financial management system will not recommend the adjustment of funds because the additional interest is insignificant.

After the procedure has determined the best adjustment of the user's accounts (blocks 400, 402, and 404), the procedure identifies the financial institutions involved in the adjustment of the user's accounts (block 406). The financial institutions are determined from the information entered by the user when identifying the user's accounts to the financial management system. Next, the procedure contacts the appropriate financial institutions and/or payment networks and executes the financial transfers necessary to implement the recommended adjustments to the user's accounts (block 408). A payment network may be, for example, the Federal Automated Clearing House (ACH), a debit network, a credit network, the federal wire system, or an ATM network. The financial management system is able to automatically access the user's accounts by using the login name and password for the account, which is provided by the user when identifying the user's accounts to the financial management system.

After executing the financial transactions necessary to implement the recommended adjustments to the user's accounts, a report is generated for the user that identifies the financial transfers executed (block 410). Finally, the user's account information is updated in the financial management system such that the system has accurate account balance information for all of the user's accounts (block 412).

The procedure described above with respect to FIG. 11 can be modified based on the user's preferences with respect to the types of accounts to be analyzed. For example, if the user selects only asset accounts for analysis, then the functions associated with blocks 402 and 404 of the procedure are not performed.

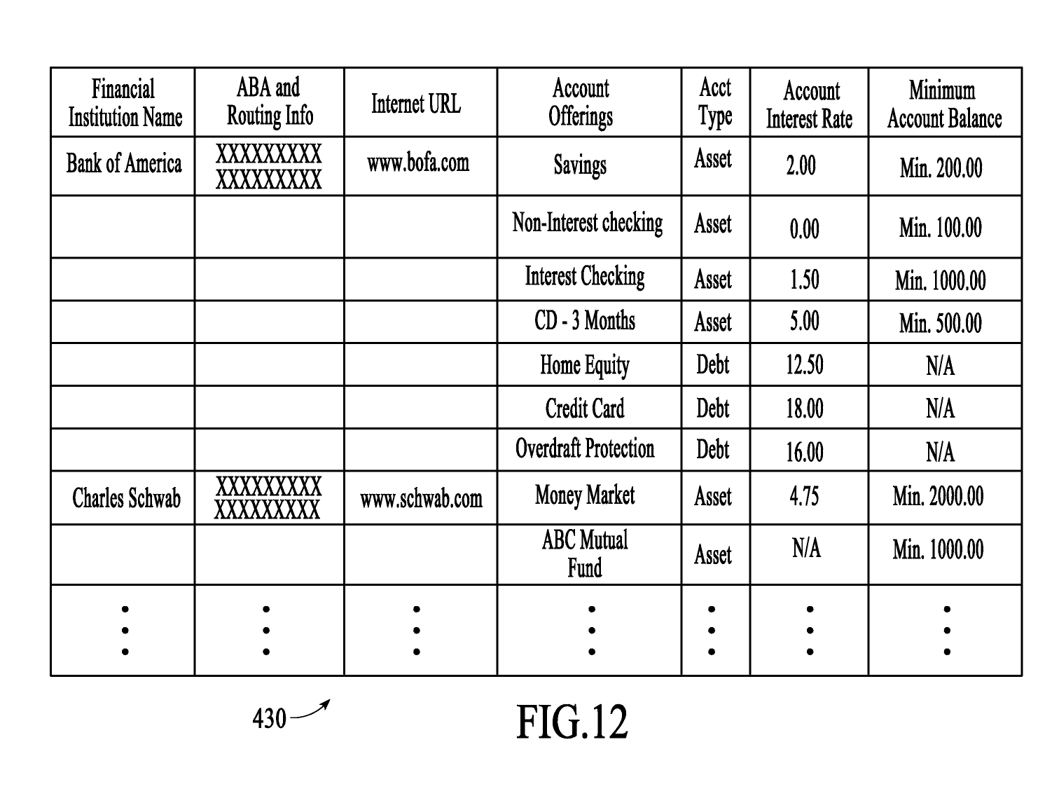

FIG. 12 shows a table 430 illustrating various information associated with different financial institutions. The information contained in table 430 may be obtained from the financial institution itself or from one or more market information services. The information contained in table 430 is periodically updated by comparing the information stored in the table against the current financial institution information.

The first column of table 430 identifies the name of the financial institution and the second column identifies the American Bankers Association (ABA) number and routing number. The third column indicates an Internet uniform resource locator (URL) associated with the financial institution. The fourth column of table 430 identifies the various account offerings from a particular financial institution. In this example, Bank of America offers a savings account, two types of checking accounts (interest bearing and non-interest bearing), a three month certificate of deposit (CD), a home equity loan, a credit card account, and overdraft protection for a checking account. The next column indicates the type of account (e.g., an asset account or a debt account).

The sixth column of table 430 indicates the current interest rate associated with each account. In the case of an asset account, the interest rate is the interest paid to a customer based on the balance in the account. In the case of a debt account, the interest rate is the interest charged to a customer based on the outstanding balance of the debt. The last column in table 430 indicates the minimum balance associated with each account. In this example, the debt accounts do not have a minimum balance. However, a debt account may have a maximum balance (e.g., the maximum value that can be loaned). Although not shown in FIG. 12, additional account information may be stored in table 430, such as monthly service charges, per-check charges, service charges for ATM transactions, or service charges if the minimum balance is not maintained.

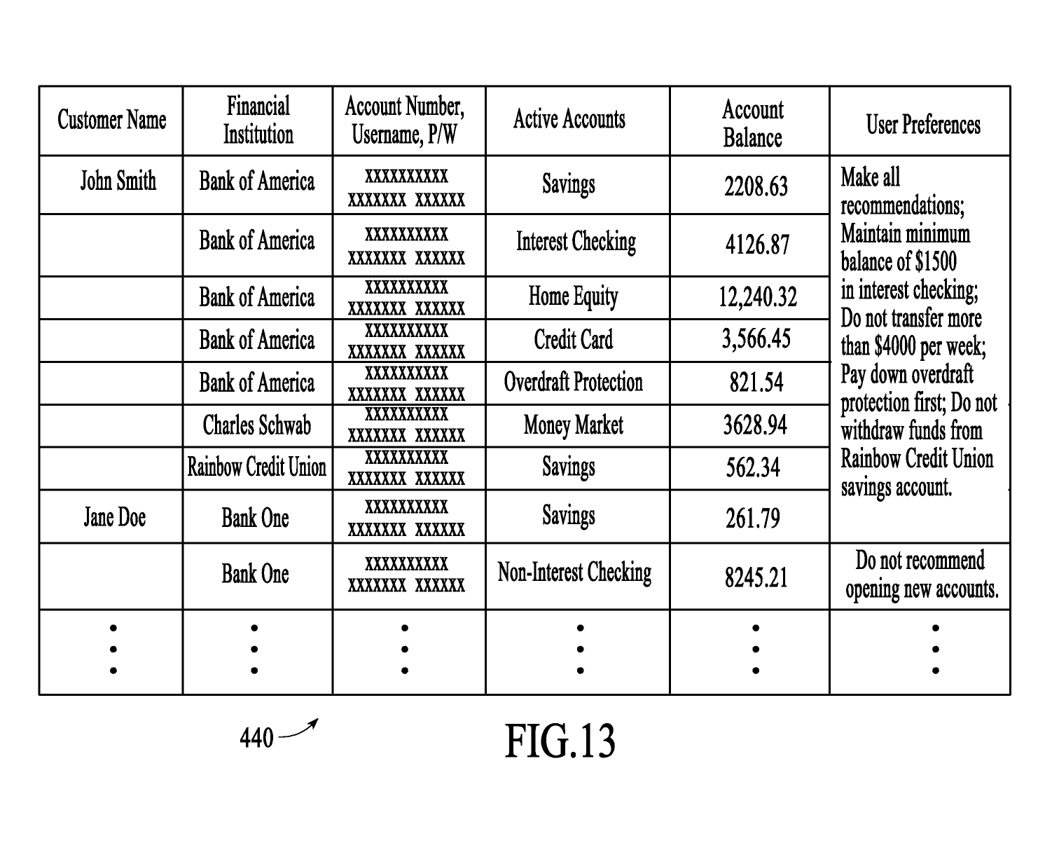

FIG. 13 shows a table 440 illustrating various customer information related to financial accounts and user preferences. Most information contained in table 440 is obtained from the user during an account setup procedure. The current account balance information is typically retrieved from the financial institution by the financial management system. The account balance information is periodically updated by retrieving current information from the financial institution.

The first column of table 440 identifies the customer name (the table contains customer information for multiple customers accessing the same financial management system). The second column identifies a financial institution and the third column identifies an account number as well as an online username and password associated with the account number. The username and password are used to access the account to perform online banking functions such as executing fund transfers or retrieving current account balances. The fourth column of table 440 identifies the accounts that the customer has with the financial institution (i.e., active accounts). For example, John Smith has five active accounts with Bank of America (savings, interest checking, home equity, credit card, and overdraft protection), one active account with Charles Schwab (money market account), and one active account with Rainbow Credit Union (savings account). The next column in table 440 indicates the current account balance for each active account. The last column indicates user preferences. The user preferences are determined by the user based on the manner in which the user wants information displayed, the manner in which accounts should be analyzed, and the types of recommendations the user desires. Additionally, the user preferences may specify certain minimum balances or other requirements for all accounts or for specific accounts. For example, the user preferences for John Smith specify that a minimum balance of $1500 should be maintained in the interest checking account. These user preferences are typically incorporated into the logic rules, discussed above, which are used to determine when and how to adjust funds between accounts.

Other types of user preferences include a maximum number of transactions per month in a particular account (e.g., some money market accounts set limits on the number of transactions in a particular month). By setting a user preference (or a logic rule) to limit the number of monthly transactions, the financial management system will not recommend (or attempt to execute) too many transactions in a particular month. A user may also set a preference that requires the financial management system to predict expenses for the next seven days (e.g., based on historical expenses during similar periods) and maintain a “buffer” in the account equal to the predicted expenses for the next seven days. Further, a user may set a preference indicating that funds should not be adjusted unless the adjustment results in a savings of at least five dollars per day.

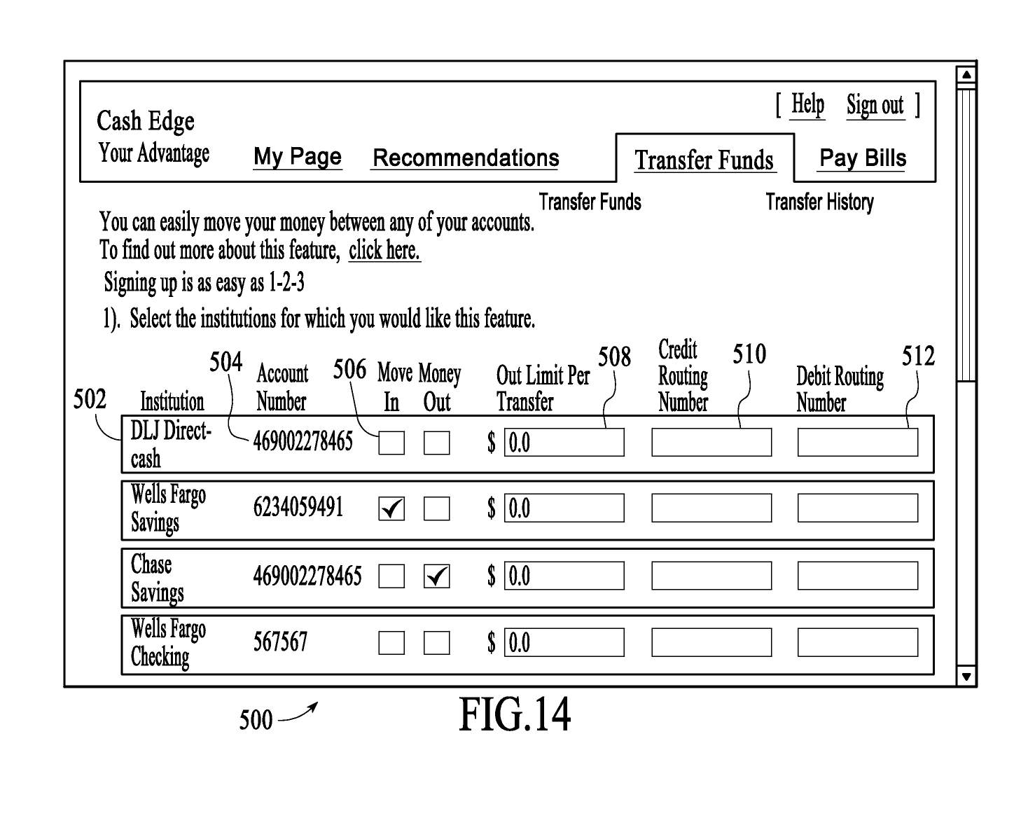

FIGS. 14-15 illustrate user interface screens illustrating various account entry fields and account recommendations. FIG. 14 illustrates an example screen 500 generated by a web browser or other application that allows a user to enter account information and preferences. Each entry identifies an institution 502 associated with the account and an account number 504. The user may select whether the financial management system has access to move funds into the account, out of the account, or both, by selecting the appropriate check boxes 506. The user may also set a maximum amount that can be withdrawn from the account at a particular time or during a particular time period by entering the amount in field 508. The credit routing number for the account is entered in field 510 and the debit routing number for the account is entered in field 512.

Although not shown in FIG. 14, other fields may be provided in the user interface to allow the user to enter additional preferences or information, such as interest rate, minimum balance the user wants maintained, etc. Certain account information (such as interest rate and routing numbers) may be obtained from the bank directly, thereby minimizing the information required to be entered by the user.

FIG. 15 illustrates another example screen 550 generated by a web browser or other application that allows a user to review recommendations generated by the financial management system. In the example of FIG. 15, one recommendation 552 is shown—to transfer funds from the Wells Fargo Checking account into the Chase Savings account. A recommended amount to transfer 554 has also been identified. If the recommendation is executed, the projected savings 556 over the next six months is $26. The reasoning or analysis supporting the recommendation and the projected savings is provided at 558. The user can execute the recommendation by activating the “Execute” button 560 on the screen. After activating the “Execute” button, the financial management system automatically performs the necessary steps to transfer the recommended funds between the two accounts.

In an alternate embodiment, the user is given the option to modify the amount to be transferred between the two accounts. For example, the user may only want to transfer $500 instead of the recommended $877. In this situation, the financial management system is still able to automatically perform the steps necessary to transfer $500 between the two accounts.

The systems and procedures discussed perform various financial analysis and generate one or more financial recommendations. To implement the financial recommendations, such as transferring funds between accounts, one or more of the systems and/or procedures discussed below may be utilized. Furthermore, the systems and procedures discussed below can be used to transfer funds between accounts at the user's request, and not necessarily based on any financial analysis or financial recommendations. For example, the user may want to transfer funds between two accounts in anticipation of a known withdrawal from the account receiving the funds. Thus, the systems and procedures discussed below are useful to transfer funds between accounts for any reason.

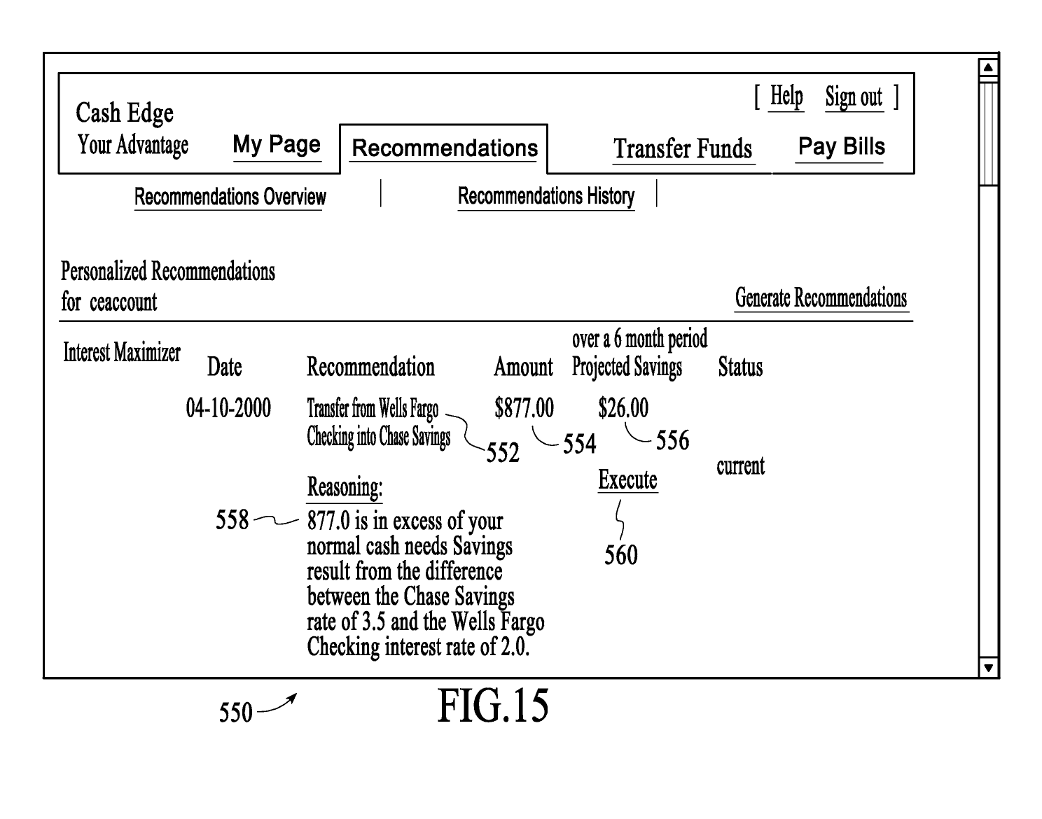

FIG. 16 illustrates an environment 570 in which funds are transferred between various financial institutions using a payment network 572. Payment network 572 can be, for example, an ACH network, a debit network, a credit card network, or a wire transfer network. Three different financial institutions 574, 576, and 578 are coupled to payment network 572, thereby allowing the three financial institutions to exchange funds among one another. A commercial payment processor 580 is coupled to financial institution 578 and a financial management system 582. Financial management system 582 may be similar to the financial management system 220, discussed above. Financial management system 582 is typically a neutral third party that performs various financial transactions on behalf of a user. Thus, financial management system 582 is not necessarily associated with any financial institution.

Financial management system 582 initiates the transfer of funds between financial institutions based on user instructions and/or recommendations based on analysis of the user's accounts. Additionally, financial management system 582 provides a common application or interface for accessing all accounts for a particular user. Thus, the user can access the financial management system 582 in a common manner and retrieve information and execute fund transfers using common commands, etc., regardless of the financial institutions involved. Furthermore, financial management system 582 registers multiple financial accounts for one or more account holders. Thus, financial management system 582 provides a single point for registering multiple financial accounts. A user may register multiple accounts associated with different financial institutions at this single point. After registering all accounts, the user can execute transactions between any of the registered accounts, regardless of whether the accounts are with the same or different financial institutions. Thus, the user is not required to establish account information for every pair of financial institutions that funds may be transferred between. Instead, the user registers the information associated with each account (e.g., account number, bank name, account password, etc.) once, which allows each registered account to exchange funds with any other registered account, regardless of the financial institutions associated with the accounts. The receiving and storing of the registered account information may be performed, for example, by financial management system 582.

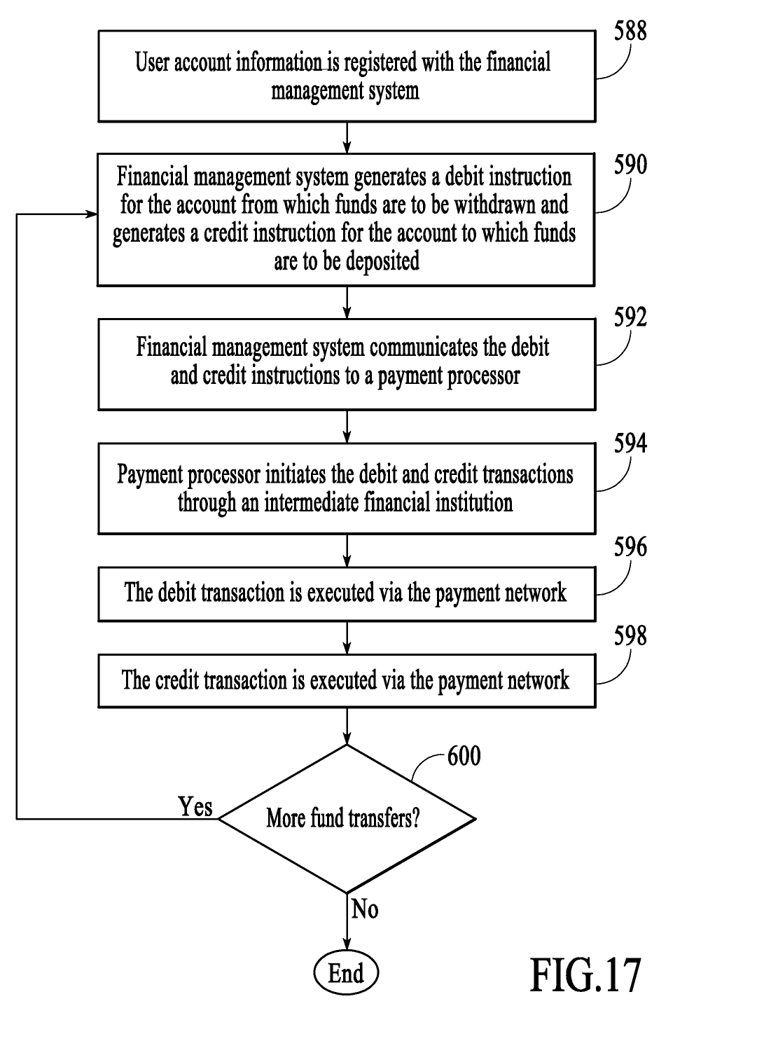

Although only three financial institutions 574, 576, and 578 are shown in FIG. 18, a particular environment may include any number of financial institutions coupled to payment network 572. Furthermore, as discussed below, the financial institutions 574, 576, and 578 may be coupled to one another via multiple payment networks.

Typically, payment network transactions are performed by financial institutions that are members of the payment network 572. Thus, financial management system 582 is not able to initiate transactions directly on the payment network 572 unless it is a member of the payment network. Instead, financial management system 582 initiates transactions through commercial payment processor 580 and financial institution 578. Financial institution 578 is capable of executing the requested financial transactions using payment network 572. Commercial payment processor 580 provides another interface to the payment network 572.

In an alternate embodiment, payment processor 580 is not required. Instead, financial management system 582 sends instructions directly to financial institution 578, which executes the instructions using payment network 572. In another embodiment, financial institution 578 is not required. Instead, financial management system 582 sends instructions to commercial payment processor 580, which executes the instructions on payment network 572.

Some financial institutions, such as certain brokerage firms and credit unions, are not coupled to the payment network 572. These financial institutions use an intermediate financial institution to gain access to payment network 572. For example, in the environment of FIG. 16, a brokerage firm may gain access to payment network 572 through financial institution 574 or 576.

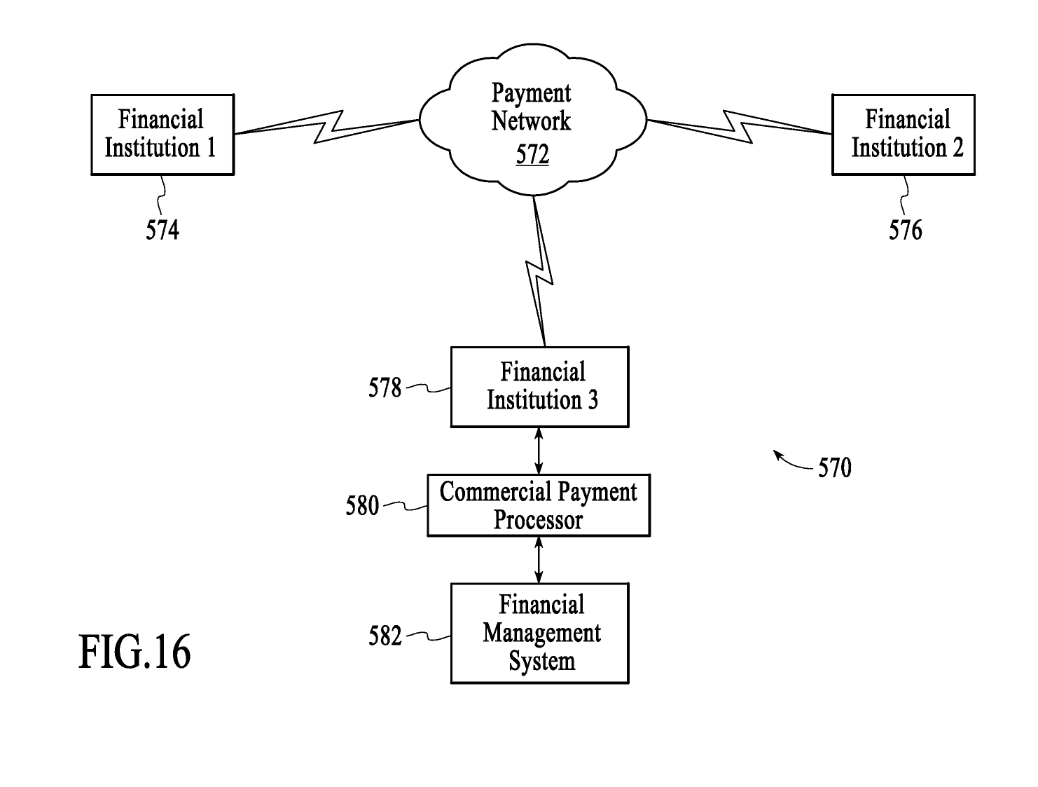

FIG. 17 is a flow diagram illustrating a procedure for transferring funds between two financial institutions. Initially, a user's account information is registered with the financial management system (block 588). After analyzing a user's asset accounts and/or debt accounts as discussed above (or based on a user's request to transfer funds between two accounts), the financial management system generates a fund transfer instruction (block 590). The fund transfer instruction can be divided into two separate transactions: a debit instruction (for the account from which the funds are to be withdrawn) and a credit instruction (for the account to which the funds are to be deposited). The debit instruction and the credit instruction are communicated to a payment processor (block 592). The payment processor initiates the requested debit and credit transactions through an intermediate financial institution (e.g., financial institution 578 in FIG. 16) that is coupled to the payment network (block 594). The debit transaction and/or the credit transaction can be performed in real-time or deferred. The debit transaction is received and executed by the appropriate financial institution (block 596) and the credit transaction is received and executed by the appropriate financial institution (block 598). If the financial management system has additional fund transfers to execute (block 600), the procedure returns to block 590 to execute the next transfer. The procedure terminates after executing all fund transfers.

For example, in the environment of FIG. 16, the financial management system 582 receives user account information during a user registration process. Next, the financial management system 582 analyzes the user's accounts and determines whether funds should be transferred from the user's checking account at financial institution 574 to the user's savings account at financial institution 576. To initiate this fund transfer, financial management system 582 generates a debit instruction to withdraw the appropriate funds from the user's checking account at financial institution 574. Additionally, financial management system 582 generates a credit instruction to deposit the appropriate funds (equal to the funds withdrawn by the debit instruction) into the user's savings account at financial institution 576. The instructions are then communicated via payment processor 580 and financial institution 578 onto the payment network 572.

Alternatively, fund transfers can occur as one-time transfers initiated by the user (e.g., transfer $500 from the user's savings account to the user's checking account) or as periodic transfers (e.g., transfer $750 from the user's money market account to the user's checking account on the 12th day of each month). Additionally, fund transfers can occur based on one or more rules, such as transfer $600 from the user's savings account to the user's checking account if the checking account balance falls below $300.

FIG. 18 illustrates another environment 620 in which funds are transferred between various financial institutions using multiple payment networks 626 and 628. In this example, a first financial institution 622 is coupled to payment network 626 and a second financial institution 624 is coupled to payment network 628. A third financial institution 630 is coupled to both payment networks 626 and 628. A financial management system 632 is coupled to financial institution 630. Financial management system 632 is similar to the financial management system 220, discussed above.

If a fund transfer is required between accounts at the two financial institutions 622 and 624, the financial management system 632 generates a fund transfer instruction. The fund transfer instruction may include the account information and financial institution information for the accounts involved, the value to be transferred, and other information. In this example, the transfer instruction is separated into two different transactions: a first transaction that withdraws the appropriate funds from an account at one financial institution and a second transaction that deposits those funds into an account at the second financial institution. Although two different transactions occur, the fund transfer appears as a single transaction to the user or account holder.

The environment shown in FIG. 18 may be referred to as a “hub-and-spoke” arrangement in which financial management system 632 is the “hub”, and financial institutions 622 and 624 each represent a “spoke”. In alternate embodiments, the environment in FIG. 18 can be expanded to include any number of spokes coupled to any number of financial institutions via any number of payment networks. This configuration allows financial management system 632 to control the execution of transactions between any of the financial institutions.

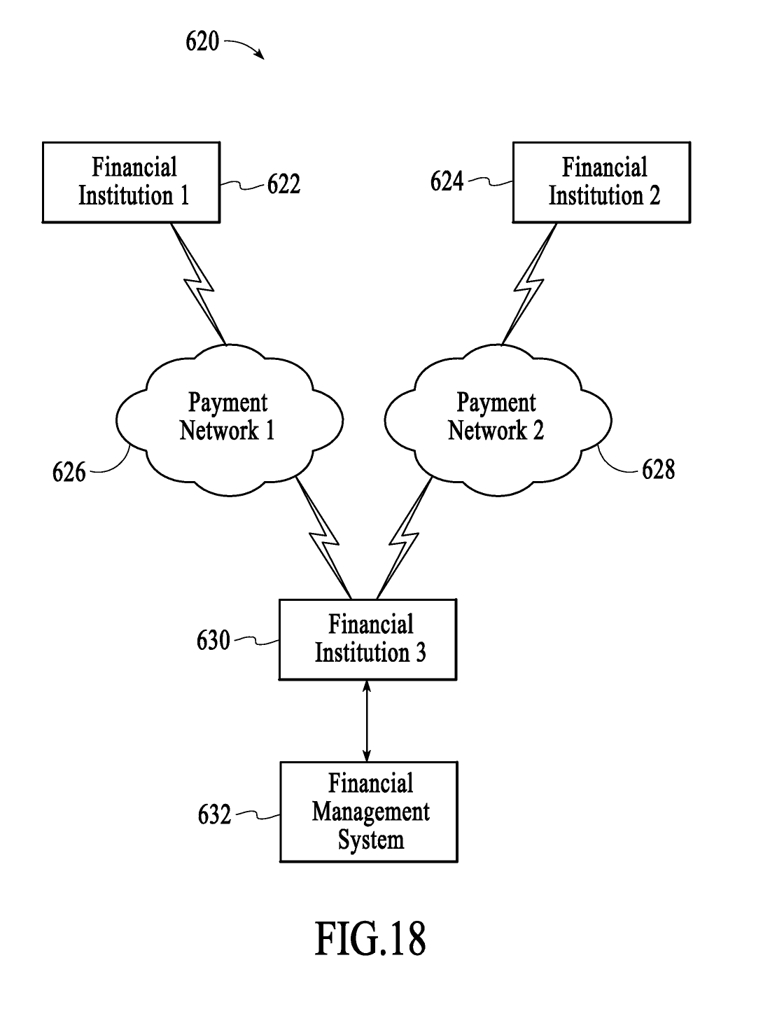

FIG. 19 illustrates another environment 650 in which funds can be transferred between various financial institutions using a payment network 652. In this example, financial institutions 654 and 656 are coupled to the payment network 652. A financial management system 658 is also coupled to the payment network 562 and a third financial institution 660. In this example, the financial management system 658 is capable of executing certain transactions directly on payment network 652, but uses a financial institution (or commercial payment processor) to execute other transactions on payment network 652. Thus, financial institution 660 is utilized for those transactions that cannot be executed directly by the financial management system 658. In one example, a funds transfer between financial institutions 654 and 656, for example, is separated into two different transactions: a first transaction that withdraws the appropriate funds from an account at financial institution 654. The funds are held in an “intermediary” account owned by the financial management system 658. Such an intermediate account could be at a financial institution such as financial institution 660. A second transaction initiated by financial management system 658 deposits the funds into an account at financial institution 656 from the intermediary account owned by financial management system 658. Although two different transactions occur, the funds transfer appears as a single transaction to the user or account holder. In the course of the funds transfer, financial institutions 654 and 656 do not deal directly with each other, and are not required to have any access data or other data regarding the other financial institution or its accounts or account holders.

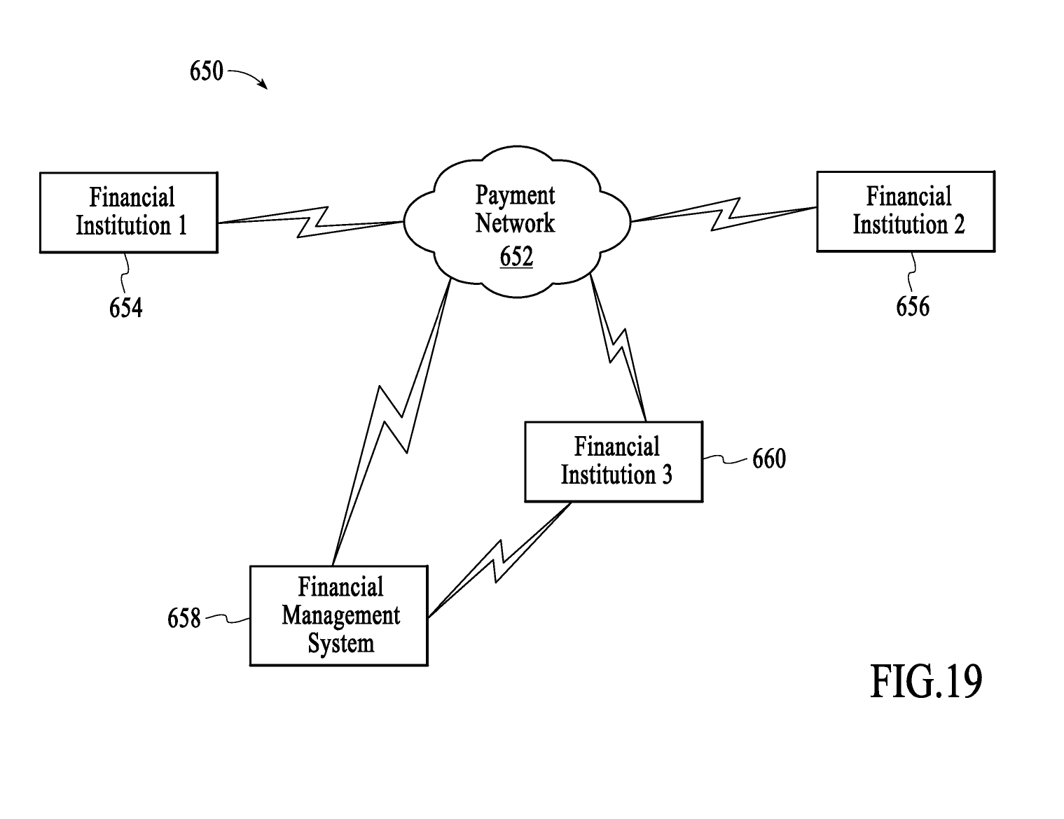

FIGS. 20-58 illustrate particular embodiments of a financial management system and funds transfer method such as those previously illustrated and described herein, that includes an invoicing application and payment hubs. The invoicing application and payment hubs enable an invoicing entity and a payer to each access a single underlying system including a single underlying software application for creating the invoice, modifying the invoice, paying the invoice, etc. The system thus provides multiple, views of the same data. The invoicing entity and the payer may access the invoice via different user interfaces, which are each coupled to an invoice database of the financial management system. The financial management system communicates through the underlying application with each of the invoicing entity and the payer such that payment account information (belonging to the payer) and destination account information (belonging to the invoicing entity) is never shared between the invoicing entity and the payer, but is only disclosed to the financial management system. The financial management system executes payment transactions related to an invoice according to the funds transfer methods described herein.

FIG. 20 is a block diagram of a system 2000 including an invoicing application and payment hubs, according to an embodiment. A financial management system 2002 includes an invoicing application 2004, payment hubs 2006, and databases 2008. The invoicing application 2004 includes user interfaces that allow a user to create and modify invoices as further described below. Payment hubs 2006 are access points through which payers can access the same invoices for payment. Payment hubs 2006 include web sites and user interfaces that can be branded for particular invoicing entities. Alternatively, a payment hub 2006 can be a location to which payers can go in order to view invoices from multiple invoicing entities. Invoices are stored in invoice databases 2008, and are updated whenever a user modifies an invoice, or when the system modifies the invoice. For example, the system may modify the invoice to reflect current penalties based on aging of the invoice. As further described below, invoices are payment enabled, meaning a user can pay the invoice from the invoice. When a payer clicks on the invoice to pay the invoice, it is paid according to the fund transfer methods described herein. A payer never needs to give financial account information directly to an invoicing entity. Payment information, including but not limited to, financial account at an institution, credit card information, pre-paid card information, etc., is given instead to the invoicing application through the payment hub and kept confidentially by the financial management system which acts as an intermediary between the invoicing entity and the payer.

Financial management system 2002 is coupled to one or more networks 2010, which can include any type of communications network such as the Internet, LANs, WANs, etc. Invoicing entities (“invoicers”) 2016 are similarly coupled to networks 2010. Also coupled to networks 2010 are funds sources 2012, which can include financial institutions, payment networks, or any source that has the ability to transfer funds electronically. Individual payer personal computers (PCs) 2014 are also coupled to networks 2010.

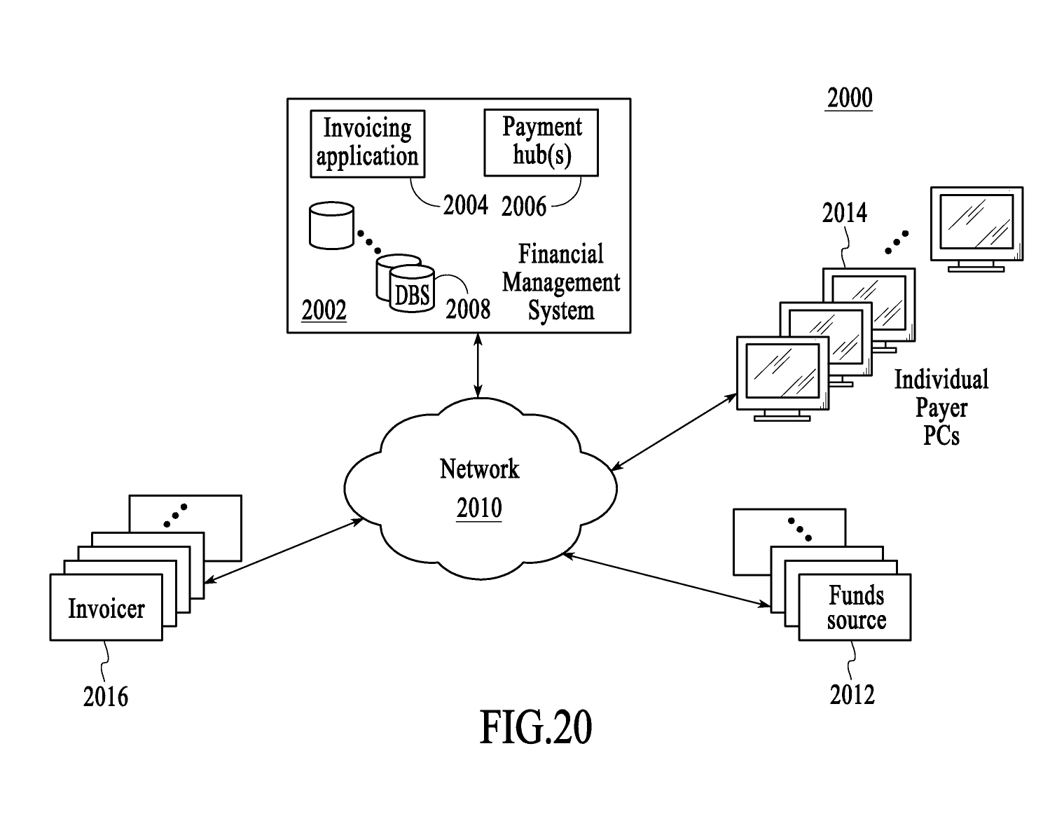

FIG. 21 is a block diagram of an invoicing application 2004, according to an embodiment. Invoicing application 2004 provides multiple functionalities based on the funds transfer capabilities described herein. These functionalities are provided by a pay employees module 2108, a pay vendors module 2106, a cashflow management module 2104, and a send invoice module 2102. The functionalities provided by the send invoice module 2102 are the main focus of the following description.

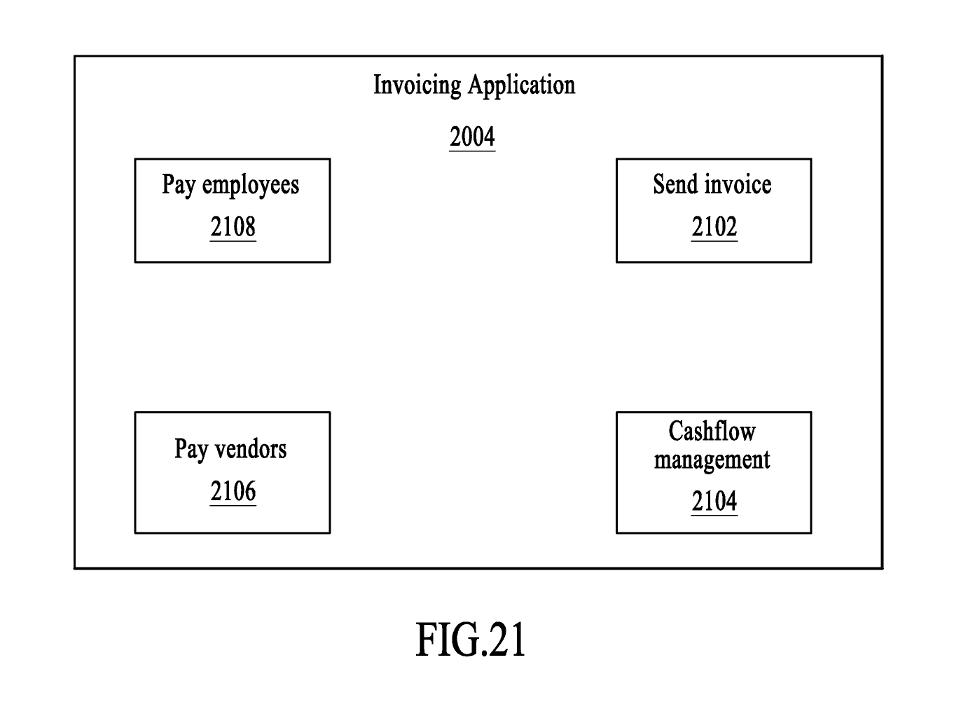

FIG. 22 is a block diagram of a system 2200 including an invoicing application, payment hubs, and user interfaces, according to an embodiment. The invoicing application 2204 communicates with a payer PC 2214 and can send emails notifying of a new or updated invoice. The invoice can also be sent by regular mail including the URL. Any other form of communication of the invoice or notification of the invoice is possible. The invoicing application 2204 also communicates with an invoice database (DB) 2208 to store invoices. The invoicing application 2204 communicates with payment hubs 2206, for example to post invoices for viewing and to execute payments. Payment hubs 2206 include user interfaces that are tailored as desired. For example, a small business could have its own payment hub appropriately branded as such. Invoices could appear on more than one payments hub if desired, while each payment hub would communicate any changes to the invoice to the invoicing application 2204 and the invoice DB 2208.

A payer can log into the payment hubs 2206 from payer PC 2214 using by entering a URL or by clicking on a link provided in an email from the invoicing application 2204.

An invoicing user interface (UI) is provided to invoicing entities for creating business profiles, customers, and invoices, as further described below. Accounting software (SW) 2218 is optionally used by an invoicing entity to communication with the invoicing application for maintaining consistent data regarding invoices created as described herein. The invoicing application 2204 is further coupled to payment processing 2216, which can include ACH processing, credit card payment processing, or any other network-based method of transferring funds from any type of asset account or liability account.

FIGS. 21-22 are examples of particular system configurations, but many alternative configurations are possible. In addition, the multiplicity of payment hubs (all centrally administered) allows high flexibility in creating invoicing business models. For example, the system of FIG. 20 is applicable to an embodiment in which each invoicer 2016 buys the invoicing capability described herein from a financial institution that the invoicer does business with (e.g., funds sources 2012). In this case, a payer 2014 accesses a financial institution-branded payment hub, and views all of the invoices received for the payer from participating businesses.

In an alternative embodiment, the payer can log into a financial institution web site and view various invoices from various invoicers (same as above). However, clicking to pay a particular invoice takes the payer to a business-branded page.

In another alternative embodiment, multiple financial institutions aggregate their respective payment hubs. This provides a payer with a larger pool of possible invoicing entities that all contribute invoices to the aggregated payment hub, creating a larger network of participating invoicers and payers. In the embodiment just described, a financial institution is provided as an example of an entity that would be a logical provider of payment hub services, but an entity with access to appropriate infrastructure could provide the described services.

In yet an alternative embodiment, a payer can log into a payment hub directly from an invoicer “biller-direct” web site and view a business-branded payment hub containing only the invoices from that particular invoicing entity. In one such system, a global network of centrally administered payment hubs is made available to invoicers and payers of all sizes, anywhere. All of the embodiments described are examples of the high flexibility in layering payment hubs that is provided by the system and methods herein.

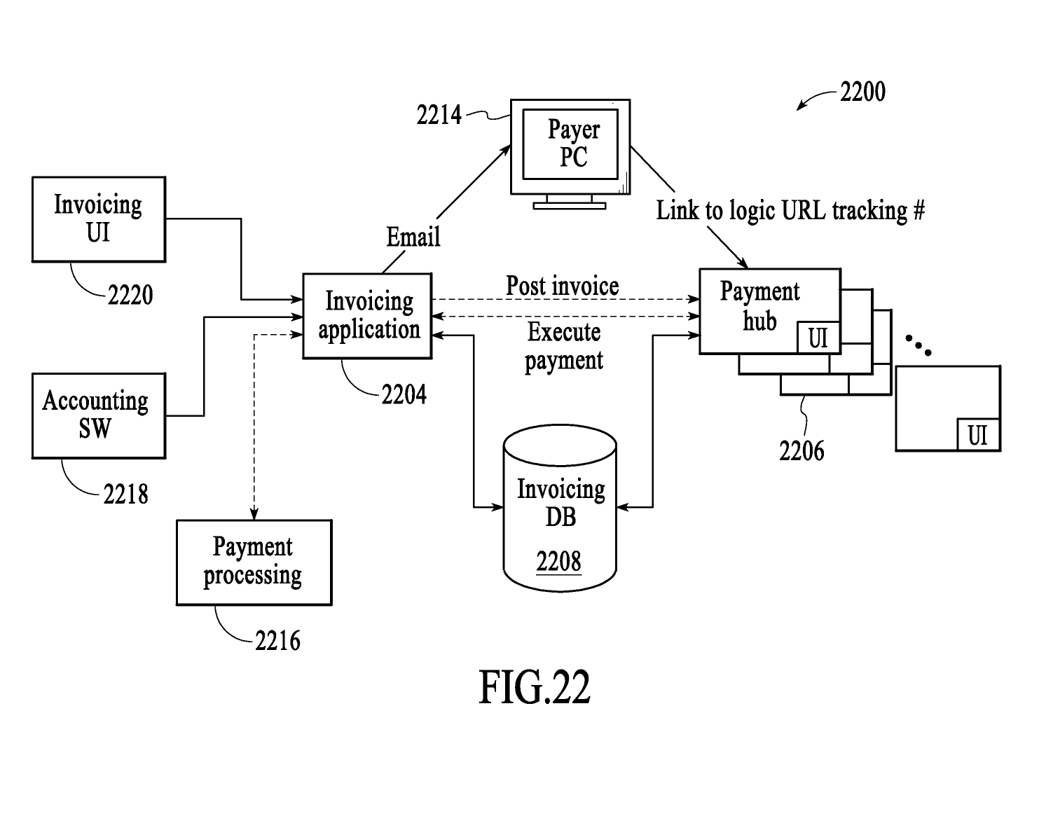

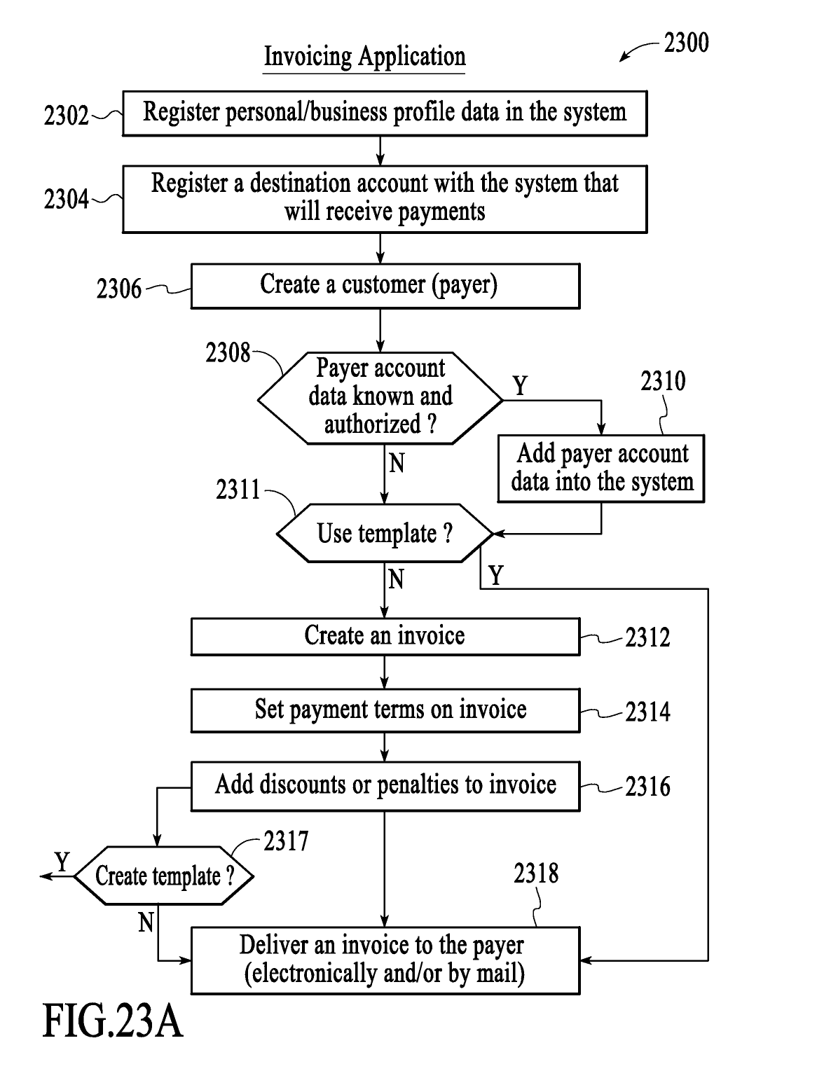

FIG. 23A is a flow diagram of an invoicing application process in a payment enabled invoice method 2300, according to an embodiment. For example, FIG. 23A describes an invoicing entity interacting with the UI 2220. An invoicing entity registers a personal or business profile at 2302. An invoicing entity can be an individual, a small business, or any type of entity. A single invoicing entity can enter multiple profiles, if desired. The invoicing entity registers a destination account at 2304 which will be used to receive payments of invoices. The invoicing entity creates a customer (or payer) at 2306. At 2308 it is determined whether the invoicing entity has previously received authorized payer account data from a payer regarding an account that the payer has designated for use. If the payer account data is known and authorized, the payer account data is entered into the system at 2310. According to embodiments, payer account data is not required, and in most instances will never be known by the invoicing entity, although it could be. Whether the payer account information is known and entered or not, it is determined at 3211 whether an invoice template is to be used. As further described below, an invoicing entity can create and store invoice templates for reuse. If an invoice template is not to be used, the invoicing entity creates an invoice at 2312.

The invoicing entity sets payment terms on the invoice at 2314. Payment terms include how long a payer has to pay before finance charges are assessed, the amount of finance charges, and so on. Any discounts or penalties can be added to the invoice at 2316. In an embodiment, the discounts and penalties are automatically updated based on the payment terms that are set. For example, if a payer accesses an invoice after the designated period for payment, the invoice automatically updates to include finance charges as appropriate. In addition, the invoice can be configured (at 2314) to prompt the payer to pay by a certain date in order to realize a discount or avoid penalties.

At 2317, the invoicing entity can choose to create a template using the invoice just created. In an embodiment, choosing to create an invoice template at 2317 takes the invoicing entity to another screen which allows modifications to the template before storing it for future use.

If the invoicing entity chooses not to create a template, the invoice is delivered to the payer at 2318 by the invoicing entity clicking on the invoice in the invoicing UI 2220.

FIG. 23B is a flow diagram illustrating a process 2301 of creating an invoice template according to an embodiment. At 2320 payment terms are set (or reviewed if already set at 2314). Discounts and/or penalties are added at 2322 (or reviewed if already added at 2316). At 2324, a list of broadcast payer recipients can be added. This enables the invoicing entity to broadcast the same invoice, except for the payer identification, to multiple payers. The invoicing entity can schedule recurring invoicing events at 2326. This is useful when invoices do not vary in amount, and other particulars, from one invoicing event to another.

At 2328, an option is provided to cause automatic updating of information and control subsequent invoices to one payer based on payment history. For example, invoices can be aggregated, including generating a current invoice that has a total amount owed (from current and past invoices) while storing previous invoices as appropriate to acceptable accounting principles. Another option is to generate a statement that sets out the current and past invoices and the payment status and penalty/discount information for each. A per-invoice aging report is a form of statement that can be generated, but embodiments are not so limited. The aggregated invoice, statement or aging report can accompany the current invoice, or replace it with all of the payment enabled capability described herein.

When the invoicing entity has completed the creation of the invoice template it is stored at 2330, for example by clicking “store”. The order of elements listed in FIG. 23B is just an example, and the order could be rearranged in any way. The invoicing entity, in one embodiment, has all of the actions available on the same screen and can click on any one to update it at any time in the creation process.

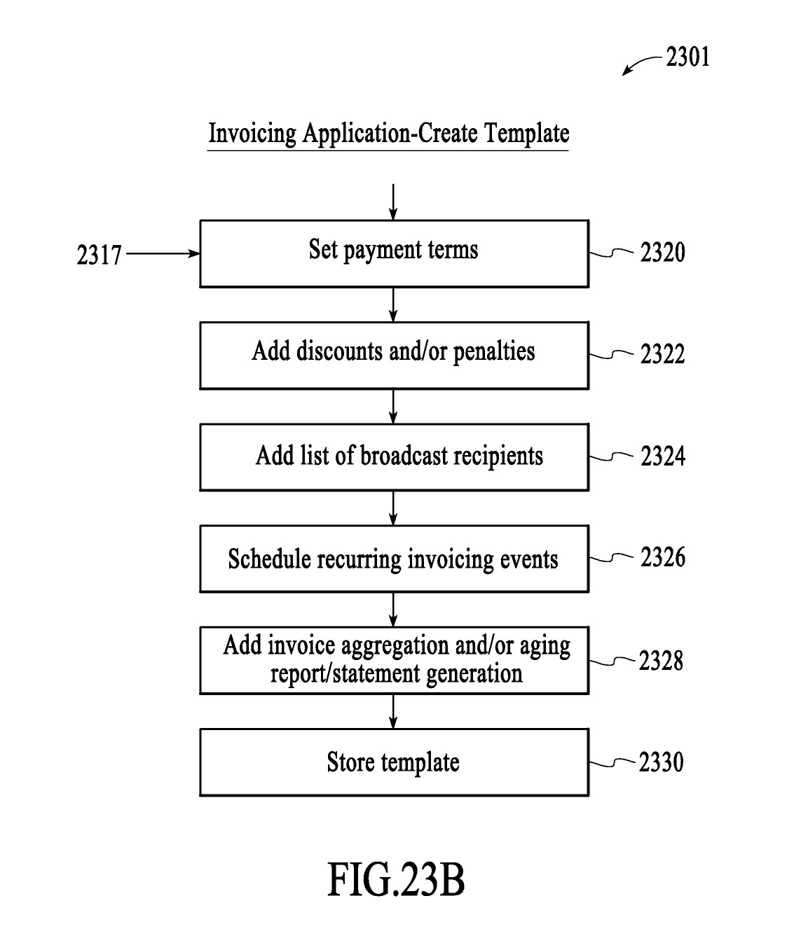

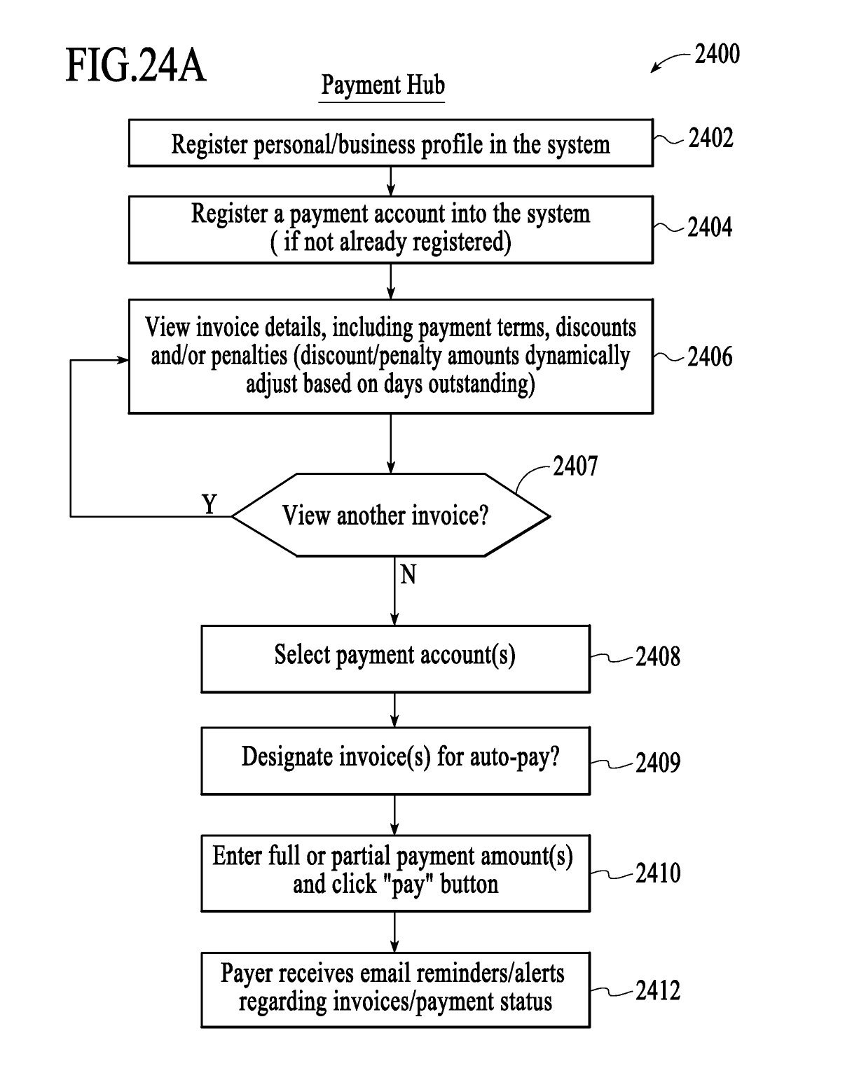

FIG. 24A is a flow diagram of a payment hub process 2400 in a payment enabled invoice method, according to an embodiment. For example, FIG. 24A describes a payer interacting with a UI through a payment hub 2206. A payer registers a personal or business profile at 2402. A payer can be an individual, a small business, or any type of entity. The payer registers a payment account at 2404 which will be used to fund payments of invoices. The payer can register multiple payment accounts and choose among them to pay different invoices.

At 2406, the payer views invoice details, such as payment terms, discounts and/or penalties applicable, etc. The discounts and/or penalties are adjusted automatically, for example based on the number of days the invoice is outstanding.

The payer has the option to view another invoice at 2407. In various embodiments, different invoices can be viewed from the same invoicing entity or different invoicing entities. If the payer has viewed all of the desired invoices, at 2408 the payer then selects one or more payment accounts from which to pay the one or more. invoices viewed. A payment account and a payment amount can be chosen for each invoice. The payer can also select one or more invoices to be automatically paid each time the invoice is generated by click “auto-pay” for example, at 2409. At 2410, the payer selected full or partial payment amounts for each of the selected invoices. In an embodiment, the payer can also select an aggregated payment as a total payment, according to which a single debit from a selected payment account is applied to more than one invoice. Payment is initiated as specified when the payer click “pay” at 2410. The payer receives email reminders and alerts regarding payment statuses and pending invoices, as shown at 2412.

FIG. 24B is a flow diagram of a payment hub “quick-pay” process 2401 according to an embodiment. In the example of FIG. 24B, a payer can use a payment hub to pay a single invoice without registering with the payment hub or having any payer information stored. The payer navigates to the payment hub using a uniform resource locator (URL). In an embodiment, the URL is in an email to the payer notifying of an invoice as shown at 2414, but embodiments are not so limited. The URL takes the payer to a payment hub, and at 2416, the payer views the specific invoice that is the subject of the notification. By clicking “Quick Pay” at 2418, the payer chooses to pay the specific invoice without registering as a payer with the payment hub. The payer can enter minimal identification information and payment type and account information at 2420. This information is a subset of the information that would be solicited from the payer on registering with the payment hub. The payer then initiates payment of the invoice by clicking “pay” at 2422. Payment is executed by the financial management system.

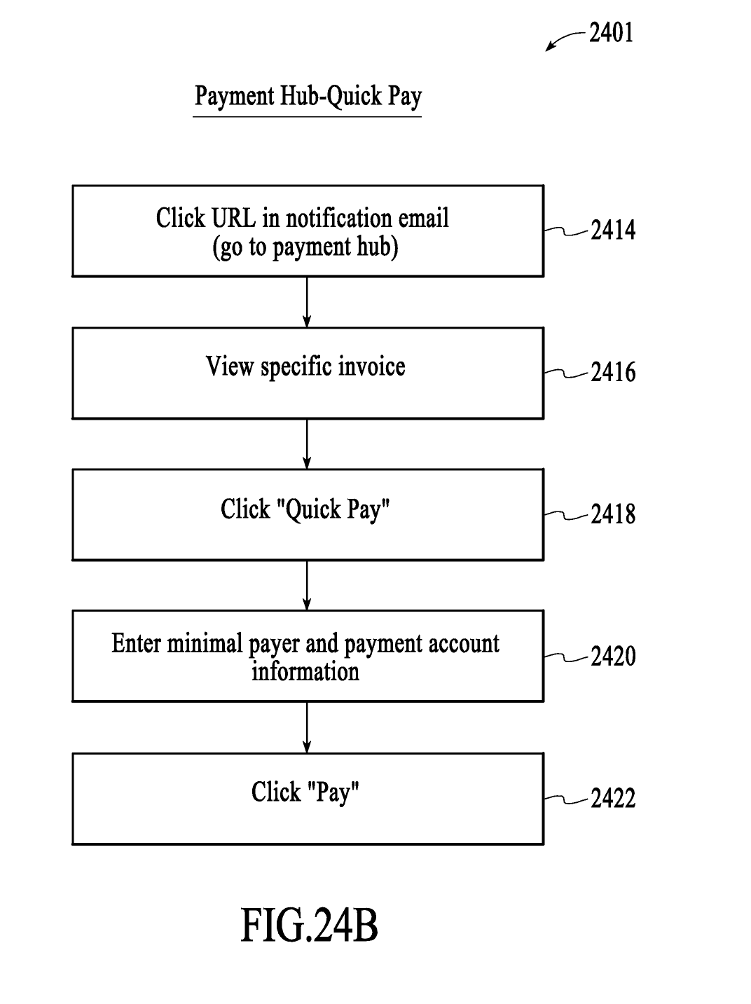

FIG. 25 is a flow diagram of invoicing entity actions and payer actions in a payment enabled explanation of benefits (EOB) method, according to an embodiment. An EOB as used herein is a type of settlement statement that an insurer would send an insured in response to the insured submitting a claim. Medical EOBs are one example. In this example, an insurer receives a claim submitted by an insured or by a provider. The insurer adjudicates the claim and sends an EOB to the insured detailing what payments the insurer will make against which charges. EOBs can be used in non-medical contexts as well, such as the casualty insurance context.

Payment of medical bills is typically a manual, paper based process that requires payers to write out and mail a physical check. Additionally payers must match up invoice amounts from healthcare providers with required payment amounts as adjudicated by insurers/processors. Tracking of healthcare invoices and EOBs is a cumbersome manual process. Because of the cumbersome nature of this paper process and the multitude of players involved in the computation of “amount owed” healthcare receivables are outstanding for a lengthy amount of time and providers often do not get payments. Using the payment enabled invoice as described herein overcomes these difficulties. In an embodiment, an EOB is a type of payment enabled invoice.

A healthcare provider (“provider”) registers a personal/business profile in the system at 2502. A single provider can enter multiple profiles, if desired. The provider registers payment account data in the system at 2504. Optionally, the insurer already has payment account data associated with the provider. At 2506, the payer utilizes healthcare services, such as going to the doctor for a checkup or having a surgical procedure performed. The provider submits a claim for the healthcare services to an insurer/processor at 2508. The financial management system associates the EOB with a particular provider and particular payer at 2510. The insurer/processor adjudicates the claim at 2512. The provider then sends the EOB to the payer (electronically and/or by mail).

If the payer has not previously used a payment enabled EOB, the payer may log into the appropriate payment hub using a link provided in an email or in a paper EOB or notification. If the payer has not previously registered personal profile data, the payer registers personal profile data in the system at 2516 after logging into the payment hub. If the payer has not previously entered payment account data to be used to pay the invoice, the payer registers payment account data in the system at 2518.

The payer receives the EOB at 2520 based on personal profile data that the system is able to associate with the EOB. In contrast to other online payment systems, the payer does not enter a particular invoice number or a number of an account the payer has with the invoicing entity. The invoice DB maintains the invoices as dynamic documents that are searchable by the system according to any information included in the invoices, such as payer identification. Any invoice in the system, whether paid or unpaid, can be accessed by an associated invoicing entity or payer. The payer can select any payment account that has been entered into the system, and click “pay” to initiate payment of the EOB.

Payment is electronically processed out of the payer's account and into the provider's account at 2522.

The provider and the payer may view the status of and invoice (EOB), payments applied, balance owed, etc. in the system at 2524, or at any time after the invoice is created.

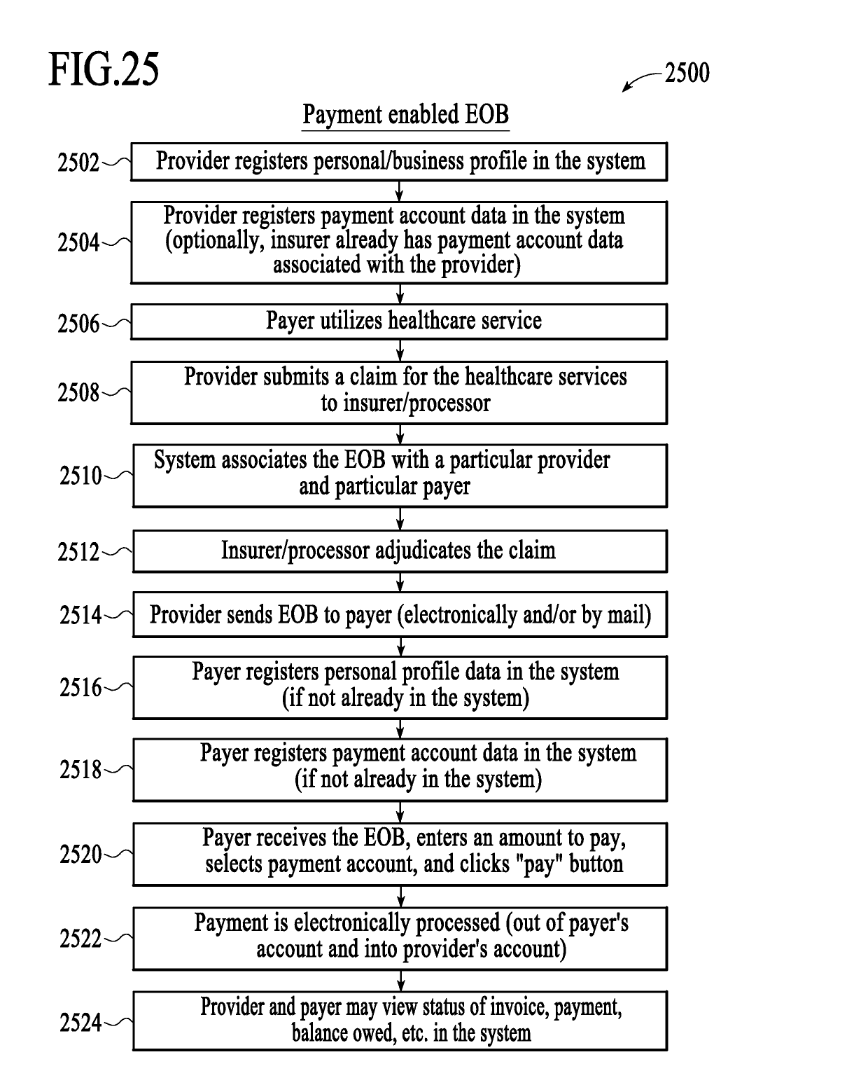

FIGS. 26-56 are screen shots that help to illustrate an embodiment of a payment enabled invoice method as described. In the embodiment of FIGS. 26-56, an invoicing UI is illustrated. The invoicing entity in the example of FIGS. 26-56 is a small business, but the invoicing entity could be a large business, or an individual.

FIG. 26 is an “invoice details” screen shot, according to an embodiment.

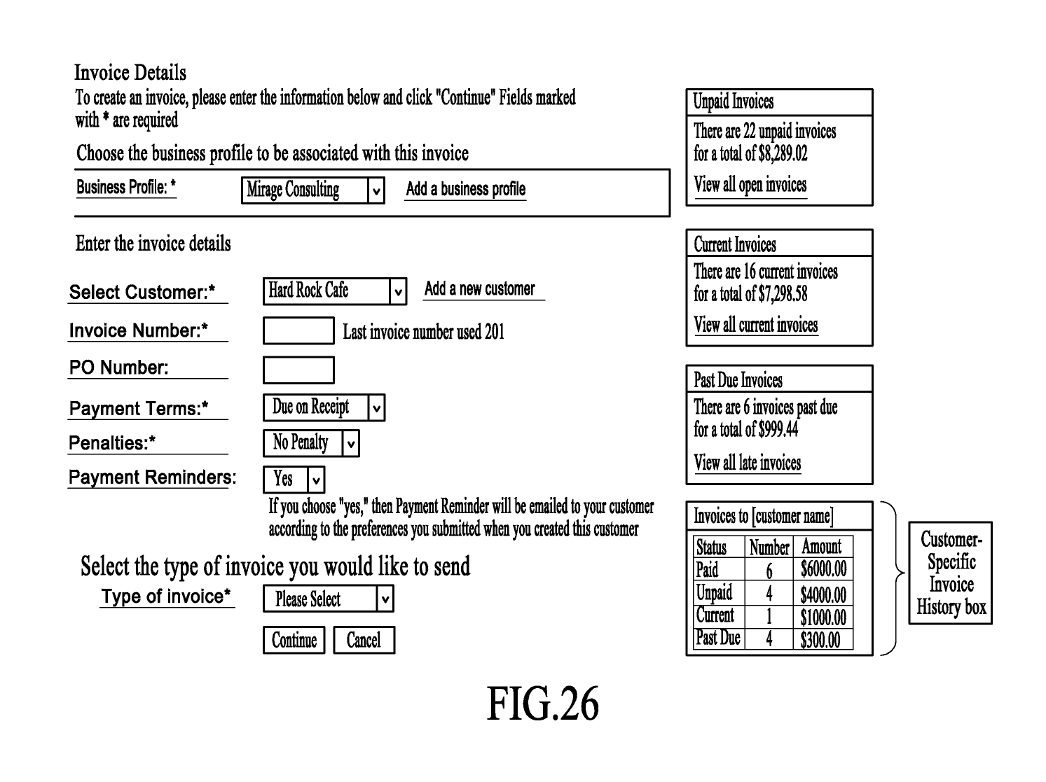

FIG. 27 is a “product invoice details” screen shot, according to an embodiment.

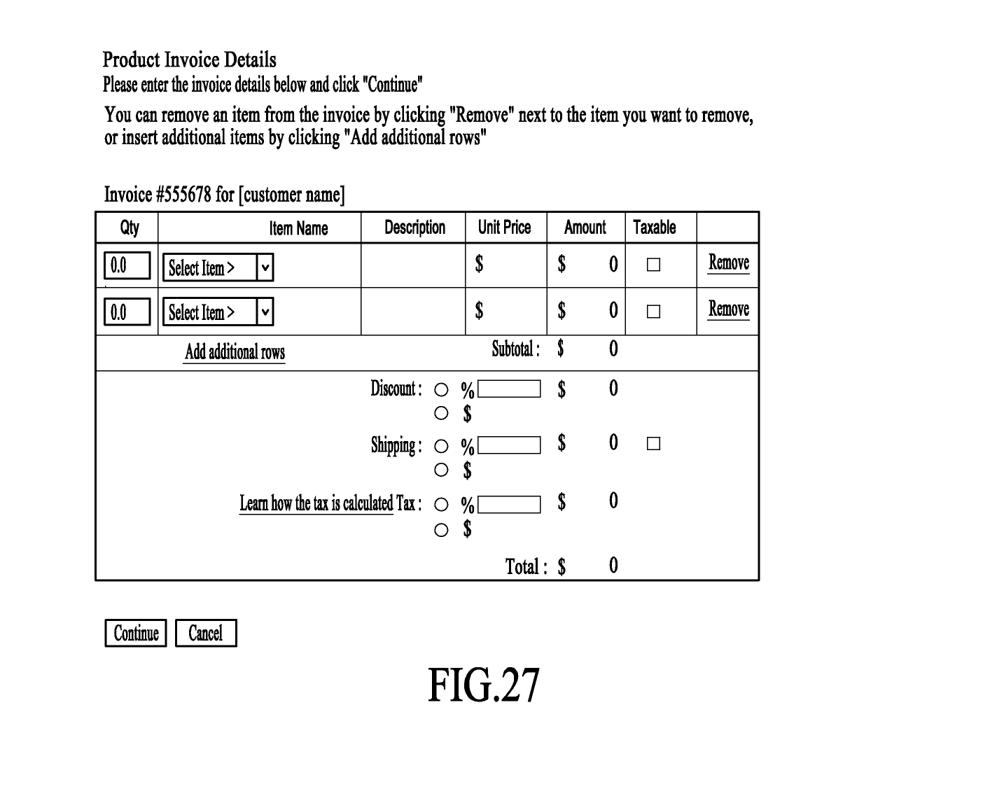

FIG. 28 is a “service invoice details” screen shot, according to an embodiment.

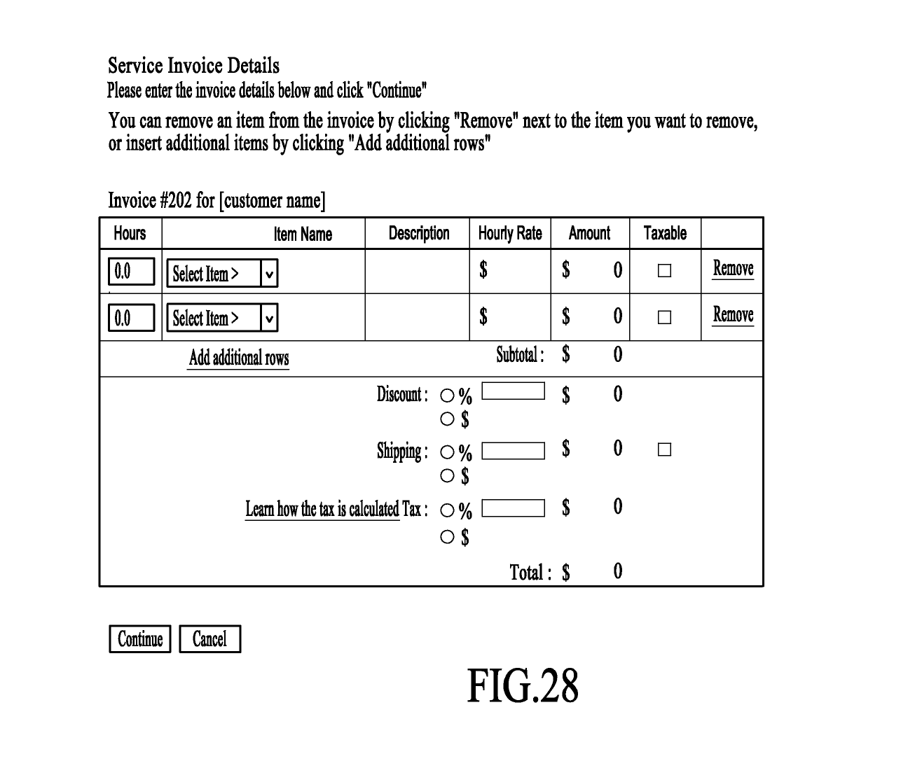

FIG. 29 is a “free form invoice details” screen shot, according to an embodiment.

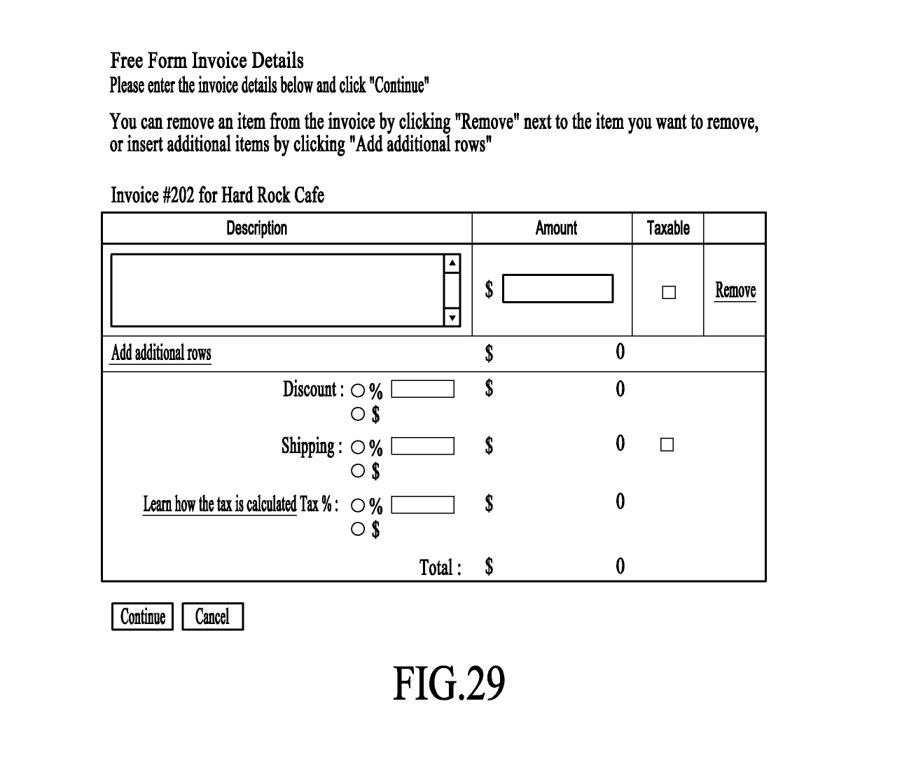

FIG. 30 is a “confirm invoice details” screen shot, according to an embodiment.

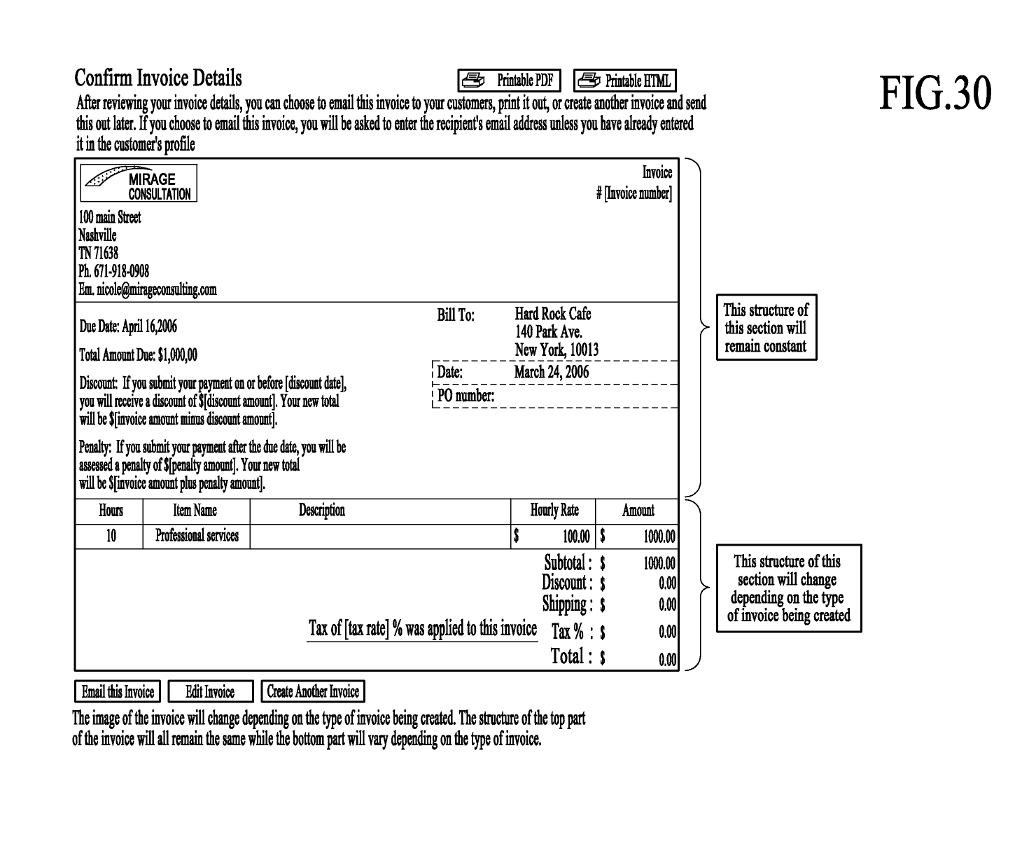

FIG. 31 is a “review email” screen shot, according to an embodiment.

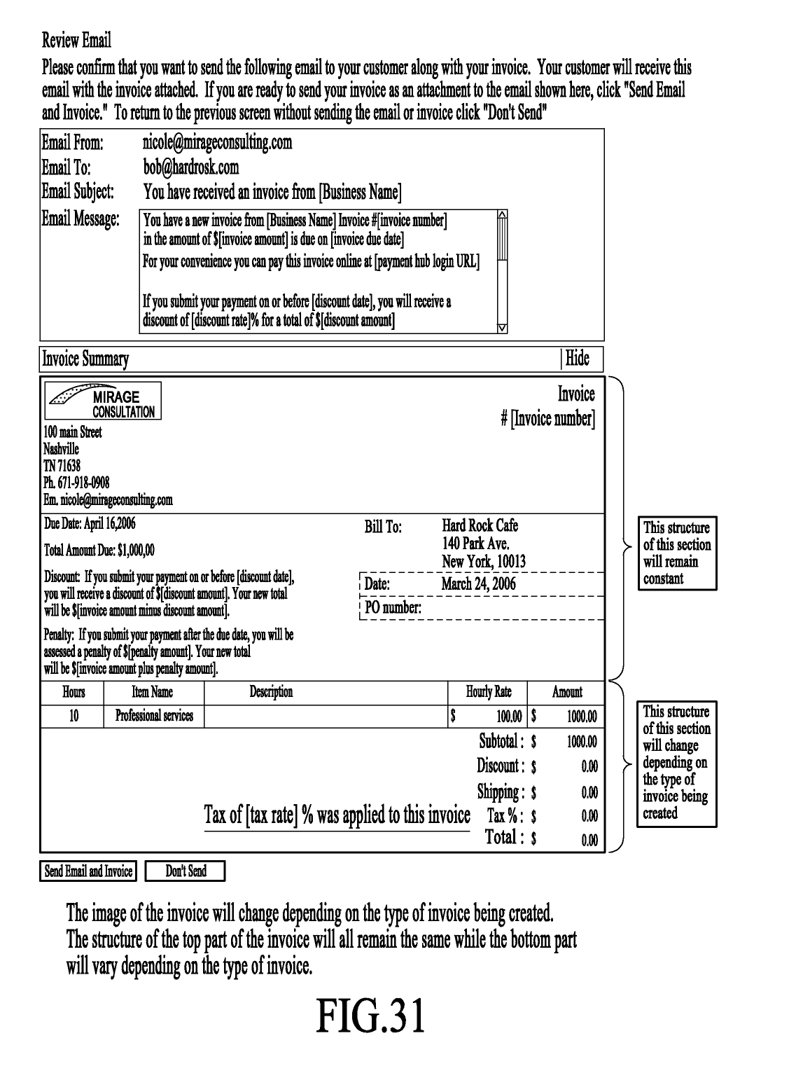

FIG. 32 is an “invoice sent” screen shot, according to an embodiment.

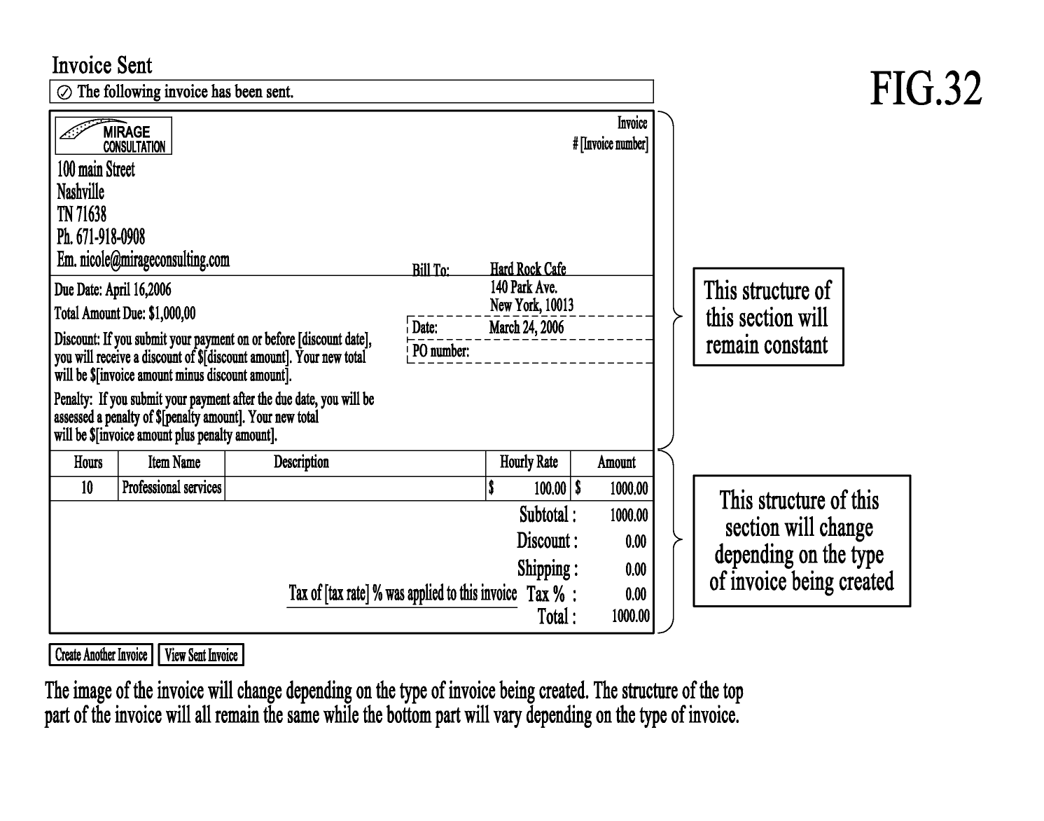

FIG. 33 is an “invoice history” screen shot showing paid invoices, according to an embodiment.

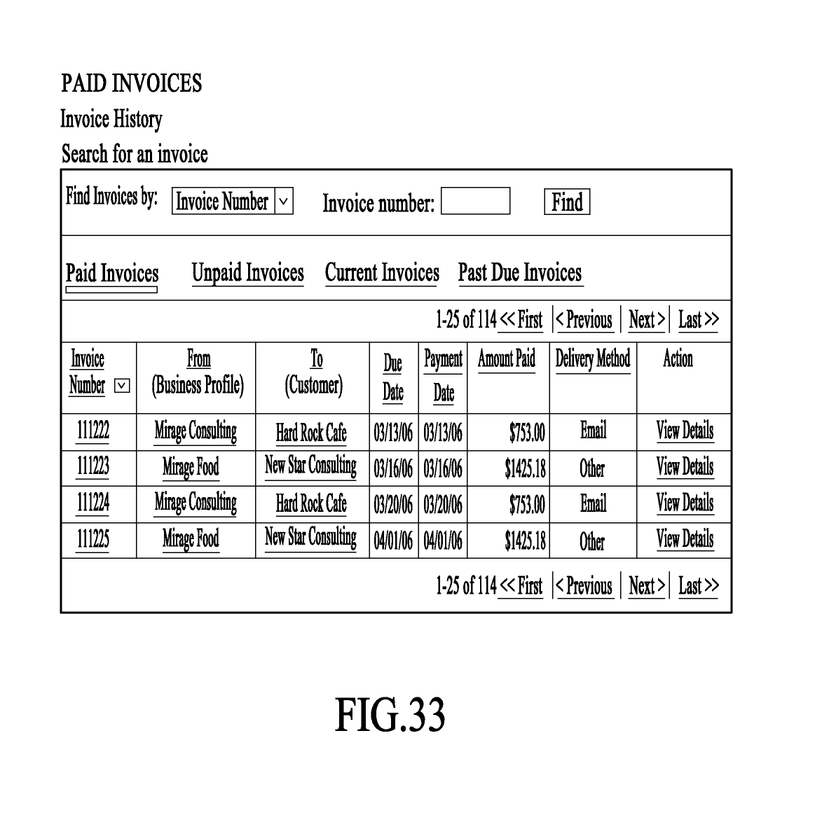

FIG. 34 is an “invoice history” screen shot showing unpaid invoices, according to an embodiment.

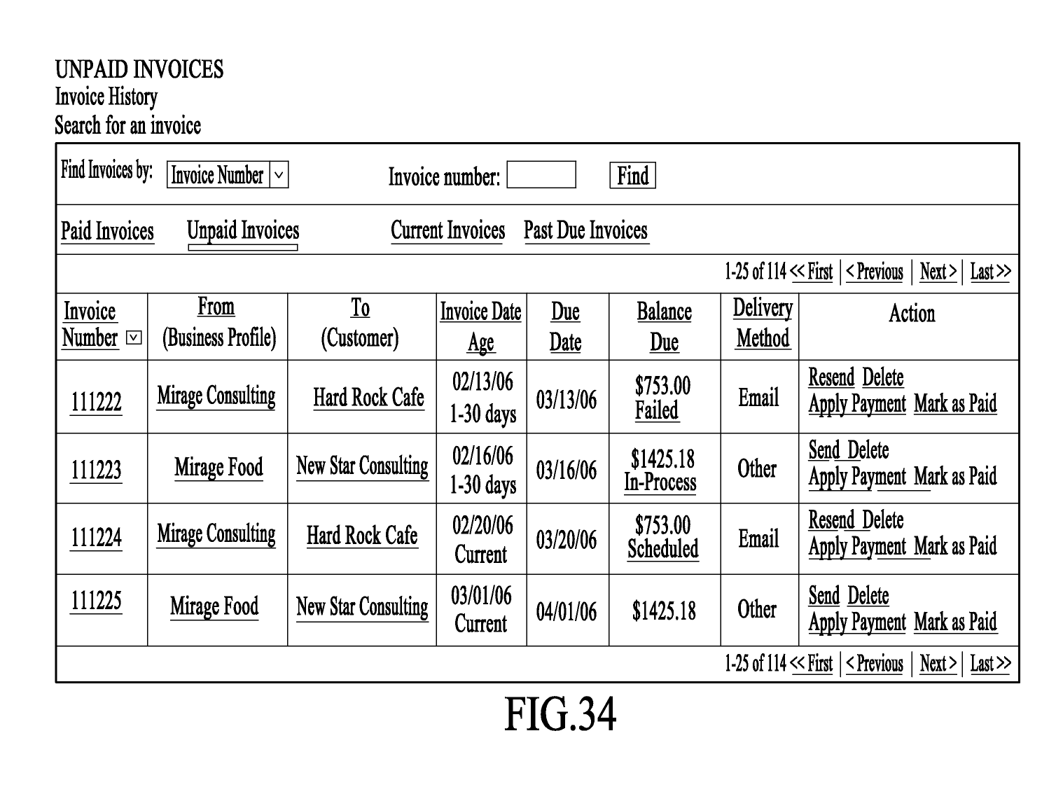

FIG. 35 is a “delete invoice” screen shot, according to an embodiment.

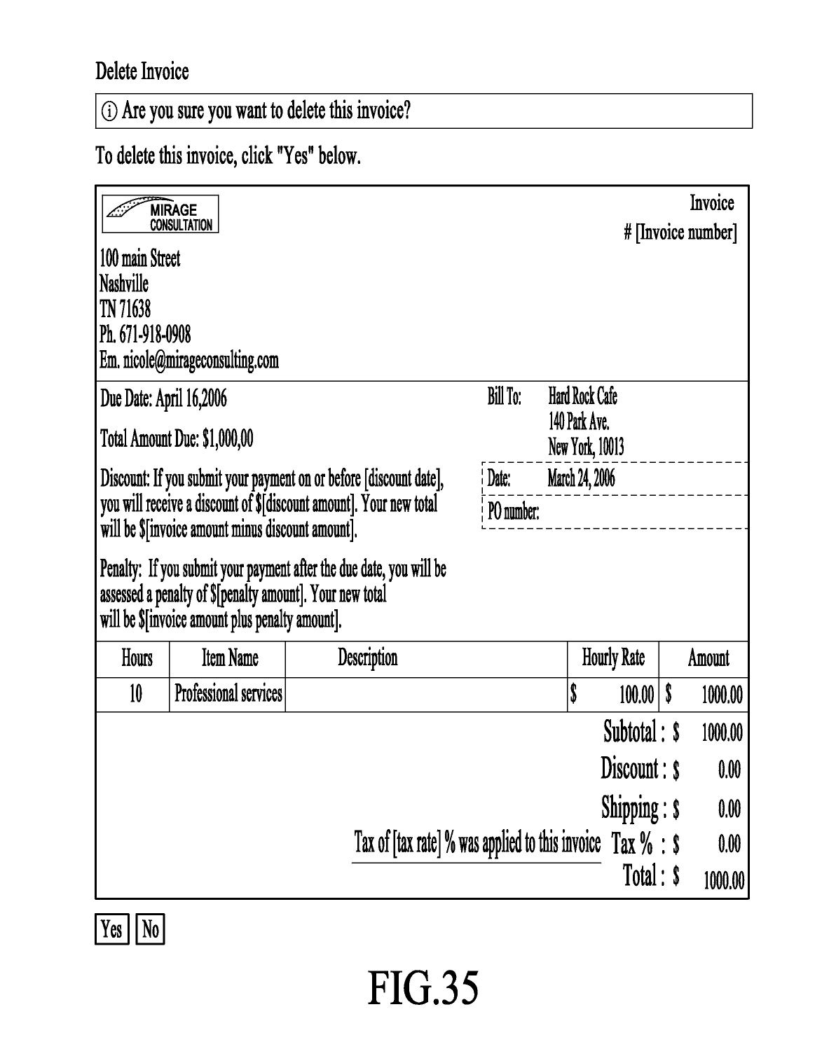

FIG. 36 is an “apply payment to invoice” screen shot, according to an embodiment.

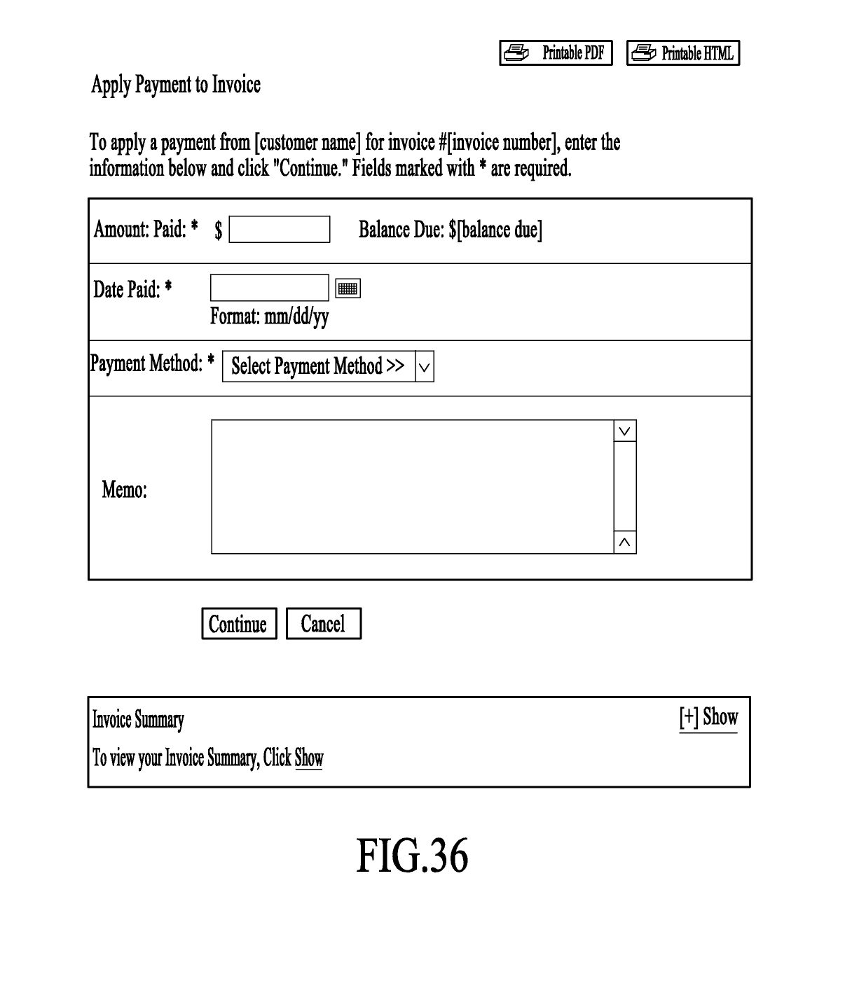

FIG. 37 is a “confirm payment to invoice” screen shot, according to an embodiment.

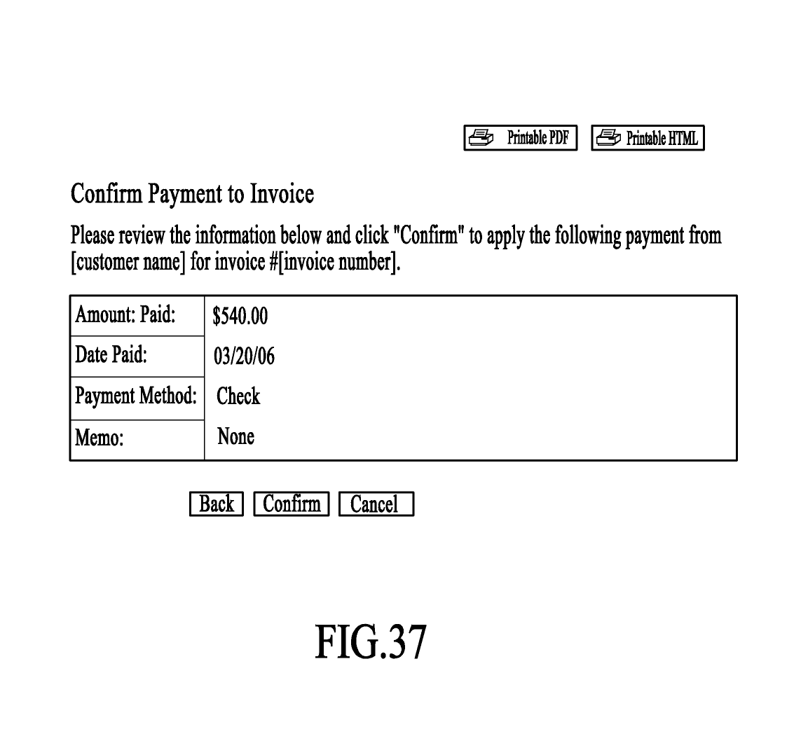

FIG. 38 is a “mark invoice as paid” screen shot, according to an embodiment.

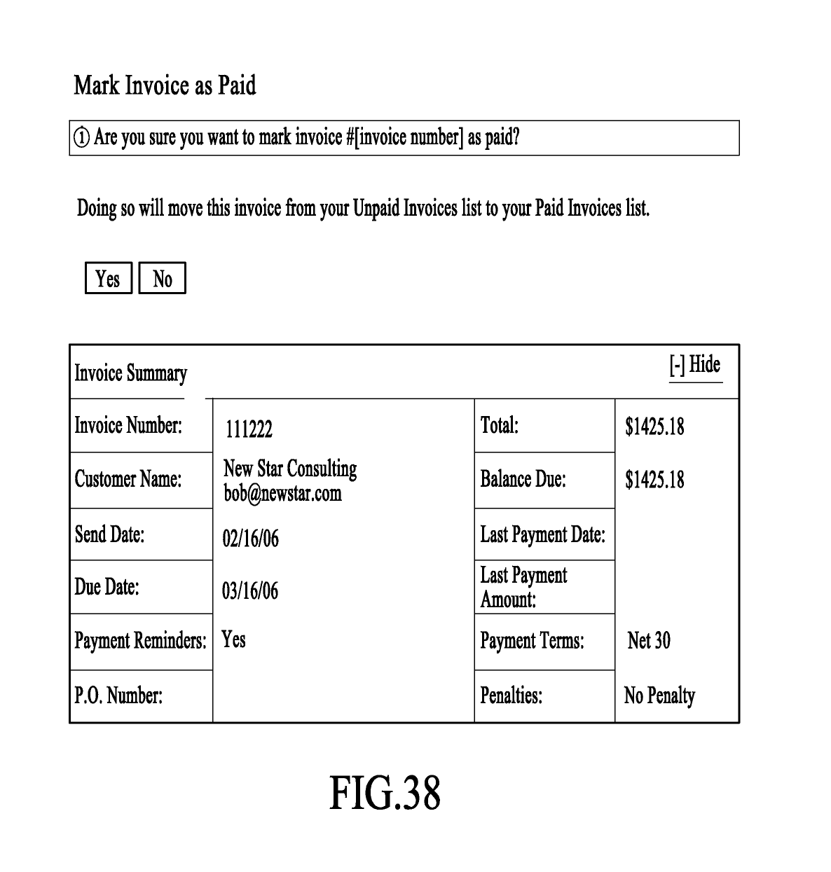

FIG. 39 is an “invoice details” screen shot, according to an embodiment.

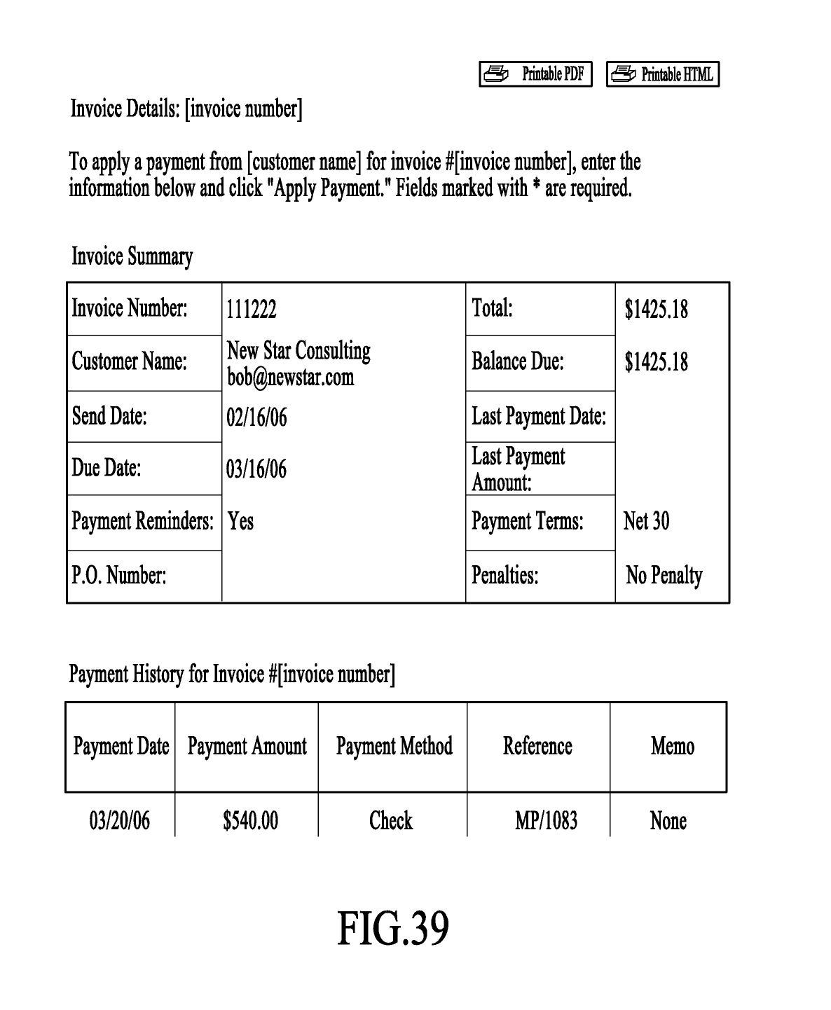

FIG. 40 is a “manage customers” screen shot, according to an embodiment.

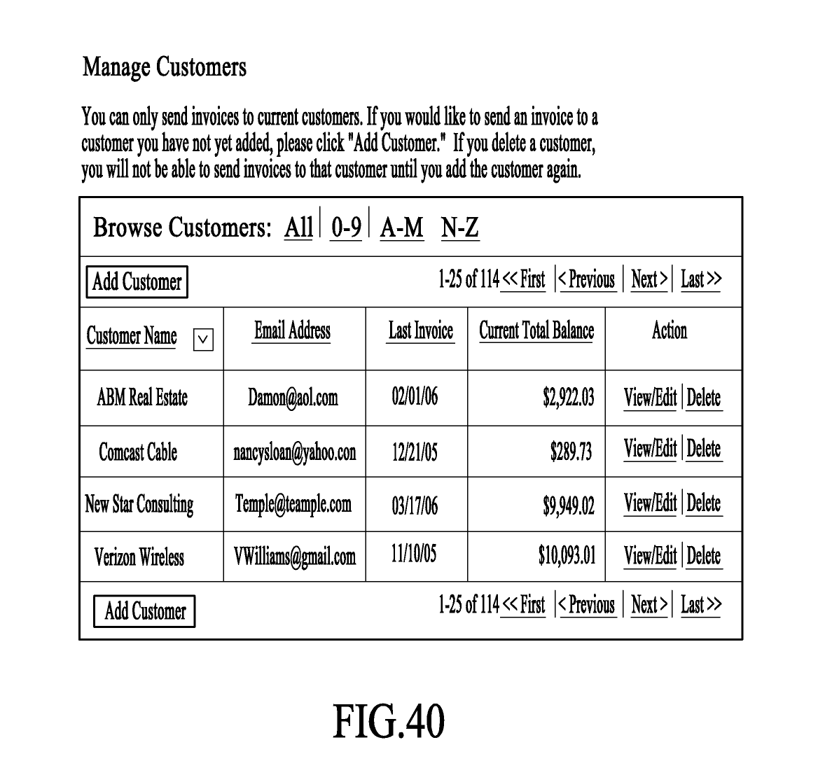

FIG. 41 is a “manage business profiles” screen shot, according to an embodiment.

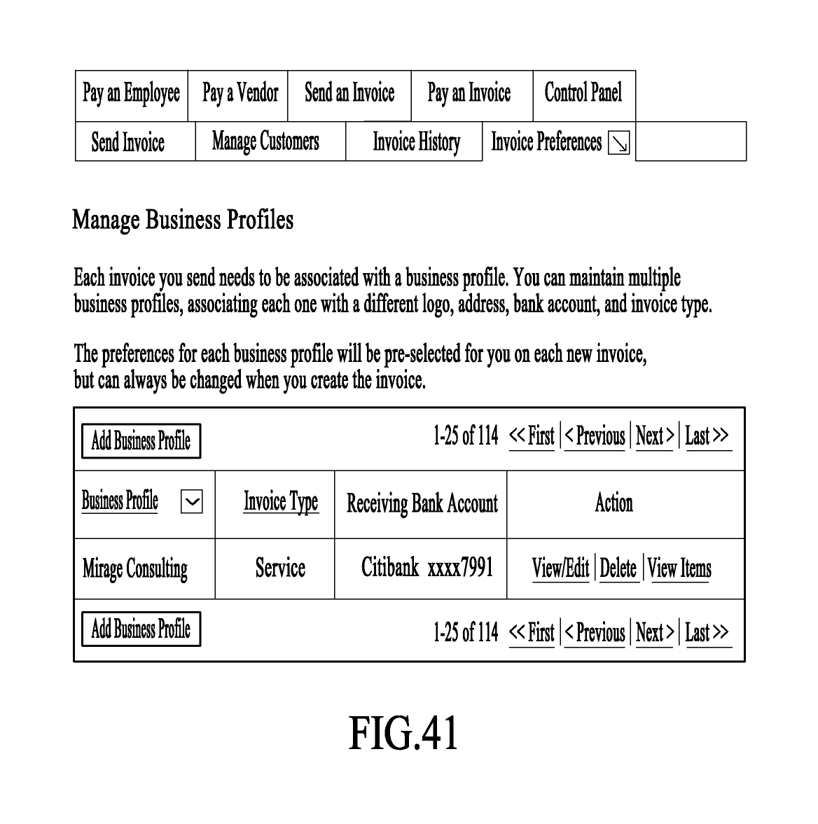

FIG. 42 is an “add business profile” screen shot, according to an embodiment.

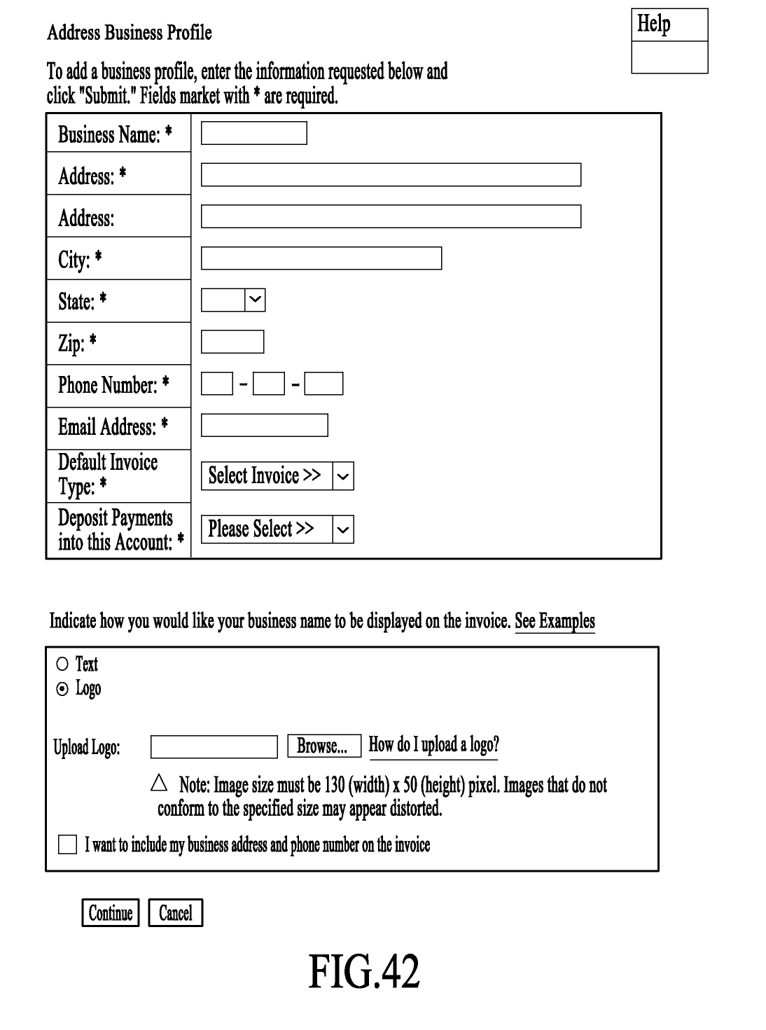

FIG. 43 is a “confirm business profile” screen shot, according to an embodiment.

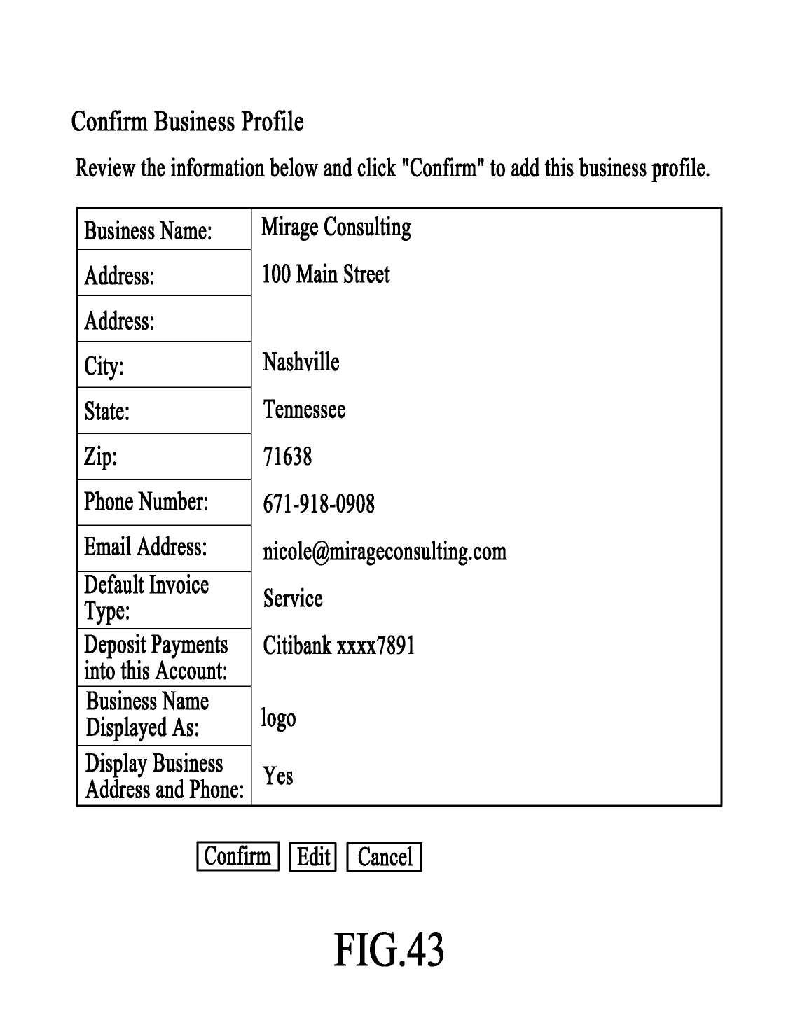

FIG. 44 is a “business profile added” screen shot, according to an embodiment.

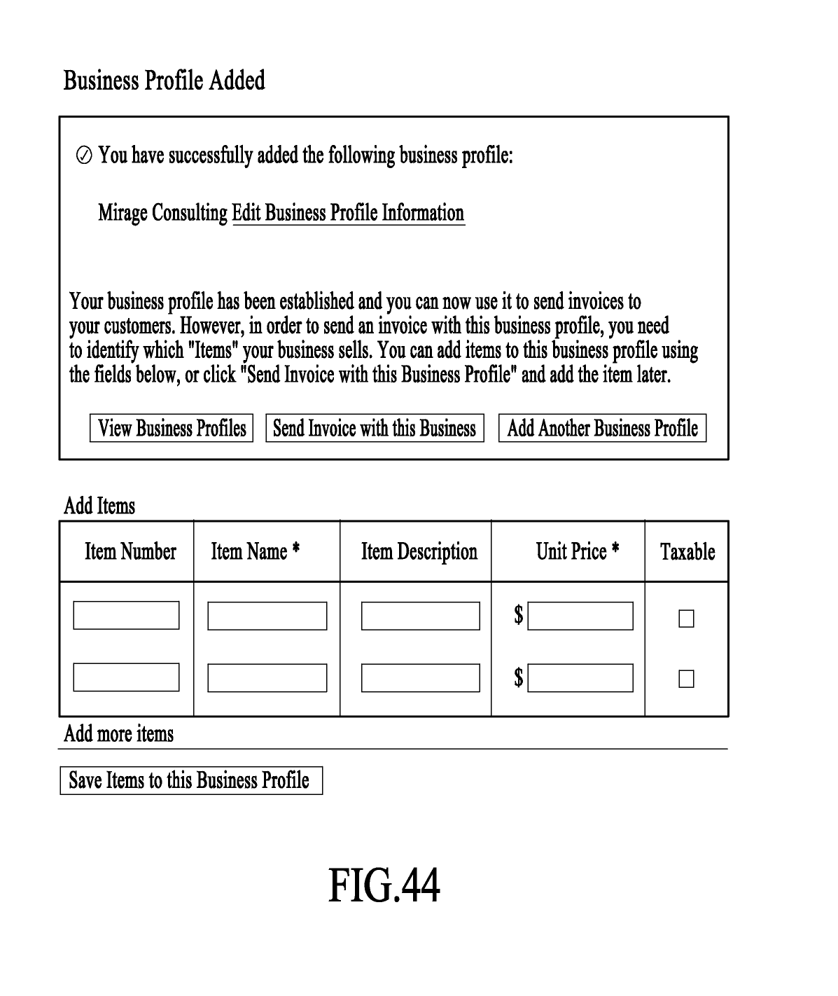

FIG. 45 is an “edit business profile” screen shot, according to an embodiment.

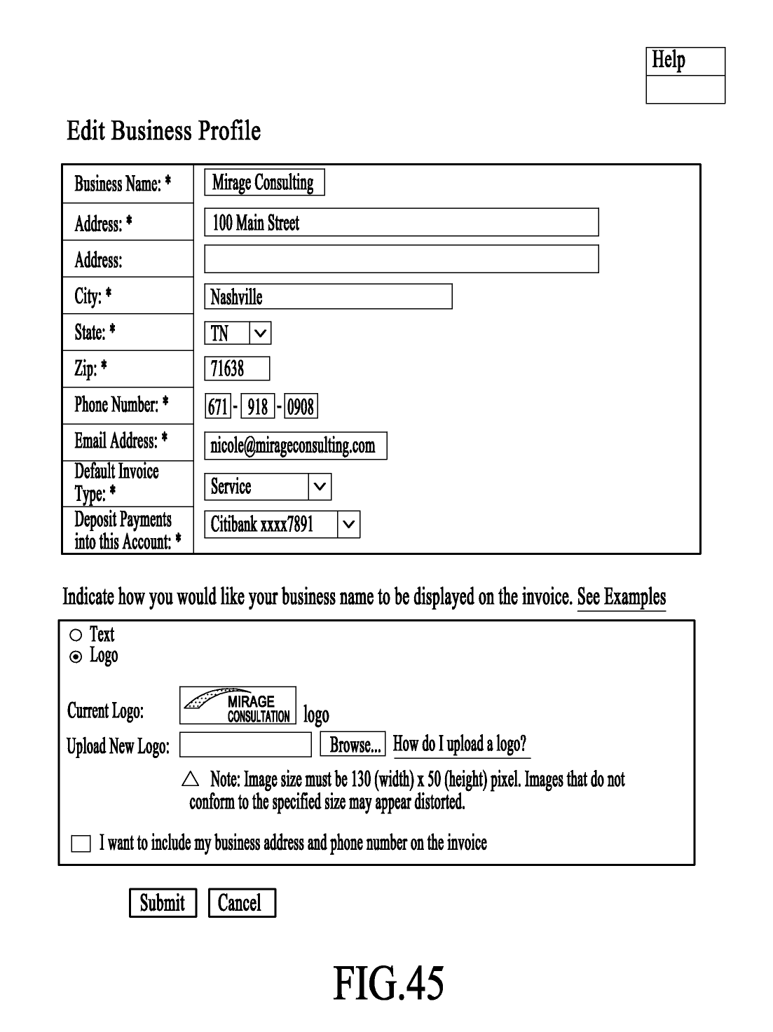

FIG. 46 is a “confirm business profile edits” screen shot, according to an embodiment.

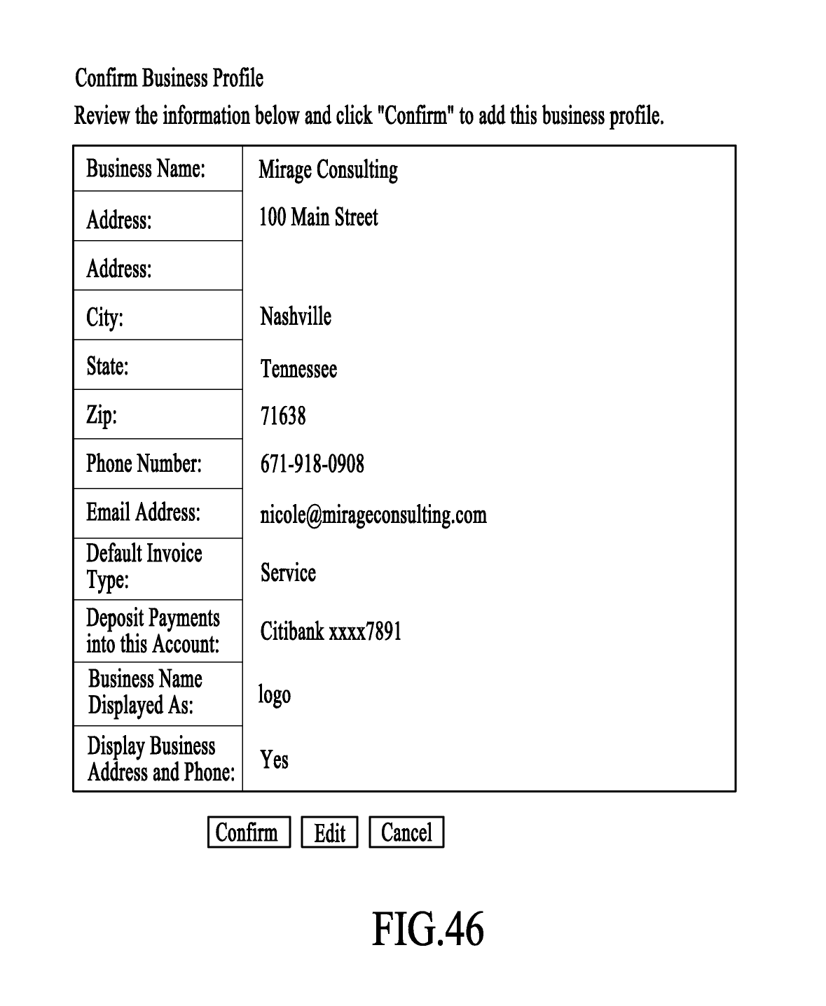

FIG. 47 is a “delete business profile” screen shot, according to an embodiment.

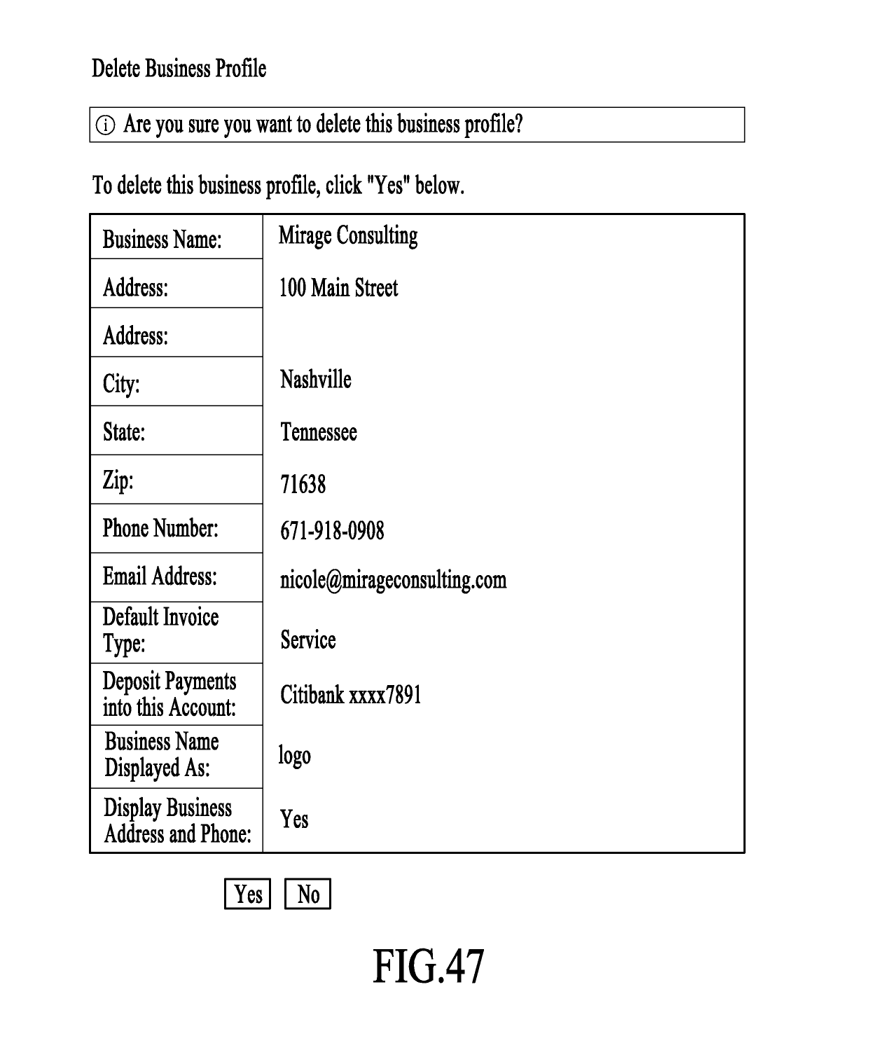

FIG. 48 is a “manage items” screen shot, according to an embodiment.

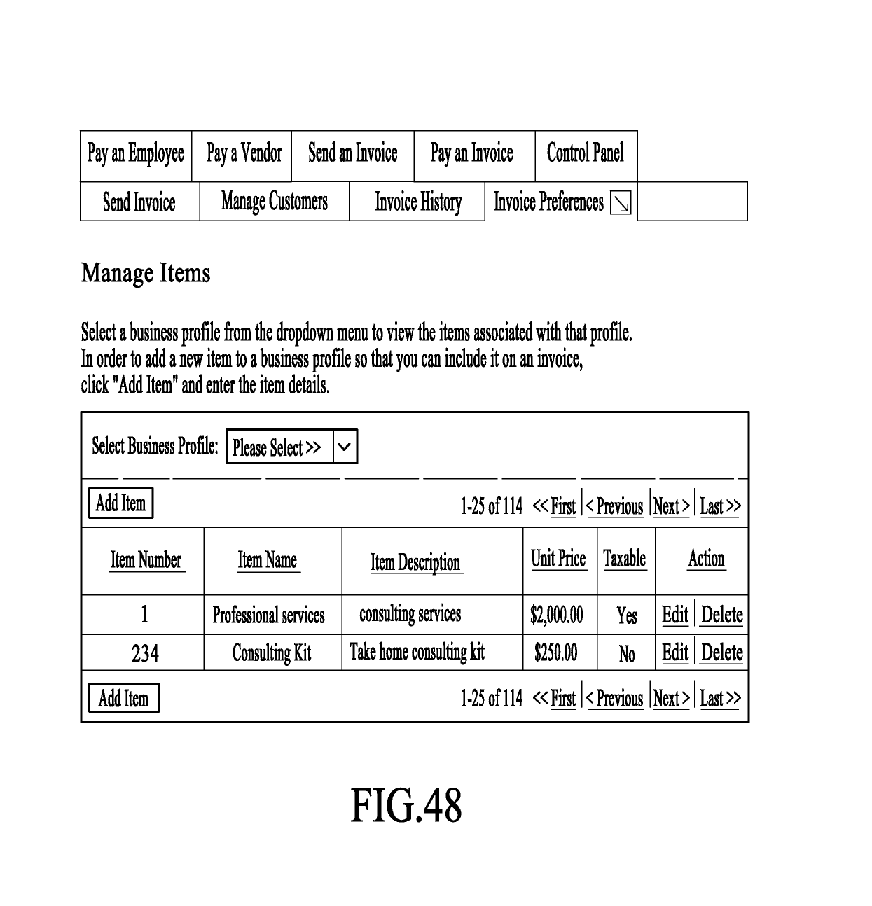

FIG. 49 is an “add item” screen shot, according to an embodiment.

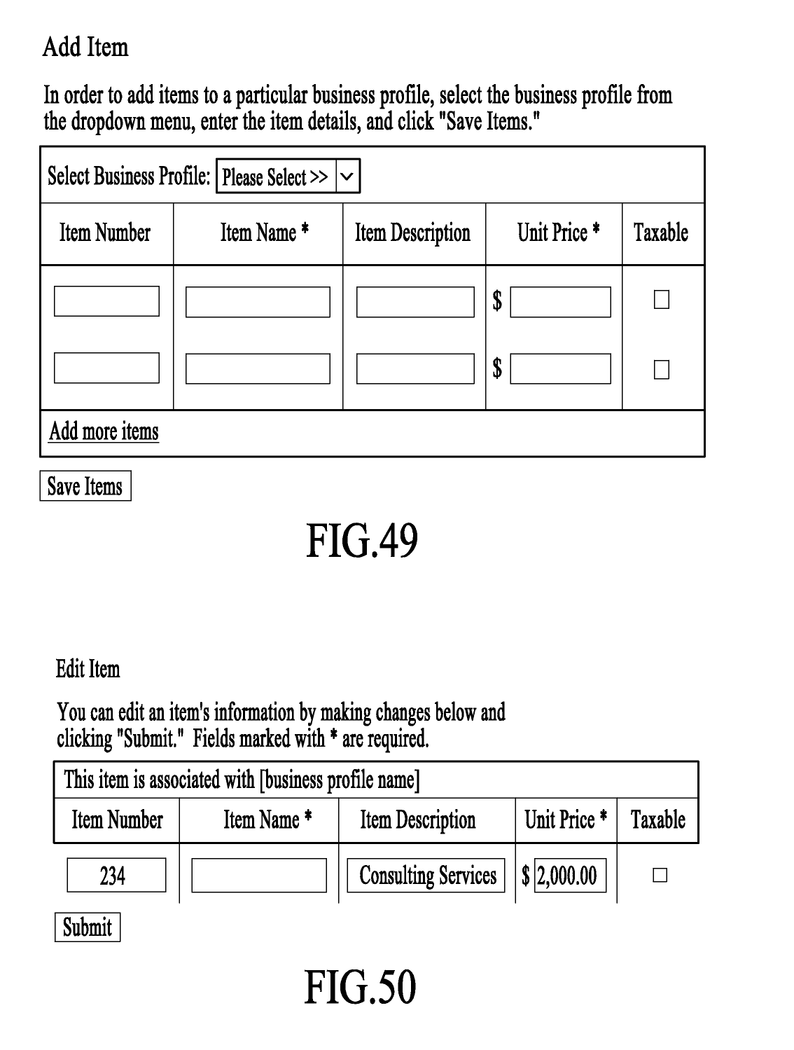

FIG. 50 is an “edit item” screen shot, according to an embodiment.

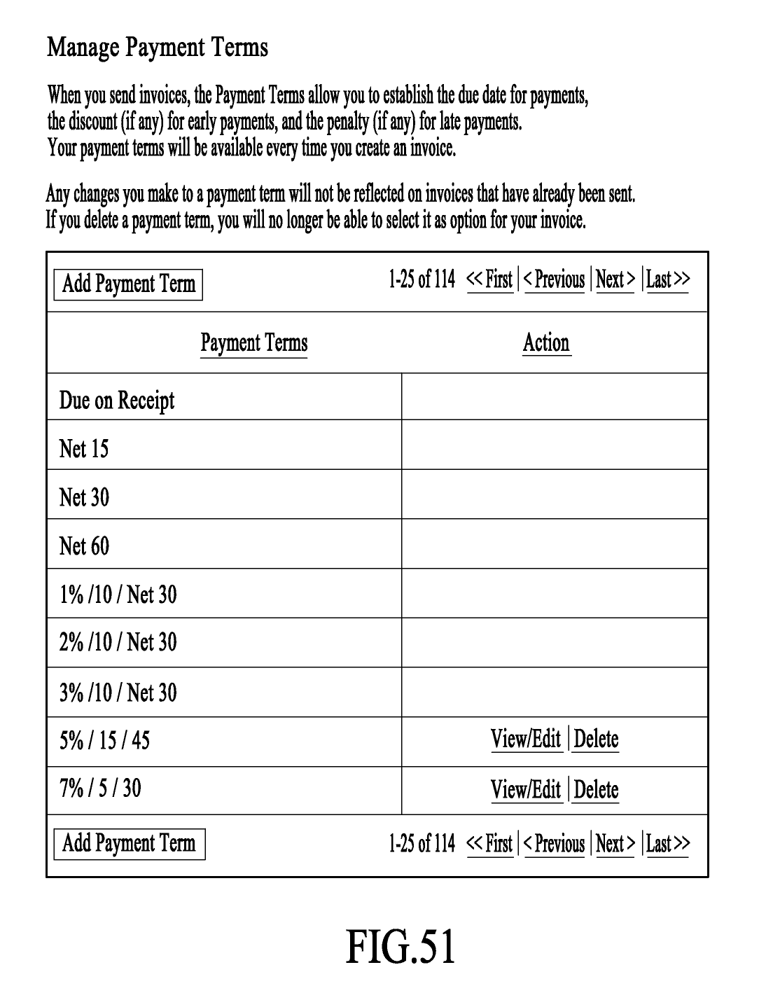

FIG. 51 is a “manage payment terms” screen shot, according to an embodiment.

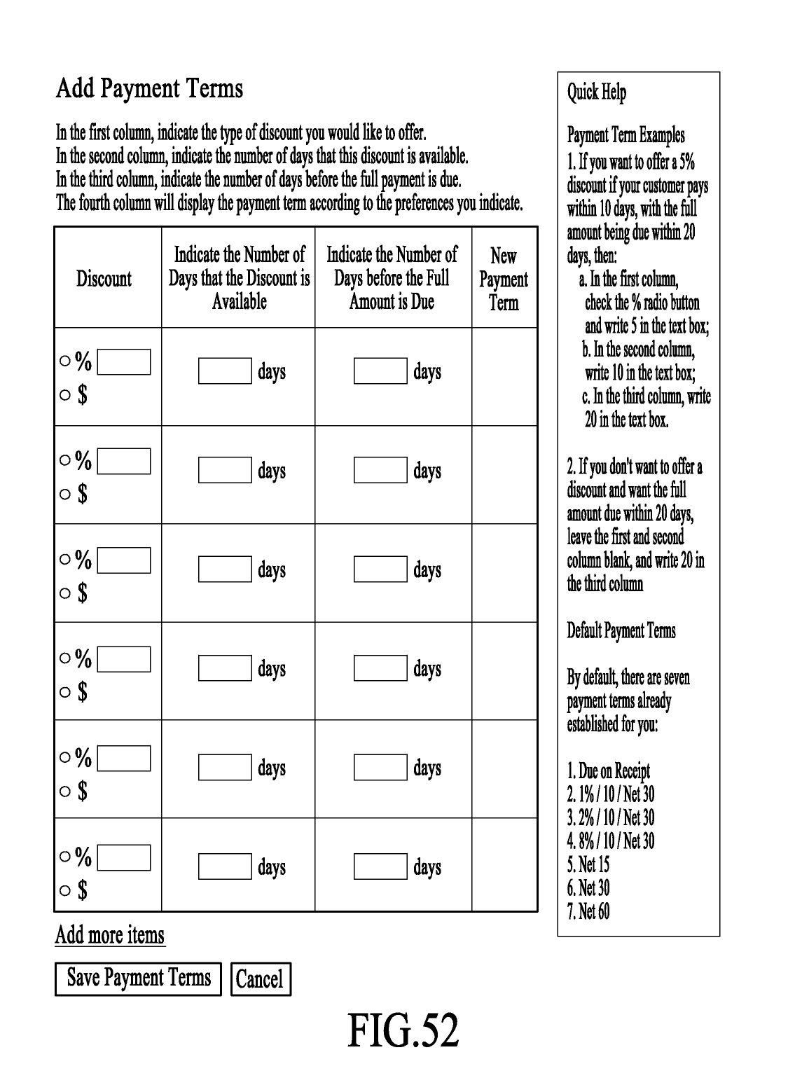

FIG. 52 is an “add payment terms” screen shot, according to an embodiment.

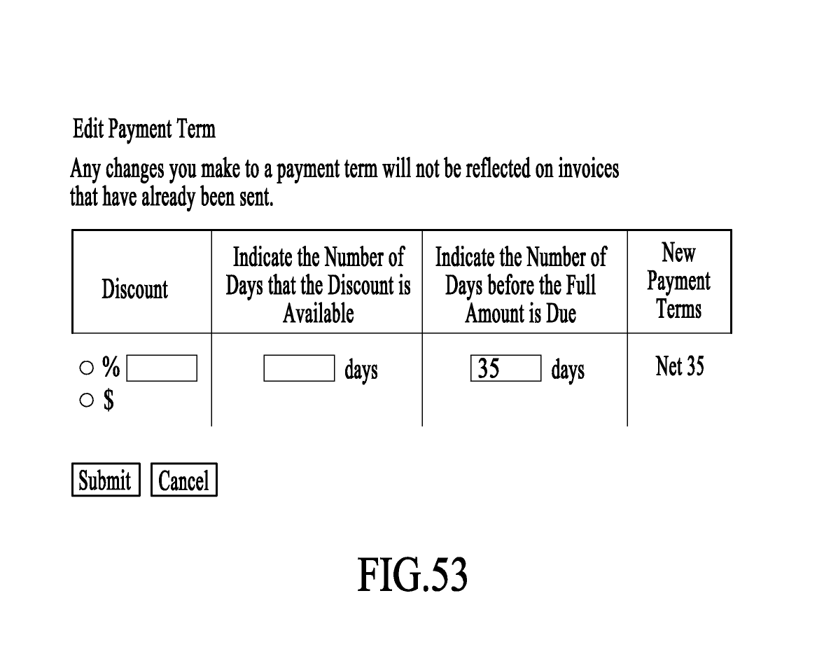

FIG. 53 is an “edit payment terms” screen shot, according to an embodiment.

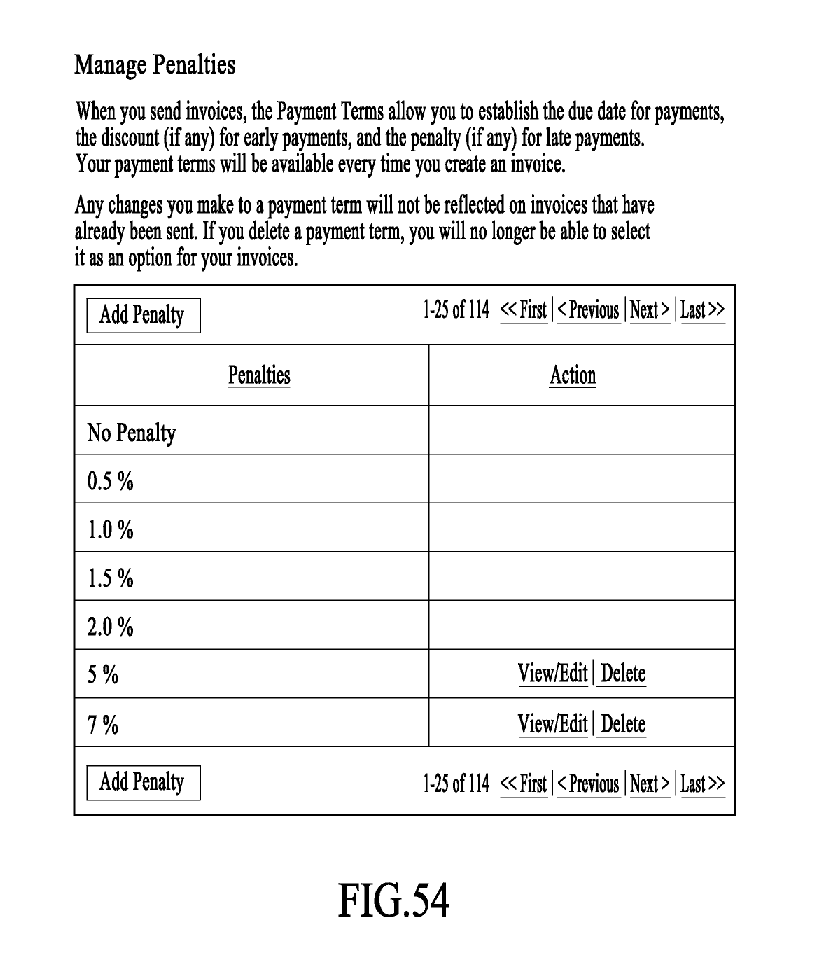

FIG. 54 is a “manage penalties” screen shot, according to an embodiment.

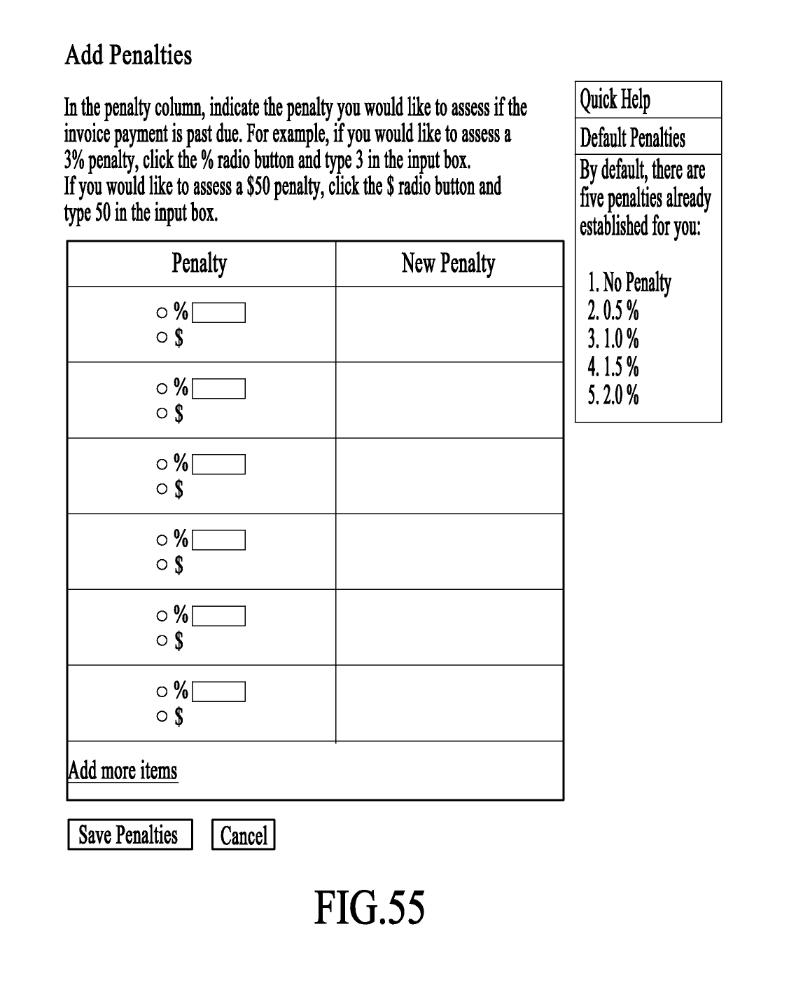

FIG. 55 is an “add penalties” screen shot, according to an embodiment.

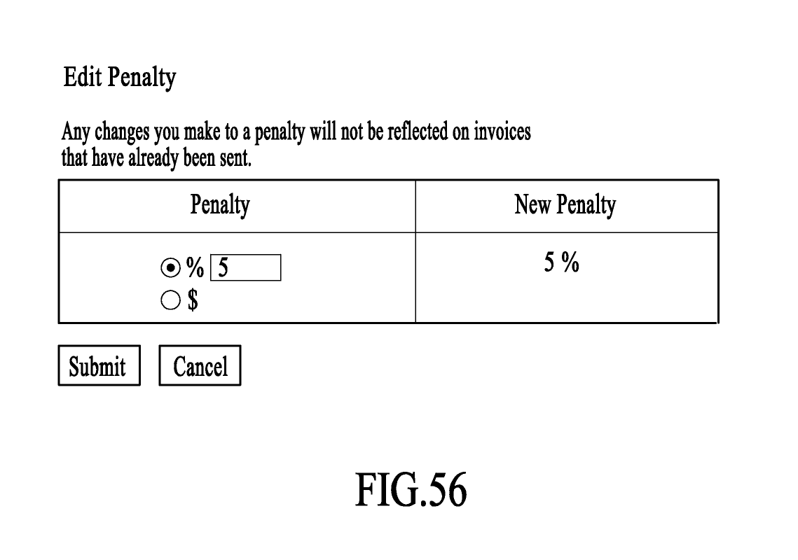

FIG. 56 is an “edit penalties” screen shot, according to an embodiment.

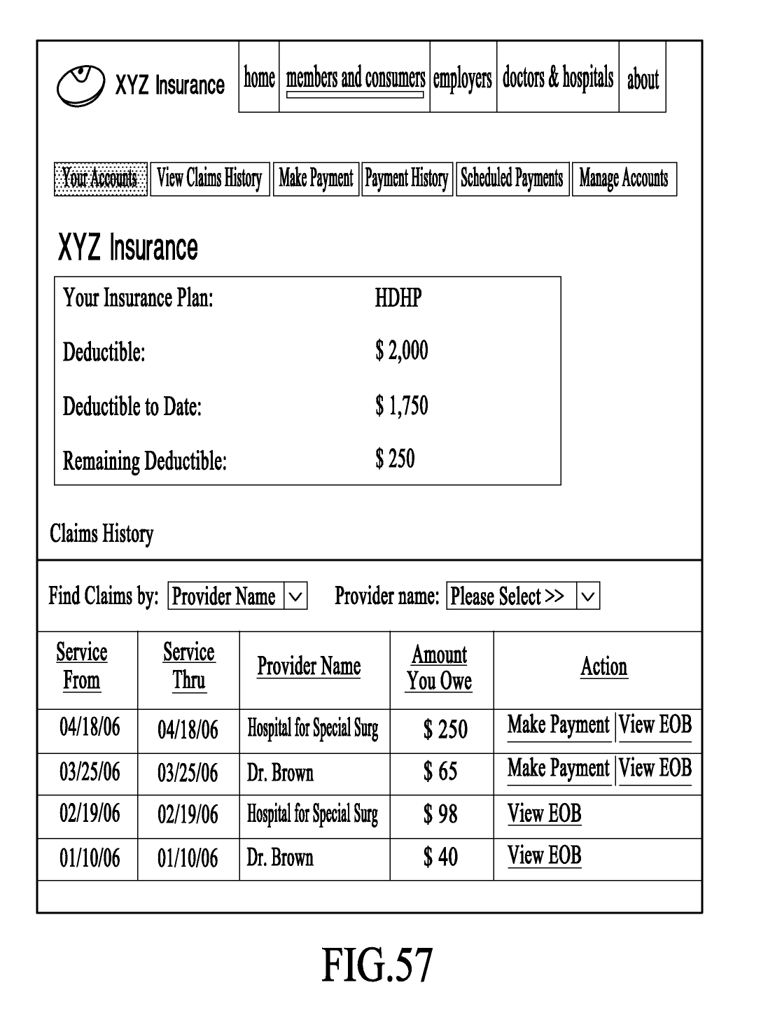

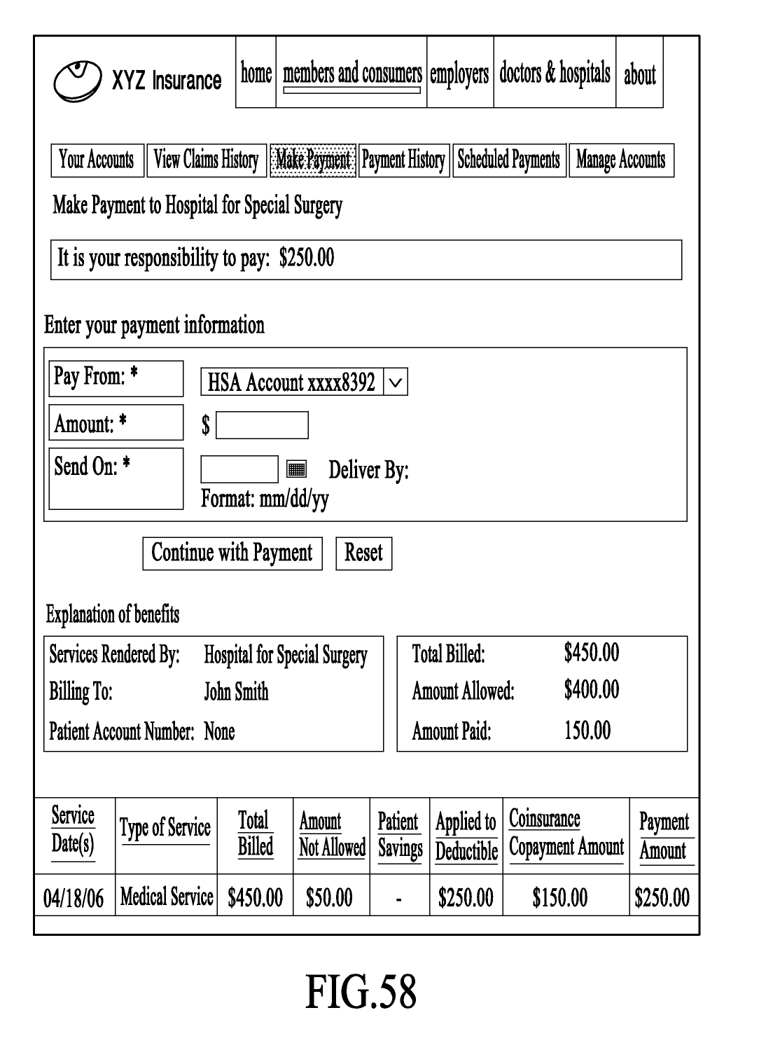

FIGS. 57-58 are screen shots that help to illustrate an embodiment of a payment enabled invoice method in which the invoice is a payment enabled EOB as described.

FIG. 57 is a “view claims history screen”, according to an embodiment. A payer can go to the view claims history screen to view a summary list of all medical claims made and associated explanation of service (EOB). The “make payment link” navigates the user to the payment enabled EOB.

FIG. 58 is a payment enabled EOB screen, according to an embodiment. A payer can view electronic EOB forms on this screen, and approve payment amounts. Approved payment amounts are sent as electronic payments directly to the provider's designated account, according to the funds transfer methods and systems described above. The payment enabled invoices described herein, including the payment enabled EOB is an intelligent invoice that automatically initiates execution of debit of appropriate accounts and credit of appropriate accounts simply by the payer clicking a payment link.

Embodiments described herein include a financial management method, comprising: receiving an input from an invoicing entity accessing a financial management system via an invoicing user interface (UI) to create a payer, wherein a payer owes an outstanding balance to the invoicing entity; via the invoicing UI, receiving a request to create an invoice, wherein creating an invoice comprises setting payment terms on the invoice, wherein the invoice states an amount comprising at least part of the outstanding balance; via the invoicing UI, receiving a destination account to associate with the invoice, wherein the destination account is an account designated to receive funds to be credited against the invoice; posting the invoice to at least one payment hub, and storing the invoice in an invoice database; receiving payer account data input from a payer accessing the at least one payment hub via a payment hub UI, wherein the payer account data includes access information for at least one payer financial account; via the payment hub UI, receiving a selection one of the at least one payer financial account for funding payment of the invoice; via the payment hub UI, receiving payer direction to pay the invoice; paying the invoice, comprising executing a transfer of funds from the payment account to the destination account; and updating the invoice to reflect payment of the invoice.

In an embodiment, payment terms comprise: a time for paying the invoice; discounts to be applied to the invoice; circumstances under which to apply the discounts; penalties to be applied to the invoice; and circumstances under which to apply the penalties.

An embodiment further comprises displaying the invoice to the payer, including automatically updating one or more of discounts and penalties based on the payment terms.

An embodiment further comprises: automatically updating one or more of discounts and penalties based on the payment terms and current date; and storing the updated invoice in the invoice database.

An embodiment further comprises: storing the invoice as a template; and receiving an input from the invoicing entity selecting the template for modification.

An embodiment further comprises: receiving input from the invoicing entity comprising a schedule of recurring invoicing events associated with at least one invoice; automatically generating the at least one invoice according to the schedule, including updating the invoice; and making the at least one invoice available on the at least one payment hub.

An embodiment further comprises: receiving input from the invoicing entity comprising a schedule of recurring invoicing events associated with at least one invoice; storing the invoice as a template; and automatically generating the at least one invoice according to the schedule, including updating the invoice.

An embodiment further comprises generating an aggregate invoice based on the invoice and past invoices, wherein the aggregate invoice combines amounts due from the invoice and from past invoices.

An embodiment further comprises generating an aging report based on the invoice and past invoices.

An embodiment further comprises generating a statement based on the invoice and past invoices.

An embodiment further comprises:

receiving a request from the payer to view at least one additional invoice other than the invoice; and displaying the invoice and the at least one additional invoice on the payer UI.

An embodiment further comprises: receiving a selection of at least one payment account from which to pay selected ones of the displayed invoices; and initiating payment of selected ones of the displayed invoices as indicated by the selection.

An embodiment further comprises: receiving at least one payment amount to be applied to at least one of the displayed invoices; and initiating payment of the at least one of the displayed invoices as indicated by the at least one payment amount, wherein payment comprises, full payment of each displayed invoice from different selected payment accounts; full payment of all of the displayed invoices from one of the selected payment accounts; and partial payment of the displayed invoices from at least one of the selected payment accounts.

An embodiment further comprises automatically generating electronic communications to the payer comprising: notifications of new invoices; alerts regarding payment terms; and payment confirmations.

In an embodiment, the payer account data further comprises payer registration information, and wherein the payer registration information is stored in the system for recognizing the payer on subsequent accesses of the at least one payment hub.

An embodiment further comprises: presenting the payer with a quick pay option; receiving a selection of the quick pay option; receiving the payer account data, wherein the at least one payer financial account includes one payer financial account; initiating payment of the invoice from the one payer account; and purging the payer account data.

In an embodiment, the invoice comprises a payment enabled settlement statement.

In an embodiment, the settlement statement comprises a payment enabled medical insurance explanation of benefits (EOB).

Embodiments described herein further include a system, comprising: a financial management system coupled to a plurality of financial institutions via at least one network, the financial management system configurable to execute a debit transaction with one of the financial institutions and to execute a credit transaction with another one of the financial institutions, wherein the debit transaction and the credit transaction are parts of a same transaction; an invoicing application module coupled to the financial management system, the invoicing application module comprising at least one invoicing user interface (UI) via which an invoicing entity registers a payer and creates an invoice for the payer; at least one payment hub coupled to the invoicing application module and to the financial management system, the at least one payment hub comprising at least one payment hub UI via which a payer accesses and views the invoice and directs payment from an account; and wherein the financial management system is further configurable to pay the invoice, including executing the debit transaction and executing the credit transaction, and to update the invoice to reflect payment.

In an embodiment, the financial management system comprises an invoice database that stores invoices created by a plurality of invoicing entities via different invoicing UIs.

In an embodiment, the at least one payment hub is configured by an institution to appear with branding of the institution, and wherein the at least one payment hub UI is accessed via a web site administered by the institution.

In an embodiment, a payer accessing the at least one payment hub can view invoices from any of the plurality of invoicing entities.

In an embodiment, the at least one payment hub is configured by an invoicing entity to appear with branding of at least one of a plurality of invoicing entities, and wherein the at least one payment hub UI is accessed via a web site administered by an institution on behalf of the plurality of invoicing entities.

In an embodiment, a payer accessing the at least one payment hub can view invoices from any of the plurality of invoicing entities.

In an embodiment, the at least one payment hub is configured by an invoicing entity to appear with branding of the invoicing entity, and wherein the at least one payment hub UI is accessed via a web site administered by the invoicing entity.

In an embodiment, a payer accessing the at least one payment hub can view invoices from the invoicing entity.

Embodiments described herein further include a financial management system, comprising: at least one coupling to a plurality of financial institutions via at least one network, wherein the financial management system is configurable to execute a debit transaction with one of the financial institutions and to execute a credit transaction with another one of the financial institutions, wherein the debit transaction and the credit transaction are parts of a same transaction; an invoicing application module coupled to the financial management system, the invoicing application module comprising at least one invoicing user interface (UI) via which an invoicing entity registers a payer and creates an invoice for the payer; at least one payment hub coupled to the invoicing application module and to the financial management system, the at least one payment hub comprising at least one payment hub UI via which a payer accesses and views the invoice and directs payment from an account; and wherein the financial management system is further configurable to pay the invoice, including executing the debit transaction and executing the credit transaction, and to update the invoice to reflect payment.

In an embodiment, the financial management system comprises an invoice database that stores invoices created by a plurality of invoicing entities via different invoicing UIs.

In an embodiment, the at least one payment hub is configured by an invoicing entity to appear with branding of at least one of a plurality of invoicing entities, and wherein the at least one payment hub UI is accessed via at least one web site administered by at least one institution on behalf of the plurality of invoicing entities.

In an embodiment, a payer accessing the at least one payment hub can view invoices stored on the invoicing database from any of the plurality of invoicing entities.

Embodiments described herein further include an invoicing user interface method, comprising: providing a plurality of invoicing user interfaces to a plurality of invoicing entities; receiving data to create invoices from the plurality of invoicing entities, wherein the data comprises payment terms and payment amounts; making the invoices available to a plurality of payers; receiving data from the plurality of payers, including direction to pay invoices; and updating the invoices in real time in response to data received from the plurality of invoicing entities and data received from the plurality of payers.

Embodiments described herein further include a payment hub user interface method, comprising: providing a plurality of payment hubs to a plurality of payers, wherein the plurality of payment hubs are coupled to an invoice database storing invoices; receiving requests via a payment hub user interface to, view invoices, comprising current and aged invoices from at least one invoicing entity; and pay invoices; and executing the received requests; and updating invoices in real time based on executed requests.

What is claimed is:

1. A financial management method, comprising:
receiving an input from an invoicing entity accessing a financial management system via an invoicing user interface (UI) to create a payer, wherein a payer owes an outstanding balance to the invoicing entity;
via the invoicing UI, receiving a request to create an invoice, wherein creating an invoice comprises setting payment terms on the invoice, wherein the invoice states an amount comprising at least part of the outstanding balance;
via the invoicing UI, receiving a destination account to associate with the invoice, wherein the destination account is an account designated to receive funds to be credited against the invoice;
posting the invoice to at least one payment hub, and storing the invoice in an invoice database;
receiving payer account data input from a payer accessing the at least one payment hub via a payment hub UI, wherein the payer account data includes access information for at least one payer financial account;
via the payment hub UI, receiving a selection one of the at least one payer financial account for funding payment of the invoice;
via the payment hub UI, receiving payer direction to pay the invoice;
paying the invoice, comprising executing a transfer of funds from the payment account to the destination account; and
updating the invoice to reflect payment of the invoice.

2. The method of claim 1, wherein payment terms comprise:
a time for paying the invoice;
discounts to be applied to the invoice;
circumstances under which to apply the discounts;
penalties to be applied to the invoice; and
circumstances under which to apply the penalties.

3. The method of claim 1, further comprising displaying the invoice to the payer, including automatically updating one or more of discounts and penalties based on the payment terms.

4. The method of claim 1, further comprising:
automatically updating one or more of discounts and penalties based on the payment terms and current date; and
storing the updated invoice in the invoice database.

5. The method of claim 1, further comprising:
storing the invoice as a template; and
receiving an input from the invoicing entity selecting the template for modification.

6. The method of claim 1, further comprising:
receiving input from the invoicing entity comprising a schedule of recurring invoicing events associated with at least one invoice;
automatically generating the at least one invoice according to the schedule, including updating the invoice; and
making the at least one invoice available on the at least one payment hub.

7. The method of claim 1, further comprising:
receiving input from the invoicing entity comprising a schedule of recurring invoicing events associated with at least one invoice;
storing the invoice as a template; and
automatically generating the at least one invoice according to the schedule, including updating the invoice.

8. The method of claim 1, further comprising generating an aggregate invoice based on the invoice and past invoices, wherein the aggregate invoice combines amounts due from the invoice and from past invoices.

9. The method of claim 1, further comprising generating an aging report based on the invoice and past invoices.

10. The method of claim 1, further comprising generating a statement based on the invoice and past invoices.

11. The method of claim 1, further comprising:
receiving a request from the payer to view at least one additional invoice other than the invoice; and
displaying the invoice and the at least one additional invoice on the payer UI.

12. The method of claim 11, further comprising:
receiving a selection of at least one payment account from which to pay selected ones of the displayed invoices; and
initiating payment of selected ones of the displayed invoices as indicated by the selection.

13. The method of claim 11, further comprising:
receiving at least one payment amount to be applied to at least one of the displayed invoices; and
initiating payment of the at least one of the displayed invoices as indicated by the at least one payment amount, wherein payment comprises,
full payment of each displayed invoice from different selected payment accounts;
full payment of all of the displayed invoices from one of the selected payment accounts; and
partial payment of the displayed invoices from at least one of the selected payment accounts.

14. The system of claim 1, further comprising automatically generating electronic communications to the payer comprising:
notifications of new invoices;
alerts regarding payment terms; and
payment confirmations.

15. The system of claim 1, wherein the payer account data further comprises payer registration information, and wherein the payer registration information is stored in the system for recognizing the payer on subsequent accesses of the at least one payment hub.

16. The method of claim 1, further comprising:
presenting the payer with a quick pay option;
receiving a selection of the quick pay option;
receiving the payer account data, wherein the at least one payer financial account includes one payer financial account;
initiating payment of the invoice from the one payer account; and
purging the payer account data.

17. The method of claim 1, wherein the invoice comprises a payment enabled settlement statement.

18. The method of 17 wherein the settlement statement comprises a payment enabled medical insurance explanation of benefits (EOB).

19. A system, comprising:
a financial management system coupled to a plurality of financial institutions via at least one network, the financial management system configurable to execute a debit transaction with one of the financial institutions and to execute a credit transaction with another one of the financial institutions, wherein the debit transaction and the credit transaction are parts of a same transaction;
an invoicing application module coupled to the financial management system, the invoicing application module comprising at least one invoicing user interface (UI) via which an invoicing entity registers a payer and creates an invoice for the payer;
at least one payment hub coupled to the invoicing application module and to the financial management system, the at least one payment hub comprising at least one payment hub UI via which a payer accesses and views the invoice and directs payment from an account; and
wherein the financial management system is further configurable to pay the invoice, including executing the debit transaction and executing the credit transaction, and to update the invoice to reflect payment.

20. The system of claim 19, wherein the financial management system comprises an invoice database that stores invoices created by a plurality of invoicing entities via different invoicing UIs.

21. The system of claim 19, wherein the at least one payment hub is configured by an institution to appear with branding of the institution, and wherein the at least one payment hub UI is accessed via a web site administered by the institution.

22. The system of claim 21, wherein a payer accessing the at least one payment hub can view invoices from any of the plurality of invoicing entities.

23. The system of claim 19, wherein the at least one payment hub is configured by an invoicing entity to appear with branding of at least one of a plurality of invoicing entities, and wherein the at least one payment hub UI is accessed via a web site administered by an institution on behalf of the plurality of invoicing entities.

24. The system of claim 23, wherein a payer accessing the at least one payment hub can view invoices from any of the plurality of invoicing entities.

25. The system of claim 19, wherein the at least one payment hub is configured by an invoicing entity to appear with branding of the invoicing entity, and wherein the at least one payment hub UI is accessed via a web site administered by the invoicing entity.

26. The system of claim 25, wherein a payer accessing the at least one payment hub can view invoices from the invoicing entity.

27. A financial management system, comprising:
at least one coupling to a plurality of financial institutions via at least one network, wherein the financial management system is configurable to execute a debit transaction with one of the financial institutions and to execute a credit transaction with another one of the financial institutions, wherein the debit transaction and the credit transaction are parts of a same transaction;
an invoicing application module coupled to the financial management system, the invoicing application module comprising at least one invoicing user interface (UI) via which an invoicing entity registers a payer and creates an invoice for the payer;
at least one payment hub coupled to the invoicing application module and to the financial management system, the at least one payment hub comprising at least one payment hub UI via which a payer accesses and views the invoice and directs payment from an account; and
wherein the financial management system is further configurable to pay the invoice, including executing the debit transaction and executing the credit transaction, and to update the invoice to reflect payment.

28. The system of claim 27, wherein the financial management system comprises an invoice database that stores invoices created by a plurality of invoicing entities via different invoicing UIs.

29. The system of claim 28, wherein the at least one payment hub is configured by an invoicing entity to appear with branding of at least one of a plurality of invoicing entities, and wherein the at least one payment hub UI is accessed via at least one web site administered by at least one institution on behalf of the plurality of invoicing entities.

30. The system of claim 29, wherein a payer accessing the at least one payment hub can view invoices stored on the invoicing database from any of the plurality of invoicing entities.

31. An invoicing user interface method, comprising:
providing a plurality of invoicing user interfaces to a plurality of invoicing entities;
receiving data to create invoices from the plurality of invoicing entities, wherein the data comprises payment terms and payment amounts;
making the invoices available to a plurality of payers;
receiving data from the plurality of payers, including direction to pay invoices; and
updating the invoices in real time in response to data received from the plurality of invoicing entities and data received from the plurality of payers.

32. A payment hub user interface method, comprising:
providing a plurality of payment hubs to a plurality of payers, wherein the plurality of payment hubs are coupled to an invoice database storing invoices;
receiving requests via a payment hub user interface to,
view invoices, comprising current and aged invoices from at least one invoicing entity; and
pay invoices; and
executing the received requests; and
updating invoices in real time based on executed requests.
